(19) United States
(12) Patent Application Publication
(10) Pub. No.: US 2010/0328637 A1
(43) Pub. Date: Dec. 30, 2010

(54) Exposure apparatus, exposing method and device fabricating method

(75) Inventor: Yasufumi Nishii, Kumayaga-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/591,827

(22) Filed: Dec. 2, 2009

Related U.S. Application Data
(60) Provisional application No. 61/193,517, filed on Dec. 4, 2008.
(60) Provisional application No. 61/193,518, filed on Dec. 4, 2008.
(60) Provisional application No. 61/193,519, filed on Dec. 4, 2008.

(51) Int. Cl. G03B 27/54

(52) U.S. Cl. 355/67; 355/77

(57) ABSTRACT

An exposure apparatus comprises: an optical member, which has an emergent surface wherefrom exposure light emerges; a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface; a first recovery port, which is disposed at least partly around an optical axis of the optical member and is capable of recovering a liquid from at least part of the first gap; and a second gap, which is formed on the outer side of the first recovery port with respect to the optical axis and is smaller than the first gap.

### CROSS-REFERENCE TO RELATED APPLICATION

This application is a non-provisional application claiming priority to and the benefit of U.S. provisional Application Nos. 61/193,517, 61/193,518, and 61/193,519, filed Dec. 4, 2008, the contents of which are incorporated herein by reference.

### BACKGROUND

1. Field of the Invention

The present invention relates to an exposure apparatus, an exposing method, and a device fabricating method.

2. Description of Related Art

In the process of fabricating microdevices, such as semiconductor devices and electronic devices, it is known to use an immersion exposure apparatus that radiates exposure light to a substrate via a liquid, as disclosed in, for example, U.S. Patent Application Publication No. 2006/0221315, U.S. Patent Application Publication No. 2007/0081140.

In an immersion exposure apparatus, it is important to hold the liquid in a desired space. For example, if some of the liquid flows out of the space, the heat of vaporization of that liquid might change the temperature or the ambient environment of the substrate. As a result, exposure failures might occur and defective devices might be produced.

In addition, in an immersion exposure apparatus, if foreign matter or a gas (e.g., bubbles) intermixes with the liquid that is present along an optical path of exposure light, then exposure failures might occur; for example, defects might be produced in a pattern formed on the substrate. These potential problems could also result in the production of defective devices.

An object of some aspects of the present invention is to provide an exposure apparatus and an exposing method that can prevent exposure failures from occurring. Another object of some aspects of the present invention is to provide a device fabricating method that can prevent defective devices from being produced.

### SUMMARY

A first aspect of the present invention provides an exposure apparatus that comprises: an optical member, which has an emergent surface wherefrom exposure light emerges; a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface; a first recovery port, which is disposed at least partly around an optical axis of the optical member and is capable of recovering a liquid from at least part of the first gap; and a second gap, which is formed on the outer side of the first recovery port with respect to the optical axis and is smaller than the first gap.

A second aspect of the present invention provides an exposure apparatus that comprises: an optical member, which has an emergent surface wherefrom exposure light emerges; a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface; a first recovery port, which is disposed at least partly around an optical axis of the optical member and is capable of recovering a liquid from at least part of the first gap; and a liquid restricting part, which is formed on the outer side of the first recovery port with respect to the optical axis and allows the passage of a gas from the first gap and prevents the passage of the liquid from the first gap.

A third aspect of the present invention provides a device fabricating method that comprises the steps of: exposing a substrate using an exposure apparatus according to the first or second aspects; and developing the exposed substrate.

A fourth aspect of the present invention provides a device fabricating method that comprises the steps of: radiating exposure light, which emerges from an emergent surface of an optical member, to a substrate; filling an optical path of the exposure light between the emergent surface and the substrate with a liquid using a second member that is disposed at least partly around the optical path of the exposure light and that has an inner surface that opposes, via a first gap, at least one surface of the group consisting of an outer surface of the optical member, which is different from the emergent surface, and an outer surface of a first member, which holds the optical member; and recovering the liquid from at least part of the first gap via a first recovery port; wherein, a second gap, which is formed on the outer side of the first recovery port with respect to the optical axis of the optical member and is smaller than the first gap, prevents the liquid from flowing from the first gap to the outer side of the first recovery port with respect to the optical axis.

A fifth aspect of the present invention provides a device fabricating method that comprises the steps of: exposing a substrate using an exposing method according to the fourth aspect; and developing the exposed substrate.

A sixth aspect of the invention provides an exposure apparatus that comprises: an optical member, which has an emergent surface wherefrom exposure light emerges; a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface; and a first supply port, which supplies a liquid to the first gap; wherein, at least some of the liquid that is supplied via the first supply port flows in the first gap in a direction away from an optical axis of the optical member, and the exposure light that emerges from the emergent surface is radiated to a substrate through the liquid between the emergent surface of the optical member and the substrate.

A seventh aspect of the invention provides an exposure apparatus that comprises: an optical member, which has an emergent surface wherefrom exposure light emerges; a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface; a first supply port, which supplies a liquid to the first gap; and a first recovery port that is disposed spaced apart from the first supply port with respect to the optical axis and that recovers the liquid that is supplied via the first supply port; wherein, a space in the first gap between the first supply port and the first recovery port is substantially filled with the liquid that is supplied via the first supply port; and the exposure light that emerges from the emergent surface is radiated to a substrate through the liquid between the emergent surface of the optical member and the substrate.

A eighth aspect of the invention provides a device fabricating method that comprises the steps of: exposing a substrate using an exposure apparatus-according to the sixth aspect of the invention; and developing the exposed substrate.

A ninth aspect of the invention provides an exposing method that comprises the steps of: radiating exposure light, which emerges from an emergent surface of an optical member, to a substrate; filling an optical path of the exposure light between the emergent surface and the substrate with a liquid using a second member that is disposed at least partly around the optical path of the exposure light and that has an inner surface that opposes, via a first gap, at least one surface of the group consisting of an outer surface of the optical member, which is different from the emergent surface, and an outer surface of a first member, which holds the optical member; and flowing at least some of the liquid that is supplied to the first gap in a direction away from the optical axis of the optical member.

A tenth aspect of the invention provides a device fabricating method that comprises the steps of: exposing a substrate using an exposing method according to the eighth aspect of the invention; and developing the exposed substrate.

A eleventh aspect of the invention provides an exposure apparatus that comprises: an optical member, which has an emergent surface wherefrom exposure light emerges; a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface; and a third member, which has a first recovery port that recovers a liquid from the first gap and is disposed such that it opposes the second member across the second gap; wherein, the exposure light that emerges from the emergent surface is radiated to a substrate through the liquid between the emergent surface of the optical member and the substrate.

A twelfth aspect of the invention provides a device fabricating method that comprises the steps of: exposing a substrate using an exposure apparatus according to the eleventh aspect; and developing the exposed substrate.

A thirteenth aspect of the invention provides an exposing method that comprises the steps of: radiating exposure light, which emerges from an emergent surface of an optical member, to a substrate; filling an optical path of the exposure light between the emergent surface and the substrate with a liquid using a second member that is disposed at least partly around the optical path of the exposure light and that has an inner surface that opposes, via a first gap, at least one surface of the group consisting of an outer surface of the optical member, which is different from the emergent surface, and an outer surface of a first member, which holds the optical member; and recovering the liquid from the first gap via a recovery port of a third member, which is disposed such that it opposes the second member across a second gap.

A fourteenth aspect of the invention provides a device fabricating method that comprises the steps of: exposing a substrate using an exposing method according to the thirteenth aspect; and developing the exposed substrate.

According to an aspect of the present invention, exposure failures can be prevented from occurring. In addition, according to an aspect of the present invention, defective devises can be prevented from being produced.

### BRIEF DESCRIPTION OF THE DRAWINGS

FIG. 1 is a schematic block diagram that shows one example of an exposure apparatus according to a first embodiment.

FIG. 2 is a partial enlarged view of the exposure apparatus according to the first embodiment.

FIG. 3 is a diagram of a liquid immersion member according to the first embodiment, viewed from above.

FIG. 4 is a view that shows the vicinity of a first recovery port and a protrusion according to the first embodiment.

FIG. 5 is a view that shows the vicinity of the first recovery port and the protrusion according to the first embodiment.

FIG. 6 is a view that shows the vicinity of the first recovery port and the protrusion according to the first embodiment.

FIG. 7 is a view that shows the vicinity of the first recovery port and the protrusion according to the first embodiment.

FIG. 8 is a view that shows the vicinity of the first recovery port and the protrusion according to the first embodiment.

FIG. 9 is a view that shows the vicinity of the first recovery port and the protrusion according to the first embodiment.

FIG. 10 is a view that shows the vicinity of the first recovery port and protrusion according to the first embodiment.

FIG. 11 is a view that shows the vicinity of the first recovery port and the protrusion according to the first embodiment.

FIG. 12 is a view that shows the vicinity of the first recovery port and the protrusion according to the first embodiment.

FIG. 13 is a schematic block diagram that shows one example of the exposure apparatus according to a second embodiment.

FIG. 14 is a view that shows the vicinity of the first recovery port and the protrusion according to the second embodiment.

FIG. 15 is a diagram of the liquid immersion member and a recovery member according to the second embodiment, viewed from above.

FIG. 16 is a schematic block diagram that shows one example of an exposure apparatus according to a third embodiment.

FIG. 17 is a partial enlarged view of the exposure apparatus according to the third embodiment.

FIG. 18 is a diagram of a liquid immersion member and a recovery member according to the third embodiment, viewed from above.

FIG. 19 is a view that shows the vicinity of the liquid immersion member and the recovery member according to the third embodiment.

FIG. 20 is a view that shows the vicinity of the liquid immersion member and the recovery member according to a modified example of the third embodiment.

FIG. 21 is a view that shows the vicinity of the liquid immersion member and the recovery member according to a modified example of the third embodiment.

FIG. 22 is a view that shows the vicinity of the liquid immersion member and the recovery member according to a modified example of the third embodiment.

FIG. 23 is a view that shows the vicinity of the liquid immersion member according to a modified example of the present embodiment.

FIG. 24 is a schematic block diagram that shows one example of an exposure apparatus according to a fourth embodiment.

FIG. 25 is a partial enlarged view of the exposure apparatus according to the fourth embodiment.

FIG. 26 is a diagram of a liquid immersion member and a recovery member according to the fourth embodiment, viewed from above.

FIG. 27 is a view that shows the vicinity of the liquid immersion member and the recovery member according to the fourth embodiment.

FIG. 28 is a view that shows the vicinity of the liquid immersion member and the recovery member according to the fourth embodiment.

FIG. 29 is a view that shows the vicinity of the liquid immersion member and the recovery member according to a modified example of the fourth embodiment.

FIG. 30 is a view that shows the vicinity of the liquid immersion member and the recovery member according to the modified example of the fourth embodiment.

FIG. 31 is a view that shows the vicinity of the liquid immersion member and the recovery member according to the modified example of the fourth embodiment.

FIG. 32 is a view that shows the vicinity of the liquid immersion member and the recovery member according to the modified example of the fourth embodiment.

FIG. 33 is a view that shows the vicinity of the liquid immersion member and the recovery member according to the modified example of the fourth embodiment.

FIG. 34 is a flow chart for explaining one example of a microdevice fabricating process.

### DESCRIPTION OF EMBODIMENTS

The following text explains the embodiments of the present invention, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions are the Z axial directions (i.e., the vertical directions). In addition, the rotational (i.e., inclined) directions around the X, Y, and Z axes are the θX, θY, and θZ directions, respectively.

### First Embodiment

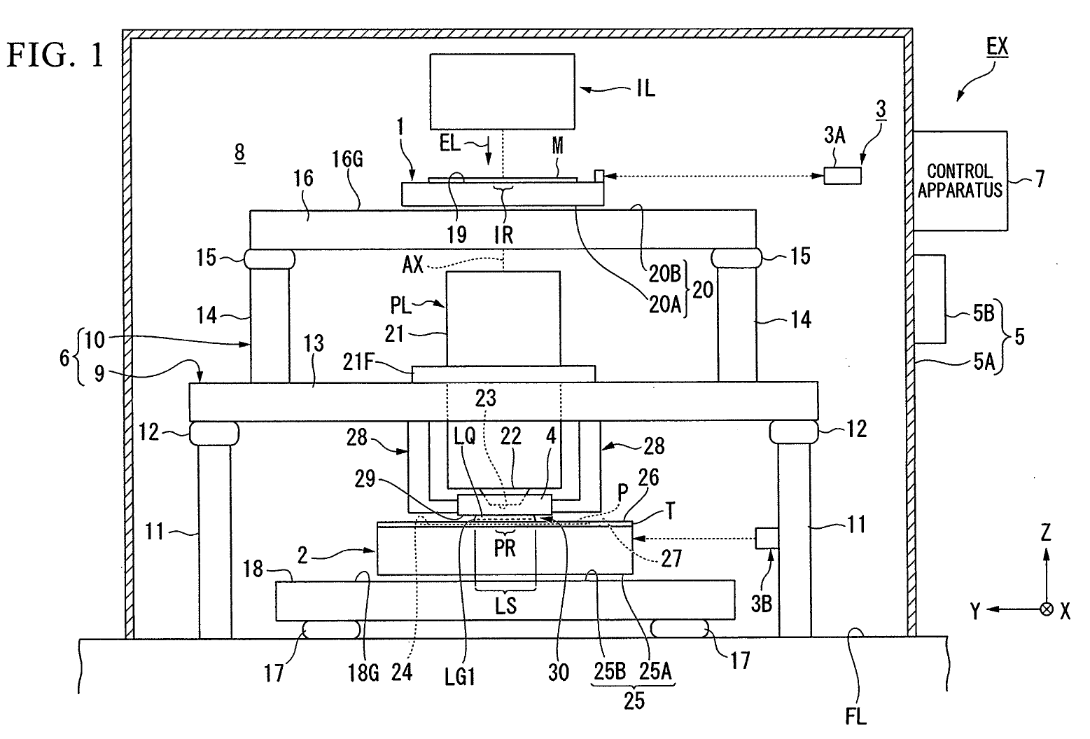

A first embodiment will now be explained. FIG. 1 is a schematic block diagram that shows one example of an exposure apparatus EX according to the first embodiment. The exposure apparatus EX of the present embodiment is an immersion exposure apparatus that radiates exposure light EL through a liquid LQ to a front surface of a substrate P. In the present embodiment, water (i.e., pure water) is used as the liquid LQ.

In FIG. 1, the exposure apparatus EX comprises: a movable mask stage 1, which holds a mask M; a movable substrate stage 2, which holds the substrate P; an interferometer system 3, which optically measures the positions of the mask stage 1 and the substrate stage 2; an illumination system IL, which illuminates the mask M with the exposure light EL; a projection system PL that projects an image of a pattern of the mask M, which is illuminated by the exposure light EL, to the substrate P; a liquid immersion member 4, which is capable of forming an immersion space LS such that at least part of an optical path of the exposure light EL is filled with the liquid LQ; a chamber apparatus 5, which houses at least the projection system PL; a body 6, which supports at least the projection system PL; and a control apparatus 7, which controls the operation of the entire exposure apparatus EX.

The mask M may be, for example, a reticle wherein a device pattern projected onto the substrate P is formed. The mask M comprises a transmissive mask that comprises a transparent plate, such as a glass plate, and a pattern, which is formed on the transparent plate using a shielding material, such as chrome. Furthermore, the mask M may alternatively be a reflective mask.

The substrate P is a substrate for fabricating devices. The substrate P comprises a base material (e.g., a semiconductor wafer) and a multilayer film that is formed thereon. The multilayer film is a film wherein a plurality of films, including at least a photosensitive film, is layered. The photosensitive film is a film that is formed from a photosensitive material. In addition, the multilayer film may include, for example, an antireflection film and a protective film (i.e., a topcoat film) that protects the photosensitive film.

The chamber apparatus 5 comprises a chamber member 5A, which forms a substantially closed internal space 8, and an environmental control apparatus 5B, which controls the environment (i.e., the temperature, the humidity, the cleanliness level, the pressure, and the like) of the internal space 8. The body 6 is disposed in the internal space 8. The body 6 comprises a first columnar structure 9, which is provided on a support surface FL, and a second columnar structure 10, which is provided on the first columnar structure 9. The first columnar structure 9 comprises first support members 11 and a first base plate 13, which is supported by the first support members 11 via vibration isolating apparatuses 12. The second columnar structure 10 comprises second support members 14, which are provided on the first base plate 13, and a second base plate 16, which is supported by the second support members 14 via vibration isolating apparatuses 15. In addition, in the present embodiment, a third base plate 18 is disposed on the support surface FL via vibration isolating apparatuses 17.

The illumination system IL radiates the exposure light EL to a prescribed illumination area IR. The illumination area IR includes a position whereto the exposure light EL that emerges from the illumination system IL can be radiated. The illumination system IL illuminates at least part of the mask M disposed in the illumination area IR with the exposure light EL, which has a uniform luminous flux intensity distribution. Examples of light that can be used as the exposure light EL emitted from the illumination system IL include: deep ultraviolet (DUV) light, such as a bright line (g-line, h-line, or i-line) light emitted from, for example, a mercury lamp, and KrF excimer laser light (with a wavelength of 248 nm); and vacuum ultraviolet (VUV) light, such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

The mask stage 1 comprises a mask holding part 19, which releaseably holds the mask M, and is capable of moving on a guide surface 16G of the second base plate 16 in the state wherein the mask M is held by the mask stage 1. The mask stage 1 is capable of holding and moving the mask M with respect to the illumination area IR by the operation of a drive system 20. The drive system 20 comprises a planar motor that comprises sliders 20A, which are disposed on the mask stage 1, and stators 20B, which are disposed on the second base plate 16. A planar motor that is capable of moving the mask stage 1 is disclosed in, for example, U.S. Pat. No. 6,452,292. The mask stage 1 is capable of moving in six directions, namely, the X axial, Y axial, Z axial, θX, θY, and θZ directions, by the operation of the drive system 20.

The projection system PL radiates the exposure light EL to a prescribed projection area PR. The projection system PL projects an image of the pattern of the mask M to at least part of the substrate P, which is disposed in the projection area PR, with a prescribed projection magnification. The projection system PL of the present embodiment is a reduction system that has a projection magnification of, for example, 1/4, 1/5, or ⅛. Furthermore, the projection system PL may also be a unity magnification system or an enlargement system. In the present embodiment, an optical axis AX of the projection system PL is parallel to the Z axis. In addition, the projection system PL may be a dioptric system that does not include catoptric elements, a catoptric system that does not include dioptric elements, or a catadioptric system that includes both catoptric and dioptric elements. In addition, the projection system PL may form either an inverted or an erect image.

A holding member 21 (i.e., a lens barrel) holds a plurality of optical elements of the projection system PL. The holding member 21 has a flange 21F. The projection system PL is supported by the first base plate 13 via the flange 21F. Furthermore, a vibration isolating apparatus can be provided between the first base plate 13 and the holding member 21.

A last optical element 22, which is the optical element of the plurality of optical elements of the projection system PL that is closest to the image plane of the projection system PL, has an emergent surface 23 wherefrom the exposure light EL emerges and travels toward the image plane of the projection system PL. The projection area PR includes a position whereto the exposure light EL that emerges from the emergent surface 23 can be radiated. In the present embodiment, the emergent surface 23 faces the −Z direction and is parallel to the XY plane. Furthermore, the emergent surface 23, which faces the −Z direction, may be a convex surface or a concave surface.

In the present embodiment, the optical axis AX (the optical axis in the vicinity of the image plane of the projection system PL) of the last optical element 22 is substantially parallel to the Z axis. Furthermore, the optical axis defined by the optical element adjacent to the last optical element 22 may be regarded as the optical axis of the last optical element 22. In addition, in the present embodiment, the image plane of the projection system PL is substantially parallel to the XY plane, which includes the X axis and the Y axis. In addition, in the present embodiment, the image plane is substantially horizontal. However, the image plane does not have to be parallel to the XY plane and may be a curved surface.

The substrate stage 2 comprises a substrate holding part 24, which releaseably holds the substrate P, and is capable of moving on a guide surface 18G of the third base plate 18. The substrate stage 2 is capable of holding and moving the substrate P with respect to the projection area PR by the operation of a drive system 25. The drive system 25 comprises a planar motor that comprises sliders 25A, which are disposed on the substrate stage 2, and stators 25B, which are disposed on the third base plate 18. A planar motor that is capable of moving the substrate stage 2 is disclosed in, for example, U.S. Pat. No. 6,452,292. The substrate stage 2 is capable of moving in six directions, namely, the X axial, Y axial, Z axial, θX, θY, and θZ directions, by the operation of the drive system 25.

The substrate stage 2 has an upper surface 26, which is disposed around the substrate holding part 24 and is capable of opposing the emergent surface 23. In the present embodiment, the substrate stage 2 comprises a plate member holding part 27, which is disposed at least partly around the substrate holding part 24 and releaseably holds a lower surface of a plate member T, as disclosed in U.S. Patent Application Publication No. 2007/0177125 and U.S. Patent Application Publication No. 2008/0049209. In the present embodiment, the upper surface 26 of the substrate stage 2 includes an upper surface of the plate member. The upper surface 26 is flat.

The interferometer system 3 comprises a first interferometer unit 3A, which is capable of optically measuring the position of the mask stage 1 (i.e., the mask M) within the XY plane, and a second interferometer unit 3B, which is capable of optically measuring the position of the substrate stage 2 (i.e., the substrate P) within the XY plane. When an exposing process or a prescribed measuring process is performed on the substrate P, the control apparatus 7 controls the positions of the mask stage 1 (i.e., the mask M) and the substrate stage 2 (i.e., the substrate P) by operating the drive systems 20, 25 based on the measurement results of the interferometer system 3.

The liquid immersion member 4 is supported by support mechanisms 28. In the present embodiment, the support mechanisms 28 are supported by the first base plate 13. In the present embodiment, the liquid immersion member 4 is suspended from the first base plate 13 via the support mechanisms 28.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. When the substrate P is to be exposed, the control apparatus 7 controls the mask stage 1 and the substrate stage 2 so as to move the mask M and the substrate P in the prescribed scanning directions within the XY plane, which intersects the optical axis AX (i.e., the optical path of the exposure light EL). In the present embodiment, the scanning directions (i.e., the synchronous movement directions) of both the substrate P and the mask M are the Y axial directions. The control apparatus 7 radiates the exposure light EL to the substrate P through the projection system PL and the liquid LQ in the immersion space LS on the substrate P while moving the substrate P in one of the Y axial directions with respect to the projection area PR of the projection system PL and moving the mask M, synchronized to the movement of the substrate P, in the other Y axial direction with respect to the illumination area IR of the illumination system IL. Thereby, the image of the pattern of the mask M is projected to the substrate P, which is thereby exposed by the exposure light EL.

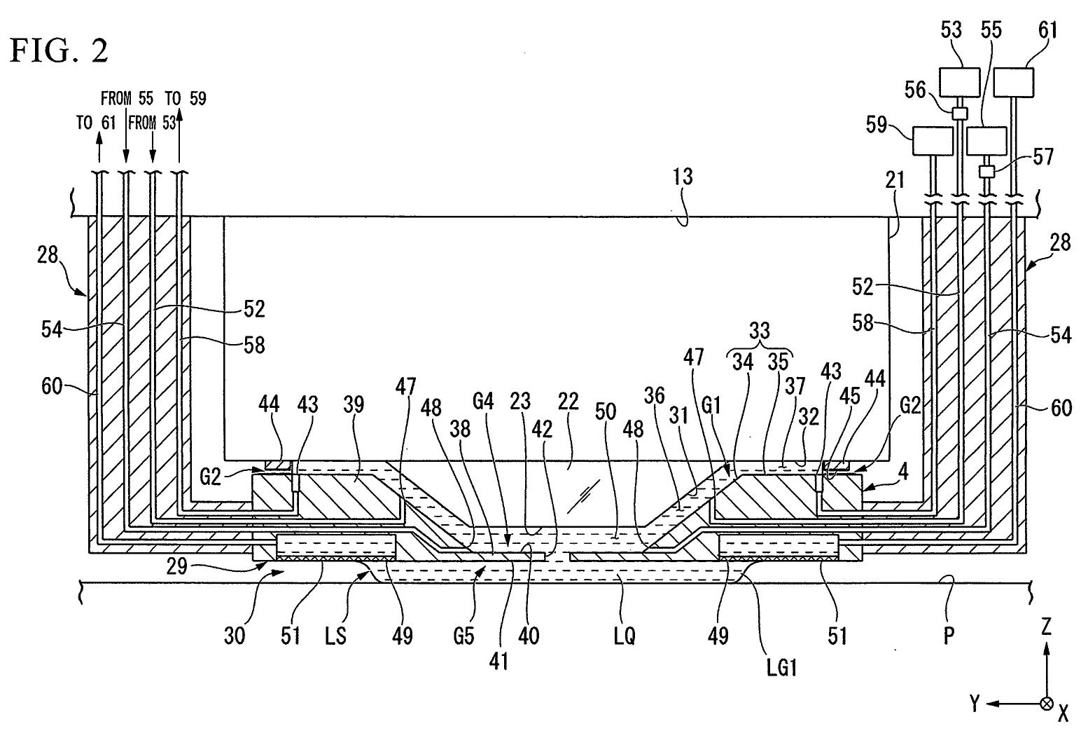

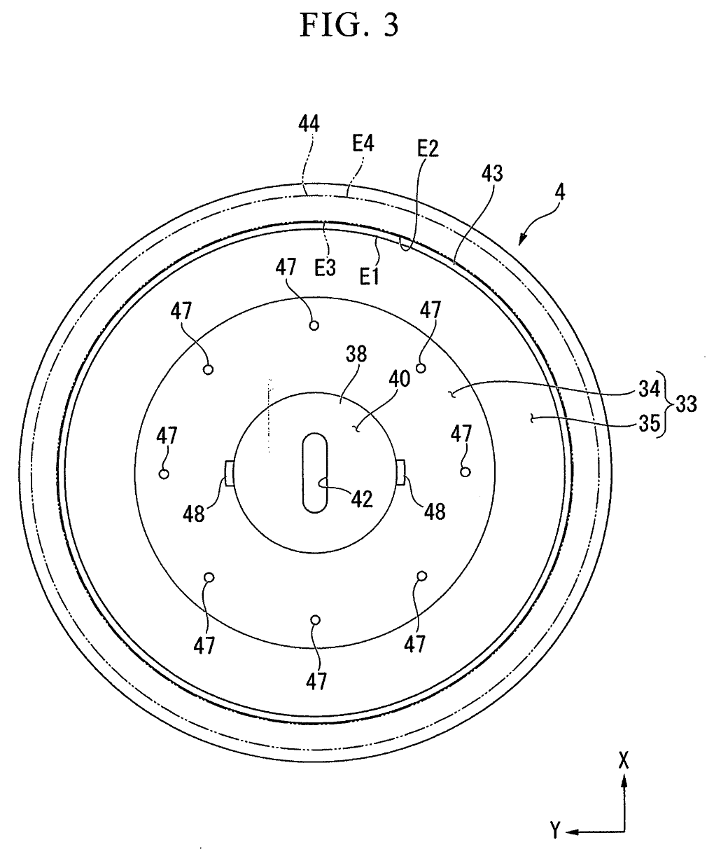

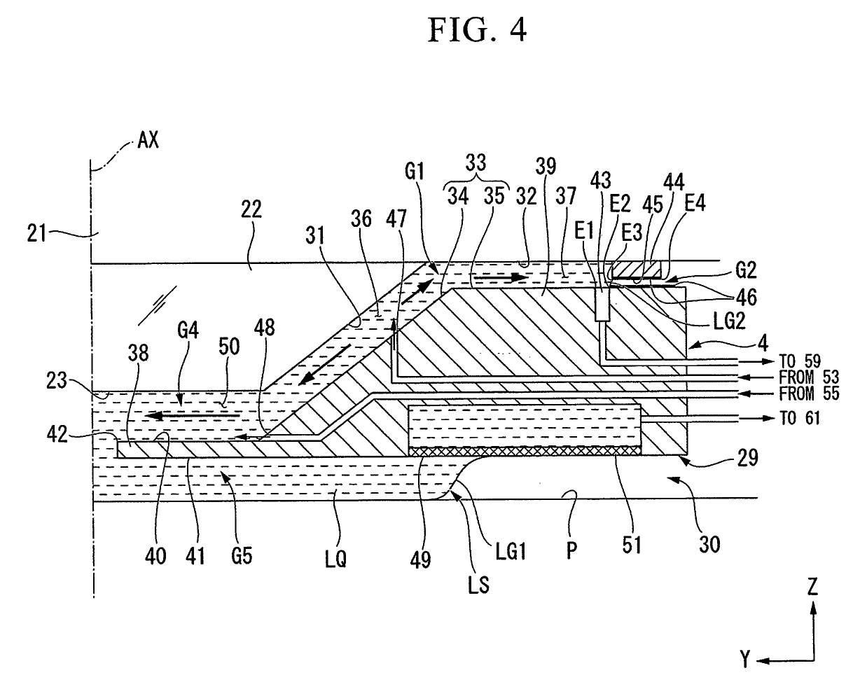

FIG. 2 is a side cross sectional view that shows the vicinity of the liquid immersion member 4, FIG. 3 shows the liquid immersion member 4 viewed from above, and FIG. 4 is a partial enlarged view of FIG. 2. As shown in FIG. 2, FIG. 3, and FIG. 4, the liquid immersion member 4 is disposed in the vicinity of the last optical element 22. The liquid immersion member 4 is disposed at least partly around the optical path of the exposure light EL such that the optical path of the exposure light EL that emerges from the emergent surface 23 is filled with the liquid LQ. In the present embodiment, the liquid immersion member 4 is an annular member. The liquid immersion member 4 is disposed around part of the optical path of the exposure light EL and around the last optical element 22. Furthermore, the liquid immersion member 4 does not have to be torric and may be, for example, rectangular ring-shaped.

The liquid immersion member 4 forms the immersion space LS such that the optical path of the exposure light EL between the emergent surface 23 and an object, which is disposed at a position at which it opposes the emergent surface 23, is filled with the liquid LQ. The immersion space LS is a portion (i.e., a space or area) that is filled with the liquid LQ. In the present embodiment, the object includes the substrate stage 2 (i.e., the plate member T), the substrate P, which is held by the substrate stage 2, or both. During an exposure of the substrate P, the liquid immersion member 4 forms the immersion space LS such that the optical path of the exposure light EL between the last optical element 22 and the substrate P is filled with the liquid LQ.

The liquid immersion member 4 has a lower surface 29, which is capable of opposing the object. A space 30 between the lower surface 29 and the object is capable of holding the liquid LQ. Part of the immersion space LS is formed by the liquid LQ held between the lower surface 29 and the object. In the present embodiment, when the substrate P is irradiated with the exposure light EL, the immersion space LS is already formed such that part of the area of the front surface of the substrate P that includes the projection area PR is covered with the liquid LQ. An interface LG1 (i.e., a meniscus or an edge) of the liquid LQ of the immersion space LS is formed between the lower surface 29 of the liquid immersion member 4 and the front surface (i.e., the upper surface) of the object. The exposure apparatus EX of the present embodiment adopts a local liquid immersion system.

For the sake of simplicity, the text below explains an exemplary case wherein the immersion space LS is formed by disposing the substrate P at a position at which it opposes the emergent surface 23 and the lower surface 29 and holding the liquid LQ between the emergent surface 23 and the lower surface 29 on one side and the front surface of the substrate P on the other side. Furthermore, as discussed above, the immersion space LS can be formed between the emergent surface 23 and the lower surface 29 on one side and the upper surface 26 of the substrate stage 2 (i.e., the plate member T) on the other side.

In the present embodiment, the liquid immersion member 4 has an inner surface 33 that opposes, across a first gap G1: an outer surface 31 of the last optical element 22, an outer surface 32 of the holding member 21 that holds the last optical element 22, or both. In the present embodiment, the inner surface 33 comprises: a first portion 34, which extends in radial directions (i.e., in directions perpendicular to the optical axis AX) with respect to the optical axis AX of the last optical element 22 (i.e., the projection system PL) and in a direction (i.e., the +Z direction) that is the reverse of the direction that the emergent surface 23 of the last optical element 22 faces; and a second portion 35, which is disposed on the outer side of at least part of the first portion 34 with respect to the optical axis AX. In the present embodiment, the second portion 35 is disposed around the first portion 34. The first gap G1 includes a first space 36, which is defined by the first portion 34, and a second space 37, which is defined by the second portion 35.

The outer surface 31 of the last optical element 22 is a surface that is different from and disposed around the emergent surface 23. Namely, the outer surface 31 is a surface wherethrough the exposure light EL does not pass. The outer surface 31 is inclined such that it extends in radial directions (i.e., directions perpendicular to the optical axis AX) with respect to the optical axis AX and in the +Z direction. In the present embodiment, the outer surface 31 and the first portion 34 are opposed. In addition, in the present embodiment, the outer surface 31 and the first portion 34 are substantially parallel. The first space 36 includes a space between the outer surface 31 and the first portion 34. The first space 36 is a space that is inclined such that it extends in radial directions with respect to the optical axis AX and in a direction (i.e., the +Z direction) that leads away from the image plane of the projection system PL. Namely, the first space 36 is a space that is inclined in the +Z direction with respect to the direction that is perpendicular to the optical axis AX (i.e., with respect to the XY plane). Furthermore, the outer surface 31 and the first portion 34 do not have to be parallel. In addition, the outer surface 31, the first portion 34, or both may include a curved surface.

In the present embodiment, the outer surface 32 of the holding member 21 is disposed around the outer surface 31 of the last optical element 22. In the present embodiment, the outer surface 32 and the second portion 35 are opposed. In addition, in the present embodiment, the outer surface 32 and the second portion 35 are substantially parallel. The second space 37 includes a space between the outer surface 32 and the second portion 35. In the present embodiment, the outer surface 32 and the second portion 35 are substantially parallel to the XY plane, and the second space 37 is a space that extends in radial directions with respect to the optical axis AX (i.e., in directions perpendicular to the optical axis AX). Furthermore, the outer surface 32 and the second portion 35 do not have to be substantially parallel to the XY plane. In addition, the outer surface 32 and the second portion 35 do not have to be parallel to one another. In addition, the outer surface 32, the second portion 35, or both may include a curved surface.

In the present embodiment, the liquid immersion member 4 comprises a plate part 38, at least part of which is disposed such that it opposes the emergent surface 23, and a main body part 39, at least part of which is disposed around the last optical element 22. The first portion 34 and the second portion 35 are disposed in the main body part 39. The plate part 38 has an upper surface 40, which opposes the emergent surface 23 across a gap G4, and a lower surface 41, which opposes—across a gap G5—the front surface of the object (e.g., the substrate P) that is disposed such that it opposes the emergent surface 23. In addition, the plate part 38 has an opening 42 wherethrough the exposure light EL that emerges from the emergent surface 23 can pass. During an exposure of the substrate P, the exposure light EL that emerges from the emergent surface 23 is radiated to the front surface of the substrate P through the opening 42.

In the present embodiment, the exposure apparatus EX comprises a first recovery port 43, which is disposed at least partly around the optical axis AX and is capable of recovering the liquid LQ from at least part of the first gap G1, and a protrusion 44 that forms a second gap G2, which is smaller than the first gap G1, on the outer side of the first recovery port 43 with respect to the optical axis AX. In the present embodiment, the first recovery port 43 is disposed annularly around the optical axis AX (i.e., around the first gap G1), and the annular second gap G2 is disposed around the first recovery port 43.

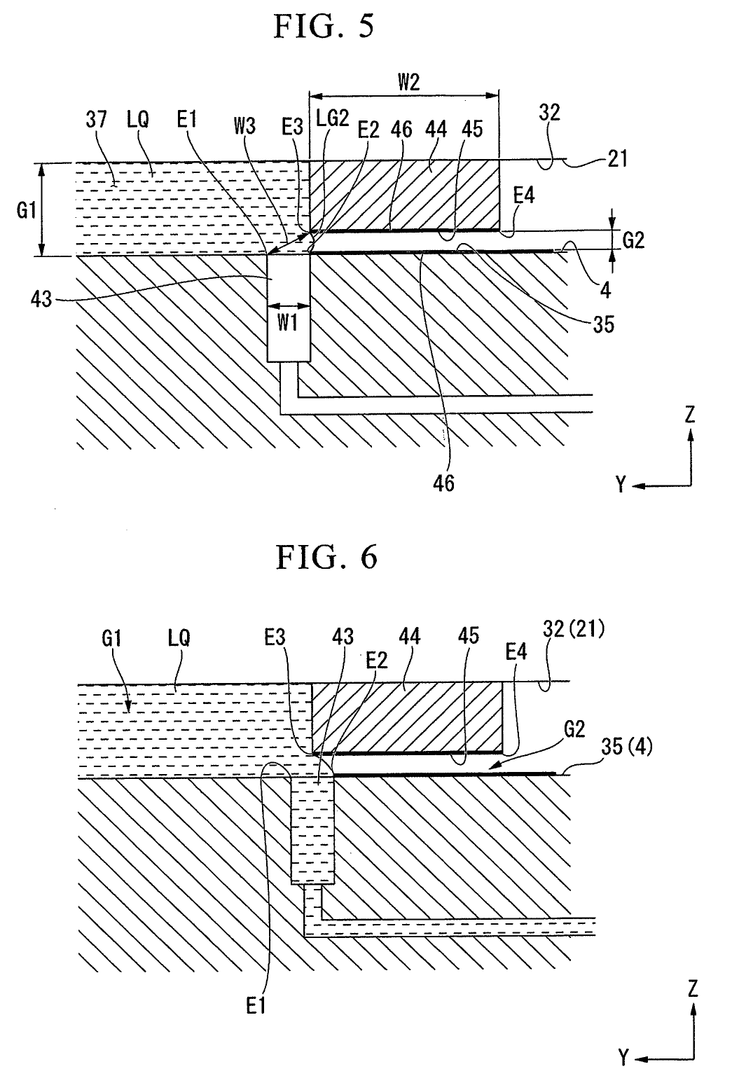

FIG. 5 is a view that shows the vicinity of the first recovery port 43 and the protrusion 44. As shown in FIG. 2 through FIG. 5, in the present embodiment, the first recovery port 43 is provided to the liquid immersion member 4. In the present embodiment, the first recovery port 43 is disposed in the second portion 35. In addition, in the present embodiment, the first recovery port 43 faces the direction (i.e., the +Z direction) that is the reverse of the direction that the emergent surface 23 of the last optical element 22 faces. The first recovery port 43 is capable of recovering the liquid LQ that is from at least part of the first gap G1 and that is not supplied to a space 50 below the emergent surface 23.

In the present embodiment, the protrusion 44 is provided to the holding member 21, which opposes the liquid immersion member 4. The protrusion 44 is disposed such that it surrounds the optical axis AX. Namely, the protrusion 44 is provided annularly within the XY plane and around the first gap G1 (i.e., the second space 37). The protrusion 44 is disposed on the outer surface 32 of the holding member 21 and projects from the outer surface 32 toward the second portion 35 of the liquid immersion member 4. Namely, the protrusion 44 extends downward (i.e., in the −Z direction) from the outer surface 32 of the holding member 21. In the present embodiment, a lower surface 45 of the protrusion 44 that opposes the second portion 35 is substantially parallel to the second portion 35. Namely, in the present embodiment, the lower surface 45 is substantially parallel to the XY plane. The second gap G2 is formed between the lower surface 45 and the second portion 35. The second gap G2 is formed such that it permits the passage of gas from the first gap G1 but prevents the passage of the liquid LQ from the first gap G1. The second gap G2 is preferably formed as small as possible and is preferably set to less than 0.1 mm.

At least one member of the group consisting of the lower surface 45 and the second portion 35, both of which form the second gap G2, is liquid repellent with respect to the liquid LQ. In the present embodiment, the contact angle of the liquid LQ with respect to the lower surface 45, the second portion 35, or both is 90° or greater. In the present embodiment, both the lower surface 45 and the second portion 35 are liquid repellent with respect to the liquid LQ. In the present embodiment, the lower surface 45 and the second portion 35 are each formed from films 46, which are liquid repellent with respect to the liquid LQ. The films 46 are formed from a liquid repellent material that contains, for example, fluorine. Examples of liquid repellent materials include tetrafluoroethylene-perfluoroalkyl vinyl ether copolymer (PFA), polytetrafluoroethylene (PTFE), polyetheretherketone (PEEK), and Teflon®.

Furthermore, only the lower surface 29, which forms the second gap G2, may be liquid repellent with respect to the liquid LQ, or only the second portion 35 may be liquid repellent with respect to the liquid LQ.

In addition, instead of using the films 46, at least part of the protrusion 44 that forms the lower surface 45, at least part of the liquid immersion member 4 that forms the second portion 35, or both may be formed from a liquid repellent member such as tetrafluoroethylene-perfluoro (alkyl vinyl ether) copolymer (PFA), polytetrafluoroethylene (PTFE), polyetheretherketone (PEEK), and the like.

The first recovery port 43 is demarcated by a first edge E1 and a second edge E2, which is disposed on the outer side of the first edge E1 with respect to the optical axis AX. Namely, in the present embodiment, a circular ring-shaped groove is formed in the second portion 35 around the optical axis AX, and the first recovery port 43 includes an upper end of that groove. The first edge E1 is a circular ring-shaped edge (i.e., a corner part) on the inner side near the optical axis AX, and the second edge E2 is a circular ring-shaped edge (i.e., a corner part) on the outer side further from the optical axis AX than the first edge E1. The first recovery port 43 (i.e., the upper end of the groove) is demarcated by the first edge E1 and the second edge E2.

The protrusion 44 forms the second gap G2 on the outer side of the second edge E2 with respect to the optical axis AX. In the present embodiment, the second gap G2 is formed such that it is adjacent to the second edge E2.

The protrusion 44 has a third edge E3, which is disposed such that it surrounds the optical axis AX, and a fourth edge E4, which is disposed on the outer side of the third edge E3 with respect to the optical axis AX. The lower surface 45 of the protrusion 44 is disposed between the third edge E3 and the fourth edge E4. The third edge E3 is an edge (i.e., a corner part) on the inner side near the optical axis AX, and the fourth edge E4 is an edge (i.e., a corner part) on the outer side far from the optical axis AX.

In the present embodiment, a distance W1 (i.e., a width) between the first edge E1 and the second edge E2 in the radial directions with respect to the optical axis AX (i.e., in the directions perpendicular to the optical axis AX) is smaller than a distance W2 (i.e., a width) between the third edge E3 and the fourth edge E4 in the radial directions.

In addition, in the present embodiment, the distance W1 between the first edge E1 and the second edge E2 is smaller than the first gap G1 (i.e., the distance between the outer surface 32 of the holding member 21 and the second portion 35 of the liquid immersion member 4 in the Z axial directions) and larger than the second gap G2 (i.e., the distance between the lower surface 45 of the protrusion 44 and the second portion 35 of the liquid immersion member 4 in the Z axial directions).

In addition, the fourth edge E4 is disposed in the radial directions with respect to the optical axis AX on the outer side of the second edge E2. In the present embodiment, the second edge E2 and the third edge E3 are disposed at substantially the same position in the radial directions with respect to the optical axis AX. Accordingly, in the present embodiment, the position of the inner side edge of the second gap G2 is substantially the same as that of the second edge E2 and the third edge E3 in the directions perpendicular to the optical axis AX, and the position of the outer side edge of the second gap G2 is substantially the same as that of the fourth edge E4.

In addition, in the present embodiment, a distance W3 between the first edge E1 and the third edge E3 is smaller than the first gap G1.

In addition, in the present embodiment, the exposure apparatus EX is provided with first supply ports 47, which supply the liquid LQ to the first gap G1. In the present embodiment, the first supply ports 47 are disposed in the inner surface 33 of the liquid immersion member 4. In the present embodiment, the first supply ports 47 are disposed in the first portion 34 of the liquid immersion member 4 that opposes the outer surface 31 of the last optical element 22. The first recovery port 43 is disposed such that it is spaced apart from the first supply ports 47 with respect to the optical axis AX. In the present embodiment, the first supply ports 47 are disposed such that they are equispaced around the optical axis AX. As shown in FIG. 3, in the present embodiment, the first supply ports 47 are disposed at 45° intervals around the optical axis AX. Furthermore, the positions and the number of the first supply ports 47 are not limited to the case shown in FIG. 3 and can be set arbitrarily.

As shown in FIG. 2 and FIG. 4, in the present embodiment, the first supply ports 47 face the direction (i.e., the +Z direction) that is the reverse of the direction that the emergent surface 23 faces. Furthermore, the first supply ports 47 do not have to face the +Z direction.

In addition, the liquid immersion member 4 comprises second supply ports 48, which supply the liquid LQ, and a second recovery port 49, which is capable of recovering the liquid LQ. The second supply ports 48 are disposed in the inner surface 33 of the liquid immersion member 4. The second supply ports 48 are disposed closer to the emergent surface 23 than the first supply ports 47 are. In the present embodiment, the second supply ports 48 are disposed such that they face the space 50 between the emergent surface 23 and the upper surface 40 of the plate part 38. The second supply ports 48 supply the liquid LQ to the optical path of the exposure light EL. As shown in FIG. 3, in the present embodiment, the second supply ports 48 are disposed such that there is one on the +Y side and one on −Y side with respect to the optical axis AX. Furthermore, the second supply ports 48 may be disposed such that there is one on the +X side and one on the −X side with respect to the optical axis AX. In addition, the number of the second supply ports 48 may be three or greater.

Furthermore, the second supply ports 48 are disposed at positions at which they oppose the outer surface 31 of the last optical element 22.

Furthermore, the number of the first supply ports 47 and the number of the second supply ports 48 may be the same. In addition, the positions of the first supply ports 47 and the positions of the second supply ports 48 may be the same in the circumferential directions with respect to the optical axis AX or they may be different.

The second recovery port 49 is disposed in the lower surface 29 of the liquid immersion member 4. The second recovery port 49 is capable of recovering the liquid LQ on the front surface of the object (e.g., the substrate P) that is disposed such that it opposes the lower surface 29 of the liquid immersion member 4. Namely, the liquid LQ on the front surface of the object (i.e., the substrate P and the like) that is disposed such that it opposes the second recovery port 49 can be recovered by the second recovery port 49.

The second recovery port 49 is disposed at least partly around the lower surface 41 of the plate part 38. In the present embodiment, the second recovery port 49 is disposed annularly around the lower surface 41. In addition, in the present embodiment, a porous member 51 is disposed in the second recovery port 49. In the present embodiment, the porous member 51 is plate shaped and has a plurality of holes (i.e., openings or pores). Furthermore, the porous member 51 may be a mesh filter, which is a porous member wherein numerous small holes are formed as a mesh.

In the present embodiment, the lower surface 29 of the liquid immersion member 4 includes the lower surface 41 of the plate part 38 and the lower surface of the porous member 51.

As shown in FIG. 2, the first supply ports 47 are connected to a first liquid supply apparatus 53 via supply passageways 52. In the present embodiment, the supply passageways 52 comprise passageways that are formed inside the liquid immersion member 4 and passageways that are formed inside the support mechanisms 28. Similarly, the second supply ports 48 are connected to a second liquid supply apparatus 55 via supply passageways 54. The first and second liquid supply apparatuses 53, 55 can supply the clean, temperature-adjusted liquid LQ to the first and second supply ports 47, 48. Furthermore, parts of the supply passageways 52 and/or parts of the supply passageways 54 do not have to be provided inside the support mechanisms 28 that support the liquid immersion member 4.

The control apparatus 7 is capable of adjusting the amount of the liquid LQ that is supplied per unit of time via each of the first supply ports 47 and the second supply ports 48. In the present embodiment, adjusting apparatuses 56, 57, which are called mass flow controllers and are capable of adjusting the amount of liquid LQ supplied per unit of time, are disposed in the supply passageways 52 and the supply passageways 54, respectively. The control apparatus 7 controls the operation of the adjustment apparatuses 56, 57. The control apparatus 7 is capable of separately adjusting the amount of the liquid LQ supplied per unit of time via the first supply ports 47 and the second supply ports 48 by separately controlling the adjusting apparatuses 56, 57. In addition, the control apparatus 7 is capable of adjusting the flow speeds of the liquid LQ supplied via the first and second supply ports 47, 48 by adjusting the amounts of the liquid LQ supplied via the first and second supply ports 47, 48.

Furthermore, the total amount of the liquid LQ supplied via all of the first supply ports 47 may be the same as or different from the total amount of the liquid LQ supplied via all of the second supply ports 48. In addition, the amount of the liquid LQ supplied via one of the first supply ports 47 may be the same as or different from the amount of the liquid LQ supplied via one of the second supply ports 48.

In addition, the plurality of passageways that branch from one supply passageway may be connected to the first supply ports 47 and the second supply ports 48.

The first recovery port 43 is connected to a first liquid recovery apparatus 59 via recovery passageways 58. In the present embodiment, the recovery passageways 58 comprise passageways that are formed inside the liquid immersion member 4 and passageways that are formed inside the support mechanisms 28. Similarly, the second recovery port 49 is connected to a second liquid recovery apparatus 61 via recovery passageways 60. The first and second liquid recovery apparatuses 59, 61 each comprise a vacuum system (such as, a valve that controls the connection state between the vacuum source and the recovery port) and can recover the liquid LQ via the first and second recovery ports 43, 49 by suctioning the liquid LQ. Furthermore, part of the recovery passageways 58 and/or part of the recovery passageways 60 do not have to be provided inside the support mechanisms 28 that support the liquid immersion member 4.

The control apparatus 7 is capable of separately adjusting the amounts of the liquid LQ recovered per unit of time via the first recovery port 43 and the second recovery port 49. In addition, by controlling the second liquid recovery apparatus 61, the control apparatus 7 can control the pressure differential between the lower surface side and the upper surface side of the porous member 51 such that only the liquid LQ passes through the porous member 51 from the lower surface side (i.e., the space 30 side) to the upper surface side (i.e., the recovery passageways 60 side). In the present embodiment, the pressure of the space 30 on the lower surface side is controlled by the chamber apparatus 5 and is substantially atmospheric pressure. By controlling the second liquid recovery apparatus 61, the control apparatus 7 adjusts the pressure on the upper surface side in accordance with the pressure on the lower surface side such that only the liquid LQ passes through the porous member 51 from the lower surface side to the upper surface side. Namely, the control apparatus 7 performs adjustments such that only the liquid LQ on the substrate P is recovered via the holes of the porous member 51 and such that the gas does not pass through the holes of the porous member 51. The technology for adjusting the pressure differential between the one side and the other side of the porous member 51 and thereby causing only the liquid LQ to pass through from the one side to the other side of the porous member 51 is disclosed in, for example, U.S. Pat. No. 7,292,313.

In the present embodiment, the control apparatus 7 is capable of forming the immersion space LS with the liquid LQ between the last optical element 22 and the liquid immersion member 4 on one side and the object (such as the substrate P) that opposes the last optical element 22 and the liquid immersion member 4 on the other side by performing a liquid recovery operation, wherein the second recovery port 49 is used, in parallel with a liquid supply operation, wherein the second supply ports 48 are used.

The following explains a method of using the exposure apparatus EX that has the abovementioned configuration to expose the substrate P.

The control apparatus 7 performs the operation of recovering the liquid LQ via the second recovery port 49 in parallel with the operation of supplying the liquid LQ via the second supply ports 48, uses the liquid immersion member 4 to form the immersion space LS between the last optical element 22 and the liquid immersion member 4 on one side and the substrate P on the other side such that the optical path of the exposure light EL between the emergent surface 23 of the last optical element 22 and the substrate P is filled with the liquid LQ, and then starts the exposure of the substrate P that is held by the substrate stage 2. The control apparatus 7 radiates the exposure light EL that emerges from the emergent surface 23 to the substrate P through the liquid LQ of the immersion space LS.

In the present embodiment, as shown in FIG. 4, the control apparatus 7 performs the operation of supplying the liquid LQ via the first supply ports 47 at least during the exposure of the substrate P. The first supply ports 47 supply the liquid LQ to the first gap G1. In the present embodiment, the first supply ports 47 face the first space 36, and at least some of the liquid LQ supplied via the first supply ports 47 to the first gap G1 (i.e., the first space 36) contacts the outer surface 31 of the last optical element 22 and flows upward (i.e., in the +Z direction) along the outer surface 31 and the first portion 34 and in directions away from the optical axis AX. Namely, the majority of the liquid LQ that is supplied via the first supply ports 47 flows along the first space 36 in a direction that is the reverse of the direction that the emergent surface 23 faces and in radial directions with respect to the optical axis AX (i.e., in directions perpendicular to the optical axis AX).

In the first space 36, the liquid LQ that flows upward and in directions away from the optical axis AX flows into the second space 37. The direction of the liquid LQ that flows from the first space 36 into the second space 37 is changed by the outer surface 32 of the holding member 21, and the liquid LQ then flows along the second space 37 horizontally and in directions away from the optical axis AX. Namely, in the second space 37, the liquid LQ flows parallel to the XY plane and in radial directions with respect to the optical axis AX.

In the present embodiment, by controlling the adjusting apparatus 56, the control apparatus 7 adjusts the amount of the liquid LQ supplied per unit of time via the first supply ports 47 such that the liquid LQ supplied via the first supply ports 47 flows evenly at a low speed in the first gap G1 and such that the first gap G1 is substantially filled with the liquid LQ.

Thus, in the present embodiment, the control apparatus 7 generates the flow of the liquid LQ in directions away from the optical axis AX of the first gap G1 by supplying the liquid LQ via the first supply ports 47 to the first gap G1.

In the second space 37, the liquid LQ that flows in the directions away from the optical axis AX is recovered via the first recovery port 43. The first recovery port 43 recovers the liquid LQ from at least part of the first gap G1. Thereby, the space in the first gap G1 between the first supply ports 47 and the first recovery port 43 can be substantially filled continuously with the liquid LQ. In addition, the flow of the liquid LQ to the outer side of the first recovery port 43 with respect to the optical axis AX is prevented. In the present embodiment, the first recovery port 43 can recover the liquid LQ, along with the gas, from at least part of the first gap G1.

In addition, in the present embodiment, the second gap G2, which is smaller than the first gap G1, is formed on the outer side of the first recovery port 43 with respect to the optical axis AX, and therefore prevents the liquid LQ from flowing from the first gap G1 to the outer side of the first recovery port 43 with respect to the optical axis AX. In addition, because the lower surface 45 and the second portion 35 that form the second gap G2 are liquid repellent with respect to the liquid LQ, it is possible to effectively prevent the liquid LQ from penetrating the second gap G2.

As discussed above, the distance between the lower surface of the protrusion 44 and the second portion 35 is preferably as small as possible such that the liquid LQ (i.e., an interface LG2) cannot pass through the second gap G2. In addition, providing the protrusion 44 in this manner makes it possible to reduce the surface area of the interface LG2 (i.e., a meniscus or edge) of the liquid LQ that is present in the first gap G1 (i.e., the second space 37), namely, the surface area over which the liquid LQ contacts the gas.

As shown in FIG. 5, the distance between the third edge E3 and the second edge E2 is extremely small. Accordingly, as shown in FIG. 5, if only the liquid LQ is recovered via the first recovery port 43, then it is possible to prevent the vaporization of the liquid LQ because the interface LG2 of the liquid LQ is formed between the third edge E3 and the second edge E2. In addition, as shown in FIG. 5, the distance W3 between the third edge E3 and the first edge E1 is also extremely small (e.g., less than 1 mm). Accordingly, even in a situation wherein the state transitions back and forth between the state wherein the interface LG2 of the liquid LQ is formed between the third edge E3 and the second edge E2 and the state wherein the interface LG2 of the liquid LQ is formed between the third edge E3 and the first edge E1, the surface area of the interface LG2 of the liquid LQ is small, which also makes it possible to reduce the fluctuations that the liquid LQ inside the first gap G1 exerts upon the liquid immersion member 4, the holding member 21, the last optical element 22, or any combination thereof.

In addition, some of the liquid LQ that is supplied via the first supply ports 47 to the first gap G1 contacts the outer surface 31 of the last optical element 22, flows along the outer surface 31 and the first portion 34 downward and in directions that approach the optical axis AX, and is supplied to the optical path of the exposure light EL. Namely, some of the liquid LQ that is supplied via the first supply ports 47 flows in the direction (i.e., the −Z direction) in which the emergent surface 23 faces and in directions that approach the optical axis AX. Thus, on the lower side (i.e., the −Z side) of the first supply ports 47 as well, the first space 36 can be filled with the liquid LQ. Accordingly, in the present embodiment, the liquid recovery operation wherein the first recovery port 43 is used is performed in parallel with the liquid supply operation wherein the first supply ports 47 are used, which makes it possible to continuously fill the first gap G1 with the clean, temperature-adjusted liquid LQ while preventing the liquid LQ from flowing out of the first gap G1. In addition, in the present embodiment, the liquid recovery operation wherein the second recovery port 49 is used is performed in parallel with the liquid supply operation wherein the first supply ports 47 and the second supply ports 48 are used, which makes it possible to continuously fill the optical path of the exposure light EL that emerges from the emergent surface 23 with the clean, temperature-adjusted liquid LQ while preventing the liquid LQ from flowing out of the optical path.

As explained above, according to the present embodiment, the first recovery port 43 and the protrusion 44, which forms the second gap G2 on the outer side of the first recovery port 43, are provided, and it is thereby possible to prevent the liquid LQ from flowing to the outer side of the first recovery port 43. According to the present embodiment, even if the liquid LQ is supplied to the first gap G1, the first recovery port 43 and the second gap G2 (i.e., the protrusion 44) can effectively prevent the liquid LQ from flowing out of the first gap G1 to the outer side thereof. Accordingly, it is possible to prevent exposure failures from occurring and defective devices from being produced.

In addition, according to the present embodiment, the liquid LQ is supplied via the first supply ports 47 to the first gap G1, which makes it possible to fill the first gap G1 with the clean, temperature adjusted liquid LQ supplied via the first supply ports 47. In addition, supplying the liquid LQ via the first supply ports 47 generates a flow of the liquid LQ in the first gap G1 toward the directions away from the optical axis AX, which makes it possible to recover at least some of the liquid LQ via the first recovery port 43. Thereby, it is possible to continuously fill the first gap G1 with the clean, temperature-adjusted liquid LQ while preventing the liquid LQ from flowing out thereof. Accordingly, the presence of foreign matter (i.e., contaminant) in the first gap G1, the contamination of the liquid LQ in the first gap G1, and the like are prevented.

In addition, according to the present embodiment, the first gap G1 is filled with the liquid LQ by supplying the liquid LQ to the first gap G1 via the first supply ports 47, and therefore the intermixing of the gas (bubbles and the like) from the first gap G1 in the liquid LQ that is present in the optical path of the exposure light EL is prevented. Accordingly, it is possible to prevent the occurrence of exposure failures caused by that gas and thereby the production of defective devices. In addition, in the present embodiment, the first gap G1 is filled with the clean, temperature-adjusted liquid LQ that is supplied via the first supply ports 47, which makes it possible to prevent the temperature of the holding member 21, the last optical element 22, the liquid immersion member 4, or any combination thereof from changing. In addition, in the present embodiment, the interface LG2 of the liquid LQ in the first gap G1 that flows in the directions away from the optical axis AX is comparatively spaced apart from the optical axis AX, which makes it possible to prevent the temperature of the last optical element 22, the liquid LQ in the optical path of the exposure light EL, or both from changing as a result of the vaporization of the liquid LQ, which tends to occur at the interface LG2. In addition, in the present embodiment, the interface LG2 of the liquid LQ in the first gap G1 is formed stably in the vicinity of the first recovery port 43; therefore, it is possible to prevent pressure fluctuations in the liquid LQ from affecting the holding member 21, the last optical element 22, the liquid immersion member 4, or any combination thereof. Accordingly, it is possible to prevent fluctuations in the position and in the optical characteristics of the last optical element 22.

In addition, in the present embodiment, the provision of the adjusting apparatuses 56, 57 makes it possible to separately adjust the amounts of the liquid LQ that are supplied per unit of time to the first and second supply ports 47, 48. For example, increasing the amount of the liquid LQ that is supplied via the first supply ports 47 makes it possible to more effectively prevent the intermixing of the gas from the first gap G1 in the liquid LQ that is present in the optical path of the exposure light EL. In addition, increasing the amount of the liquid LQ that is supplied via the second supply ports 48 makes it possible to anticipate the effect wherein the liquid LQ adjusts the temperature of the last optical element 22, the liquid immersion member 4, or both. In addition, decreasing the amount of the liquid LQ supplied via the second supply ports 48 makes it possible to restrict the amount of the liquid LQ that flows into the space 30; therefore, it is possible to reduce the amount of the liquid LQ recovered at the second recovery port 49 and to thereby prevent, for example, the liquid LQ from remaining on the substrate P. In addition, it is also possible to adjust the amounts of the liquid LQ supplied via the first and second supply ports 47, 48 in accordance with the shape of the holding member 21, the last optical element 22, the liquid immersion member 4 (all of which form the first gap G1), or any combination thereof. Thus, it is possible to appropriately adjust the amounts of the liquid LQ supplied via the first and second supply ports 47, 48 in accordance with, for example, the desired effect or the shapes of the members that form the first gap G1.

Furthermore, the present embodiment explained an exemplary case wherein the second edge E2 of the first recovery port 43 and the third edge E3 of the protrusion 44 are disposed at substantially the same position in radial directions with respect to the optical axis AX (i.e., in directions perpendicular to the optical axis AX); however, as shown in FIG. 6, at least part of the first recovery port 43 may oppose the lower surface 45 of the protrusion 44. In the example shown in FIG. 6, the second edge E2 is disposed between the third edge E3 and the fourth edge E4 and the first edge E1 is disposed on the inner side of the third edge E3 in radial directions with respect to the optical axis AX. Namely, in the example of FIG. 6, the distance between the optical axis AX and the third edge E3 in directions perpendicular to the optical axis AX is longer than the distance between the optical axis AX and the first edge E1 and shorter than the distance between the optical axis AX and the second edge E2. As in the example of FIG. 6, even if at least part of the first recovery port 43 opposes the lower surface 45 of the protrusion 44, it is possible to fill the first gap G1 continuously with the liquid LQ supplied via the first supply ports 47 while preventing the liquid LQ from flowing out of the first gap G1 because the second gap G2, which is smaller than the first gap G1, is provided on the outer side of the first recovery port 43 with respect to the optical axis AX.

Furthermore, the protrusion 44 and the first recovery port 43 may be provided such that the distance between the optical axis AX and the third edge E3 and the distance between the optical axis AX and the first edge E1 are substantially the same in the directions perpendicular to the optical axis AX. In addition, if the liquid LQ can be recovered smoothly from the first gap G1, then the protrusion 44 and the first recovery port 43 may be provided such that the distance between the optical axis AX and the third edge E3 is shorter than the distance between the optical axis AX and the first edge E1 in the directions perpendicular to the optical axis AX.

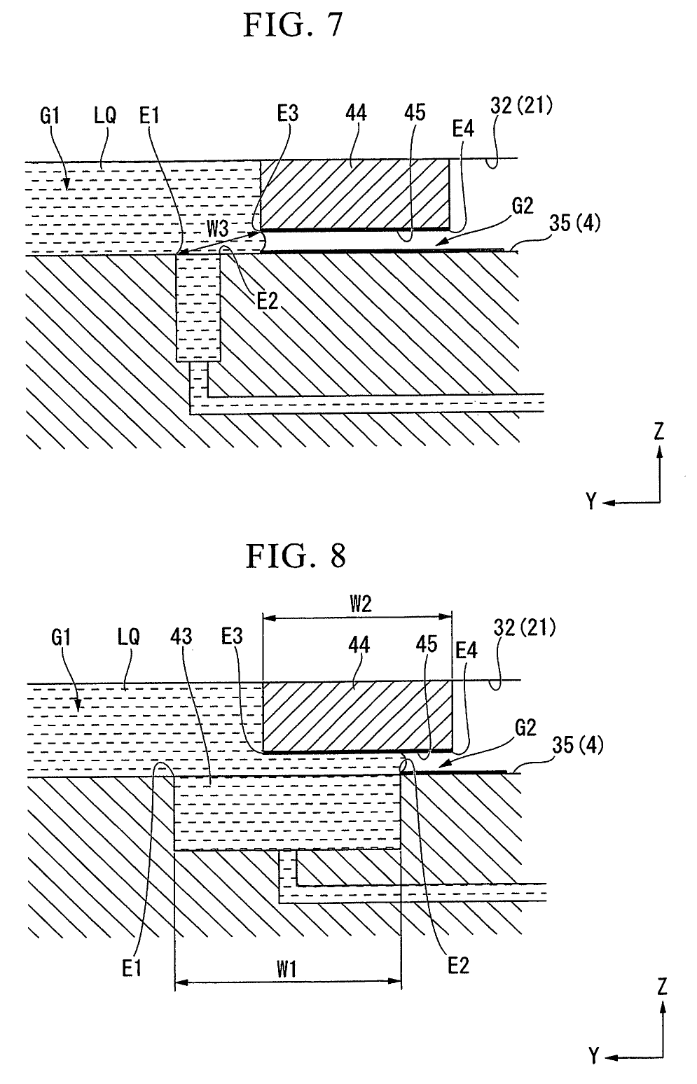

In addition, as shown in FIG. 7, the second edge E2 may be disposed on the inner side of the third edge E3 in radial directions with respect to the optical axis AX (i.e., in directions perpendicular to the optical axis AX. Namely, the protrusion 44 and the first recovery port 43 may be provided such that the distance between the optical axis AX and the third edge E3 is longer than the distance between the optical axis AX and the second edge E2 in the directions perpendicular to the optical axis AX. In the example shown in FIG. 7 as well, the distance W3 between the first edge E1 and the third edge E3 is smaller than the first gap G1. In the example shown in FIG. 7 as well, the first recovery port 43 and the second gap G2 make it possible to fill the first gap G1 continuously with the liquid LQ supplied via the first supply ports 47 while preventing the liquid LQ from flowing out of the first gap G1.

In addition, as shown in FIG. 8, the first recovery port 43 and the protrusion 44 may be provided such that the distance W1 between the first edge E1 and the second edge E2 is larger than the distance W2 between the third edge E3 and the fourth edge E4 in radial directions with respect to the optical axis AX (i.e., in directions perpendicular to the optical axis AX). In the example shown in FIG. 8 as well, the first recovery port 43 provided in the liquid immersion member 4 and the second gap G2 formed between the second portion 35 of the liquid immersion member 4 and the lower surface 45 of the protrusion 44 make it possible to fill the first gap G1 with the liquid LQ while preventing the liquid LQ from flowing out of the first gap G1. In addition, in the example shown in FIG. 8, the distance W1 between the first edge E1 and the second edge E2 is larger than the first gap G1 (i.e., the distance between the outer surface 32 of the holding member 21 and the second portion 35 of the liquid immersion member 4 in the Z axial directions); however, the first recovery port 43 and the protrusion 44 may be provided such that the distance W1 is smaller than the first gap G1. Namely, the first recovery port 43 and the protrusion 44 may be provided such that the distance W1 is smaller than either the distance W2 or the first gap G1 but larger than the other one. In addition, in the example of FIG. 8, the distance between the optical axis AX and the third edge E3 is longer than the distance between the optical axis AX and the first edge E1 and shorter than the distance between the optical axis AX and the second edge E2 in the directions perpendicular to the optical axis AX; furthermore, the distance between the optical axis AX and the second edge E2 is shorter than the distance between the optical axis AX and the fourth edge E4; however, the positions of the first edge E1, the second edge E2, the third edge E3, and the fourth edge E4 in the directions perpendicular to the optical axis AX can be appropriately determined as was explained referencing FIG. 5 through FIG. 7.

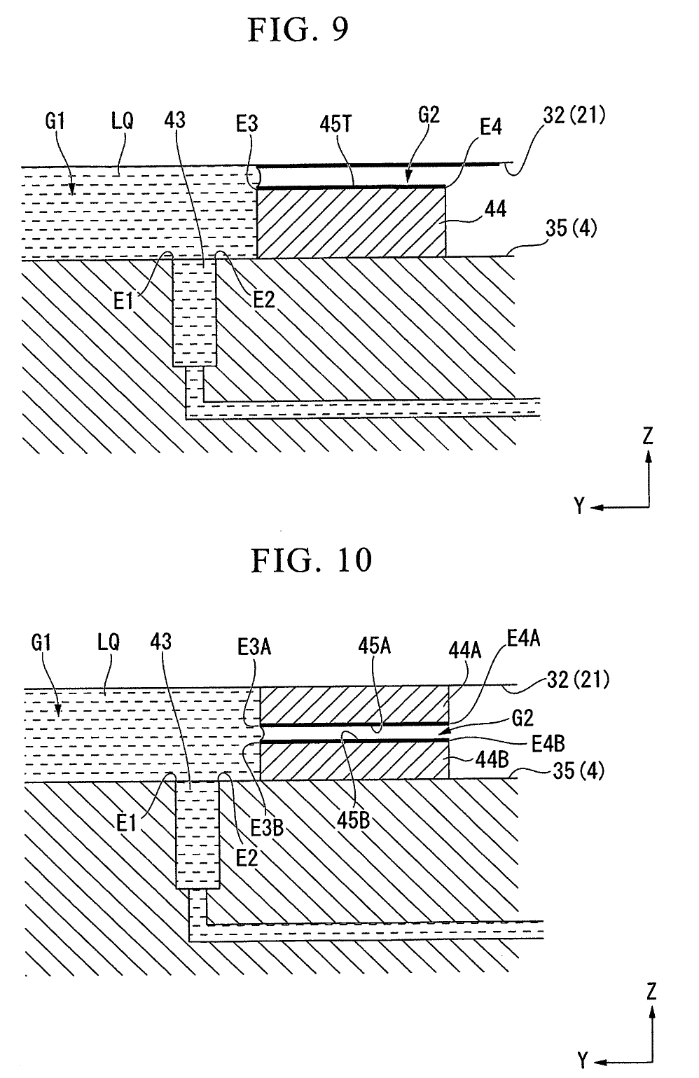

In addition, in each of the examples discussed above, the first recovery port 43 is disposed in the liquid immersion member 4 and the protrusion 44 is disposed on the holding member 21; however, as shown in FIG. 9, the first recovery port 43 and the protrusion 44 may both be disposed in the liquid immersion member 4. In FIG. 9, the protrusion 44 is disposed in the second portion 35 of the liquid immersion member 4 and protrudes in the +Z direction from the second portion 35 toward the outer surface 32 of the holding member 21. In present embodiment, the second gap G2 is formed between an upper surface 45T of the protrusion 44 and the outer surface 32. In addition, the upper surface 45T and the outer surface 32 are liquid repellent with respect to the liquid LQ. In addition, the second gap G2 (i.e., the distance between the upper surface 45T and the outer surface 32 in the Z axial directions) is, for example, less than 0.1 mm. In the example shown in FIG. 9 as well, the second gap G2 is formed on the outer side of the first recovery port 43 with respect to the optical axis AX. Accordingly, it is possible to fill the first gap G1 with the liquid LQ while preventing the liquid LQ from flowing out of the first gap G1. Furthermore, only the upper surface 45T or only the outer surface 32 may be liquid repellent. In addition, in the example of FIG. 9 as well, the positions of the first edge E1, the second edge E2, the third edge E3, and the fourth edge E4 in the directions perpendicular to the optical axis AX can be appropriately determined as was explained referencing FIG. 5 through FIG. 8.

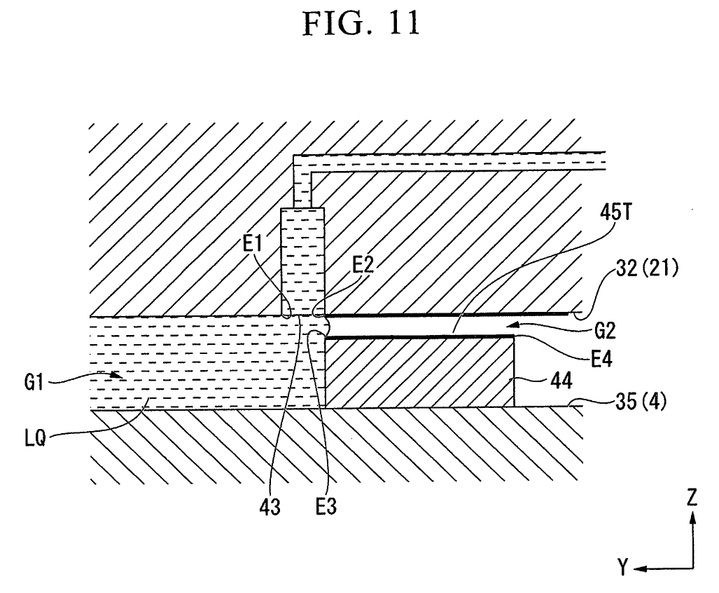

In addition, as shown in FIG. 10, the first recovery port 43 may be disposed in the liquid immersion member 4 and annular protrusions 44A, 44B may be disposed on the holding member 21 and the liquid immersion member 4, respectively. In FIG. 10, the protrusion 44A is disposed on the outer surface 32 of the holding member 21 and protrudes in the −Z direction from the outer surface 32 toward the liquid immersion member 4. The protrusion 44B is disposed on the second portion 35 of the liquid immersion member 4 and protrudes in the +Z direction from the second portion 35 toward the holding member 21. In the example shown in FIG. 10, the second gap G2 is formed between a lower surface 45A, which is between a third edge E3A and a fourth edge E4A of the protrusion 44A, and an upper surface 45B, which is between a third edge E3B and a fourth edge E4B of the protrusion 44B. The lower surface 45A of the protrusion 44A and the upper surface 45B of the protrusion 44B are liquid repellent with respect to the liquid LQ. The gap G2 is extremely small—for example, less than 0.1 mm. In the example shown in FIG. 10 as well, it is possible to fill the first gap G1 with the liquid LQ while preventing the liquid LQ from flowing out of the first gap G1 because the second gap G2 is disposed on the outer side of the first recovery port 43 with respect to the optical axis AX. Furthermore, only the lower surface 45A or only the upper surface 45B may be liquid repellent. In addition, in the example of FIG. 10, the distances of the third edge E3A and the third edge E3B from the optical axis AX are substantially the same, but they may be different. Similarly, in the example of FIG. 10, the distances of the fourth edge E4A and the fourth edge E4B from the optical axis AX are substantially the same, but they may be different. In addition, in the present embodiment of FIG. 10 as well, the positions of the first edge E1, the second edge E2, the third edges E3A, E3B, and the fourth edges E4A, E4B in the directions perpendicular to the optical axis AX can be appropriately determined as was explained referencing FIG. 5 through FIG. 8.

In addition, as shown in FIG. 11, the first recovery port 43 may be disposed in the holding member 21 and the protrusion 44 may be disposed on the liquid immersion member 4. Similar to the example of FIG. 9, in the present embodiment as well, the second gap G2 is formed between the upper surface 45T of the protrusion 44 and the outer surface 32. The upper surface 45T and the outer surface 32, which form the gap G2, are liquid repellent with respect to the liquid LQ. In addition, the gap G2 is extremely small—for example, less than 0.1 mm. In the example of FIG. 11 as well, it is possible to fill the first gap G1 with the liquid LQ while preventing the liquid LQ from flowing out of the first gap G1 because the second gap G2 is disposed on the outer side of the first recovery port 43 with respect to the optical axis AX. Furthermore, only the upper surface 45T or only the outer surface 32 may be liquid repellent. In addition, as in the example of FIG. 11, even if the first recovery port 43 is formed in a member (i.e., the holding member 21) that opposes the liquid immersion member 4, the positions of the first edge E1, the second edge E2, the third edge E3, and the fourth edge E4 in the directions perpendicular to the optical axis AX can be appropriately determined as was explained referencing FIG. 5 through FIG. 8. In addition, although omitted in the drawings, even if the first recovery port 43 is disposed in the member (i.e., the holding member 21) that opposes the liquid immersion member 4, a protrusion may be disposed in the member (i.e., the holding member 21) that opposes the liquid immersion member 4 as in the examples of FIG. 5 through FIG. 8, or protrusions may be disposed in both the liquid immersion member 4 and the member (i.e., the holding member 21) that opposes the liquid immersion member 4 as in the example of FIG. 10.

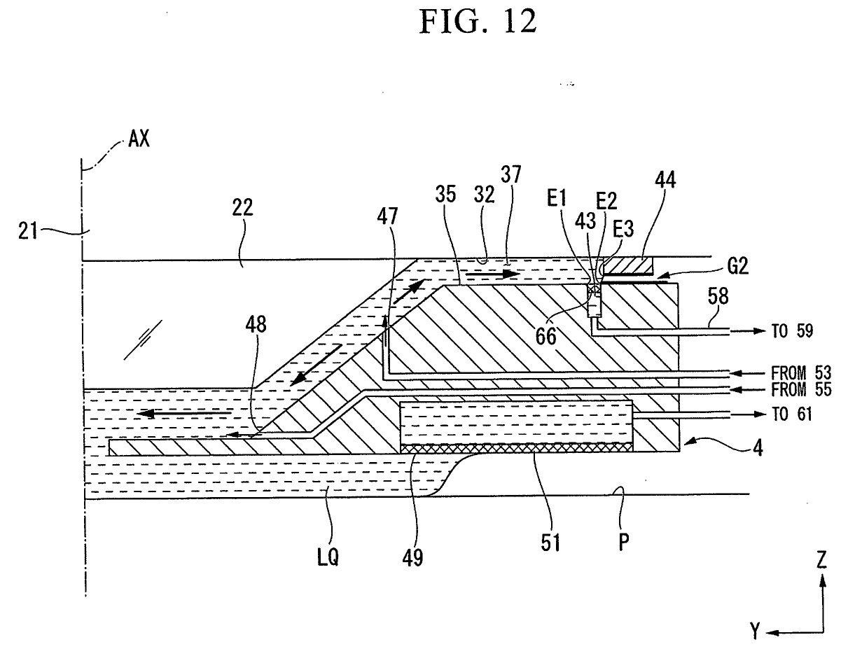

Furthermore, in each of the examples discussed above, the porous member may be disposed in the first recovery port 43. FIG. 12 shows one example wherein a porous member 66 is disposed in the first recovery port 43 and illustrates a case wherein the porous member 66 is disposed in the first recovery port 43 that was explained in FIG. 5. The porous member 66 is plate shaped and has a plurality of holes (i.e., openings or pores). Furthermore, the porous member 66 is a mesh filter, which is a porous member wherein numerous small holes are formed as a mesh.

By controlling the first liquid recovery apparatus 59, the control apparatus 7 can control the pressure differential between the lower surface side and the upper surface side of the porous member 66 such that only the liquid LQ passes through the porous member 66 from the upper surface side (i.e., the second space 37 side) to the lower surface side (i.e., the recovery passageways 58 side). In the present embodiment, the pressure in the second space 37, which is on the upper surface side, is controlled by the chamber apparatus 5 and is substantially at atmospheric pressure. The control apparatus 7 adjusts the pressure on the lower surface side in accordance with the pressure on the upper surface side by controlling the first liquid recovery apparatus 59 such that only the liquid LQ passes through the porous member 66 from the upper surface side to the lower surface side. Namely, the control apparatus 7 performs an adjustment such that only the liquid LQ in the second space 37 is recovered via the holes of the porous member 66 and the gas does not pass therethrough. The technology for causing only the liquid LQ to pass through the porous member 66 from the one side to the other side by adjusting the pressure differential between the one side and the other side of the porous member 66 is disclosed in, for example, U.S. Pat. No. 7,292,313.

Furthermore, in the examples explained referencing FIG. 6 through FIG. 11 as well, the porous member 66 can be disposed in the first recovery port 43. Particularly, as in the example explained referencing FIG. 8, if the first recovery port 43 is large in the directions perpendicular to the optical axis AX (i.e., if the distance W2 between the first edge E1 and the second edge E2 is long), then the gas will tend to intermix with the liquid LQ supplied via the first recovery port 43, and therefore, it is preferable to dispose the porous member 66 in the first recovery port 43 and thereby prevent the effects of vaporization of the liquid LQ.

### Second Embodiment

The following text explains a second embodiment. In the explanation below, constituent parts that are identical or equivalent to those in the embodiment discussed above are assigned identical symbols, and the explanations thereof are therefore abbreviated or omitted. The second embodiment is a modified example of the first embodiment discussed above. The characteristic feature of the second embodiment that differs from the first embodiment discussed above is that the first recovery port 43 is disposed in a recovery member 62 that is separate from the liquid immersion member 4.

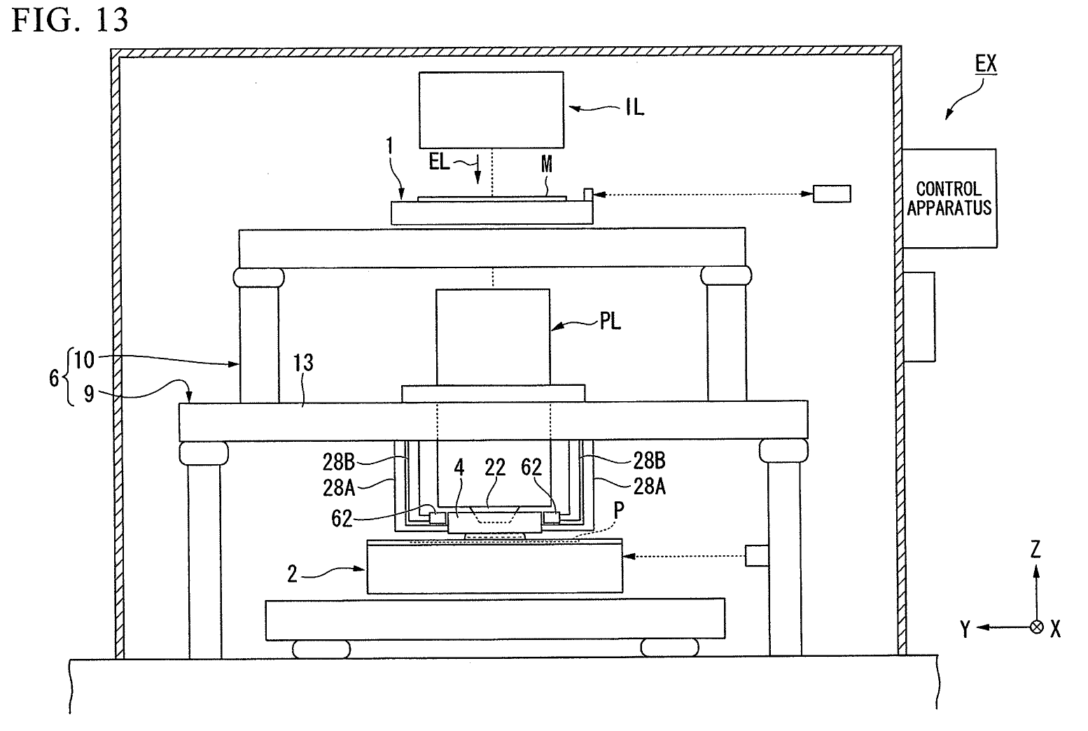

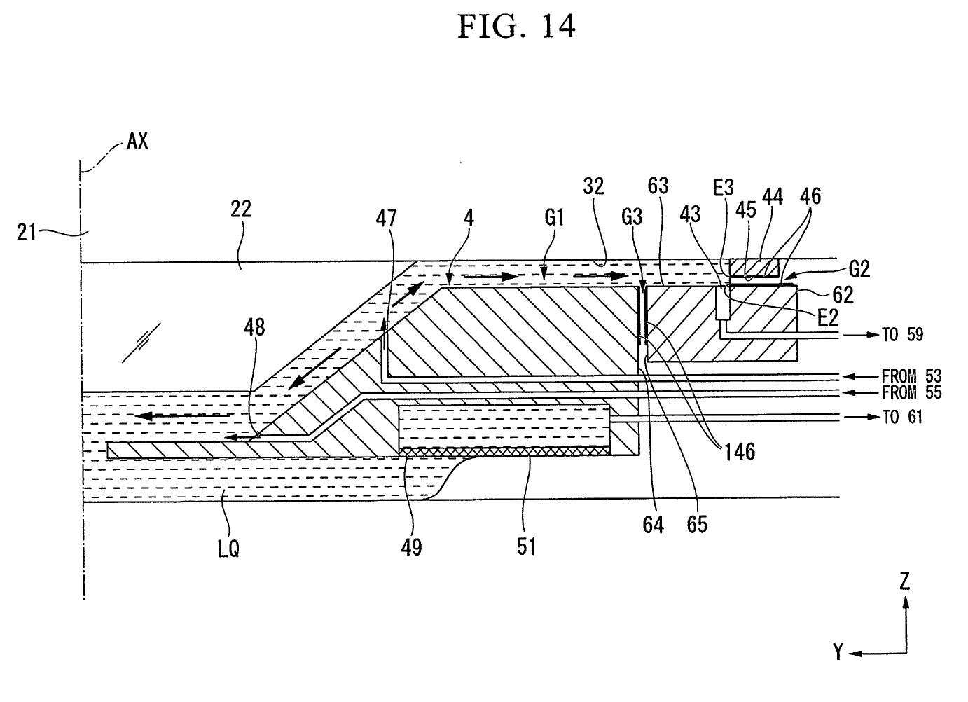

FIG. 13 shows the exposure apparatus EX according to the second embodiment, and FIG. 14 is a partial enlarged view of the exposure apparatus EX according to the second embodiment. In FIG. 13 and FIG. 14, the exposure apparatus EX comprises the recovery member 62, which is disposed such that it opposes the liquid immersion member 4 across the third gap G3 and is provided with the first recovery port 43. The liquid immersion member 4 is supported by first support mechanisms 28A. The recovery member 62 is supported by second support mechanisms 28B. In the present embodiment, the first and second support mechanisms 28A, 28B are supported by the first base plate 13. Namely, the liquid immersion member 4 and the recovery member 62 are supported spaced apart by the third gap G3 such that the transmission of vibrations from one to the other is prevented. In addition, the liquid immersion member 4 and the recovery member 62 are disposed spaced apart by the third gap G3 such that the transfer of heat from one to the other is prevented. For example, even if the temperature of either the liquid immersion member 4 or the recovery member 62 is changed by the vaporization of the liquid LQ (i.e., even if the temperature falls), it is possible to prevent the propagation of that temperature change to the other member. In the present embodiment, the liquid immersion member 4 is suspended from the first base plate 13 via the first support mechanisms 28A. The recovery member 62 is suspended from the first base plate 13 via the second support mechanisms 28B. The second support mechanisms 28B support the recovery member 62 such that the recovery member 62 is disposed at least partly around the liquid immersion member 4.

As shown in FIG. 14, the recovery member 62 has an upper surface 63, which opposes the outer surface 32 of the holding member 21. The first recovery port 43 is disposed in the upper surface 63. The first recovery port 43 faces a direction (i.e., the +Z direction) that is the reverse of the direction that the emergent surface 23 of the last optical element 22 faces.

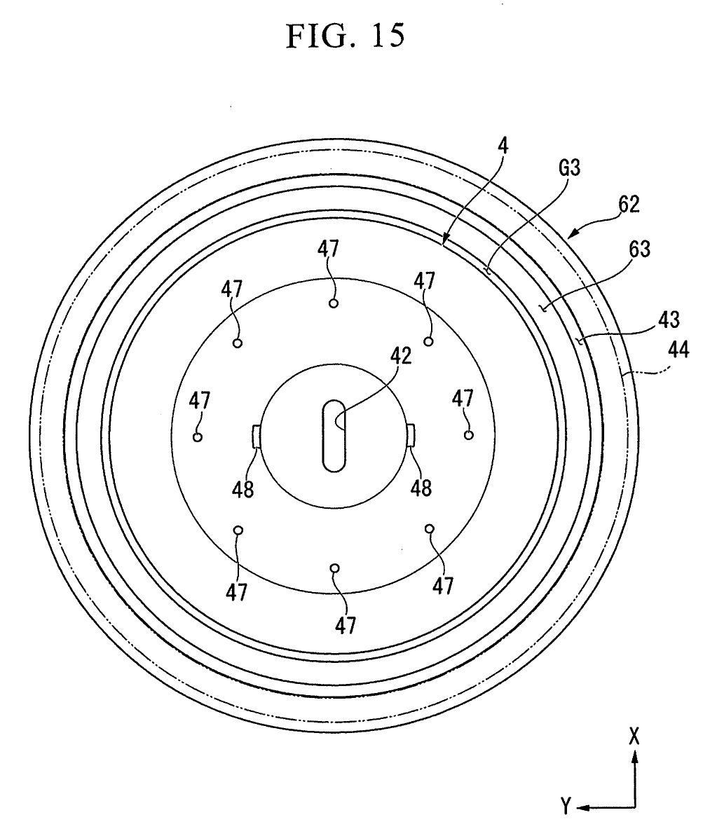

FIG. 15 is a diagram of the liquid immersion member 4 and the recovery member 62 viewed from above. As shown in FIG. 15, in the present embodiment, the recovery member 62 is an annular member that is disposed such that it surrounds the liquid immersion member 4. The first recovery port 43 is disposed in the upper surface 63 such that it surrounds the optical axis AX. Furthermore, the liquid immersion member 4 and the recovery member 62 do not have to be circular ring-shaped and may be, for example, rectangular ring-shaped.

As shown in FIG. 14, similar to FIG. 5 and the like of the first embodiment, the protrusion 44 of the present embodiment is disposed in the outer surface 32 of the holding member 21, which opposes the recovery member 62, such that it surrounds the optical axis AX. The protrusion 44 is disposed such that it protrudes in the −Z direction from the outer surface 32 toward the recovery member 62. The second gap G2 is disposed between the lower surface 45 of the protrusion 44 and the upper surface 63 of the recovery member 62. The lower surface 45 and the upper surface 63, which form the second gap G2, are liquid repellent with respect to the liquid LQ. Furthermore, only the lower surface 45 or only the upper surface 63 may be liquid repellent with respect to the liquid LQ.

In addition, in the present embodiment, at least one member of the group consisting of an outer surface 64 of the liquid immersion member 4 and an inner surface 65 of the recovery member 62, which form the third gap G3 between the liquid immersion member 4 and the recovery member 62, is liquid repellent with respect to the liquid LQ. In the present embodiment, both the outer surface 64 and the inner surface 65 are liquid repellent with respect to the liquid LQ. In the present embodiment, the outer surface 64 and the inner surface 65 are each formed from a film 146 that is liquid repellent with respect to the liquid LQ. Because the outer surface 64 and the inner surface 65, which form the third gap G3, are liquid repellent with respect to the liquid LQ, it is possible to effectively prevent the liquid LQ from penetrating the third gap G3. Furthermore, it is preferable that the third gap G3 is as small as possible so that the liquid LQ does not enter the third gap G3. For example, the third gap G3 (i.e., the distance between the outer surface 64 and the inner surface 65) is less than 0.1 mm.

Furthermore, only the outer surface 64 or only the inner surface 65, both of which form the third gap G3, may be liquid repellent with respect to the liquid LQ. In addition, instead of the films 146, at least part of the recovery member 62 that forms the inner surface 65 and/or at least part of the liquid immersion member 4 that forms the outer surface 64 may be formed from a liquid repellent material, such as tetrafluoroethylene-perfluoro (alkyl vinyl ether) copolymer (PFA), polytetrafluoroethylene (PTFE), or polyetheretherketone (PEEK).

In the present embodiment, the liquid LQ that flows in the first gap G1 in directions away from the optical axis AX is recovered by the first recovery port 43 via the space (i.e., the gap) between the outer surface 32 of the holding member 21 and the recovery member 62. Namely, in the present embodiment, the first recovery port 43 recovers the liquid LQ that flows over the third gap G3 and then from the first gap G1 into the space (i.e., the gap) between the outer surface 32 of the holding member 21 and the recovery member 62.

In the present embodiment as well, the first recovery port 43 and the second gap G2 (i.e., the protrusion 44) are capable of substantially filling the first gap G1 with the liquid LQ while preventing the liquid LQ from flowing out of the first gap G1.

Furthermore, in the present embodiment, the first recovery port 43 is provided in the recovery member 62, which is different from the liquid immersion member 4, and the protrusion 44 is provided to the outer surface 32 of the holding member 21, which opposes the recovery member 62; however, similar to the examples explained referencing FIG. 5 through FIG. 11, the protrusion 44 may be provided to the recovery member 62, which opposes the outer surface 32 of the holding member 21; alternatively, the first recovery port 43 may be provided to the outer surface 32 of the holding member 21 and the protrusion 44 may be provided to the outer surface 32 of the holding member 21, the upper surface 63 of the recovery member 62, or both.

In addition, in the present embodiment, the second edge E2 and the third edge E3 are disposed at substantially the same position in radial directions with respect to the optical axis AX; however, similar to the examples explained referencing FIG. 5 through FIG. 11, the protrusion 44 and part of the first recovery port 43 do not have to be opposed; alternatively, the protrusion 44 and at least part of the first recovery port 43 may be opposed. Namely, the positions of the first edge E1 and the second edge E2 of the first recovery port 43 as well as the positions of the third edge and the fourth edge of the protrusion 44 in radial directions with respect to the optical axis AX (i.e., in directions perpendicular to the optical axis AX) can be appropriately determined.

Furthermore, similar to the example explained referencing FIG. 12 discussed above, the porous member 66 may be disposed in the first recovery port 43 that is provided to the recovery member 62. In such a case, the control apparatus 7 can control the pressure differential between the upper surface side and the lower surface side of the porous member 66 such that only the liquid LQ passes through the porous member 66 from the upper surface side to the lower surface side.

Furthermore, in the present embodiment, the liquid immersion member 4 is supported by the first support mechanisms 28A and the recovery member 62 is supported by the second support mechanisms 28B, but the liquid immersion member 4 and the recovery member 62 may be supported by a single support mechanism in the state wherein the third gap G3 is formed between the liquid immersion member 4 and the recovery member 62.

Furthermore, in each of the embodiments discussed above, the second recovery port 49 recovers only the liquid LQ, but may recover the liquid LQ together with the gas surrounding the second recovery port 49.

In addition, in each of the embodiments discussed above, the liquid LQ is supplied via both the first supply ports 47 and the second supply ports 48, but either the first supply ports 47 or the second supply ports 48 may be omitted, and the liquid LQ may be supplied via a single supply port to both the optical path of the exposure light EL and the first gap G1.

In addition, in each of the embodiments discussed above, the two surfaces that form the second gap G2 do not have to be parallel to the plane that is perpendicular to the optical axis AX; alternatively, those two surfaces do not have to be parallel. In addition, one or both of the surfaces that form the second gap G2 may include a curved surface.

In addition, in each of the embodiments discussed above, the second space 37 extends in radial directions with respect to the optical axis AX (i.e., in directions perpendicular to the optical axis AX), but may be inclined with respect to directions perpendicular to the optical axis AX (i.e., with respect to the XY plane). For example, the second space 37 may be inclined such that it extends in radial directions with respect to the optical axis AX and in the +Z direction.

Furthermore, each of the embodiments discussed above explained an exemplary case wherein the inclination angle of the first space 36 with respect to directions perpendicular to the optical axis AX (i.e., the XY plane) is greater than the inclination angle of the second space 37 with respect to directions perpendicular to the optical axis AX, but the inclination angle of the first space 36 with respect to directions perpendicular to the optical axis AX may be the same as or smaller than the inclination angle of the second space 37 with respect to directions perpendicular to the optical axis AX.

Furthermore, in the embodiments discussed above, the size of the first gap G1 may be the same as that of the first space 36 and the second space 37, or it may be different.

Furthermore, the embodiments discussed above explained an exemplary case wherein the second gap G2 is formed by providing the protrusion 44 to either the holding member 21, the opposing member (i.e., the liquid immersion member 4 or the recovery member 62), or both, but the second gap G2 may be formed by providing the protrusion 44 to the last optical element 22, the opposing member (i.e., the liquid immersion member 4 or the recovery member 62), or both. For example, if the second portion 35 (i.e., the inner surface 33) of the liquid immersion member 4 and the outer surface of the last optical element 22 are opposed, then the protrusion 44 can be provided to the outer surface of the last optical element 22 such that the protrusion 44 protrudes toward the second portion 35 of the liquid immersion member 4.

In addition, in each of the embodiments discussed above, at least part of the outer surface 31 of the last optical element 22 that defines the first gap G1, at least part of the outer surface 32 of the holding member 21, at least part of the inner surface of the liquid immersion member 4, or any combination thereof, preferably is lyophilic to the liquid LQ (i.e., the contact angle of the liquid LQ with respect to such a part is 40°, 30°, 20°, or less).

In addition, in each of the embodiments discussed above, the first recovery port 43 that recovers the liquid LQ from the first gap G1 is disposed annularly around the optical axis AX (i.e., around the first gap G1), but may be disposed partially around the optical axis AX (e.g., dispersed at equal intervals). In this case, too, the second gap G2 (i.e., the protrusion 44) is preferably disposed annularly around the optical axis AX (i.e., around the first gap G0, but the second gap G2 (i.e., the protrusion 44) may be provided partially around the optical axis AX in accordance with how the first recovery port 43 is disposed.

In addition, in each of the embodiments discussed above, the first recovery port 43 faces the direction (i.e., the −Z direction) that the emergent surface 23 of the last optical element 22 faces, or faces the direction (i.e., the +Z direction) that is the reverse thereof, but it does not have to face either the +Z direction or the −Z direction. For example, at least part of the first recovery port 43 may be provided in the inner surface of the protrusion 44, which faces the optical axis AX. Namely, at least part of the first recovery port 43 may be provided to the inner surface of the protrusion 44, which faces the second space 37 of the first gap G1.

In addition, each of the embodiments discussed above is configured such that the liquid LQ flows actively to the first gap G1 in directions away from the optical axis AX and the first gap G1 is substantially filled with the liquid LQ; however, if the liquid LQ overflows, it may be recovered via the first recovery port 43 only if the liquid LQ overflows from the first gap G1 (i.e., the first space 36 or the second space 37).

In addition, in each of the embodiments discussed above, the second gap G2 is formed on the outer side of the first recovery port 43 with respect to the optical axis AX, but the mechanism that is disposed on the outer side of the first recovery port 43 with respect to the optical axis AX and allows the gas from the first gap G1 to pass through while preventing the liquid LQ from the first gap G1 to pass through is not limited to a gap and may be a through hole; alternatively, a liquid recovery port may be further provided such that the gas from the first gap G1 is allowed to pass through and the liquid LQ from the first gap G1 is prevented from passing through.

### Third Embodiment

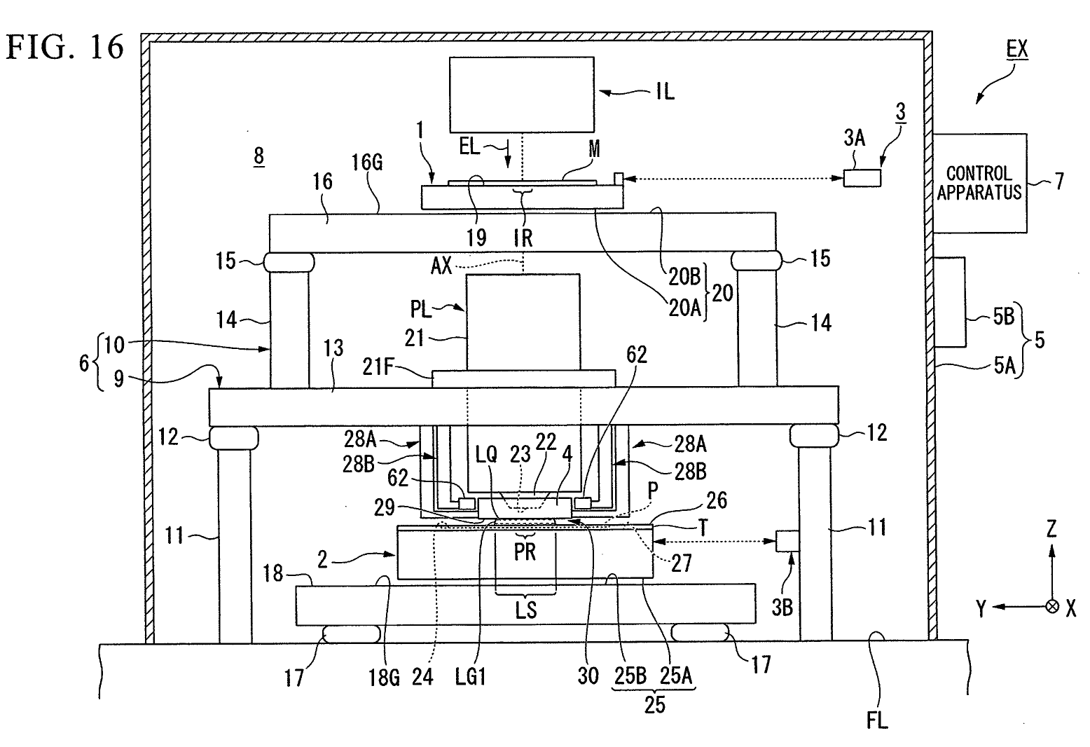

The following text explains a third embodiment. FIG. 16 is a schematic block diagram that shows one example of an exposure apparatus EX according to the third embodiment. In the explanation below, constituent parts that are identical or equivalent to those in the embodiment discussed above are assigned identical symbols, and the explanations thereof are therefore abbreviated or omitted.

In the present embodiment, as shown in FIG. 1, the exposure apparatus EX comprises: a recovery member 62, which is disposed in the vicinity of the liquid immersion member 4 and is capable of recovering the liquid LQ.

The liquid immersion member 4 is supported by first support mechanisms 28A. The recovery member 62 is supported by second support mechanisms 28B. In the present embodiment, the first and second support mechanisms 28A, 28B are supported by the first base plate 13. In the present embodiment, the liquid immersion member 4 is suspended from the first base plate 13 via the first support mechanisms 28A. The recovery member 62 is suspended from the first base plate 13 via the second support mechanisms 28B.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. When the substrate P is to be exposed, the control apparatus 7 controls the mask stage 1 and the substrate stage 2 so as to move the mask M and the substrate P in the prescribed scanning directions within the XY plane, which intersects the optical axis AX (i.e., the optical path of the exposure light EL). In the present embodiment, the scanning directions (i.e., the synchronous movement directions) of both the substrate P and the mask M are the Y axial directions. The control apparatus 7 radiates the exposure light EL to the substrate P through the projection system PL and the liquid LQ in the immersion space LS on the substrate P while moving the substrate P in one of the Y axial directions with respect to the projection area PR of the projection system PL and moving the mask M, synchronized to the movement of the substrate P, in the other Y axial direction with respect to the illumination area IR of the illumination system IL. Thereby, the image of the pattern of the mask M is projected to the substrate P, which is thereby exposed by the exposure light EL.

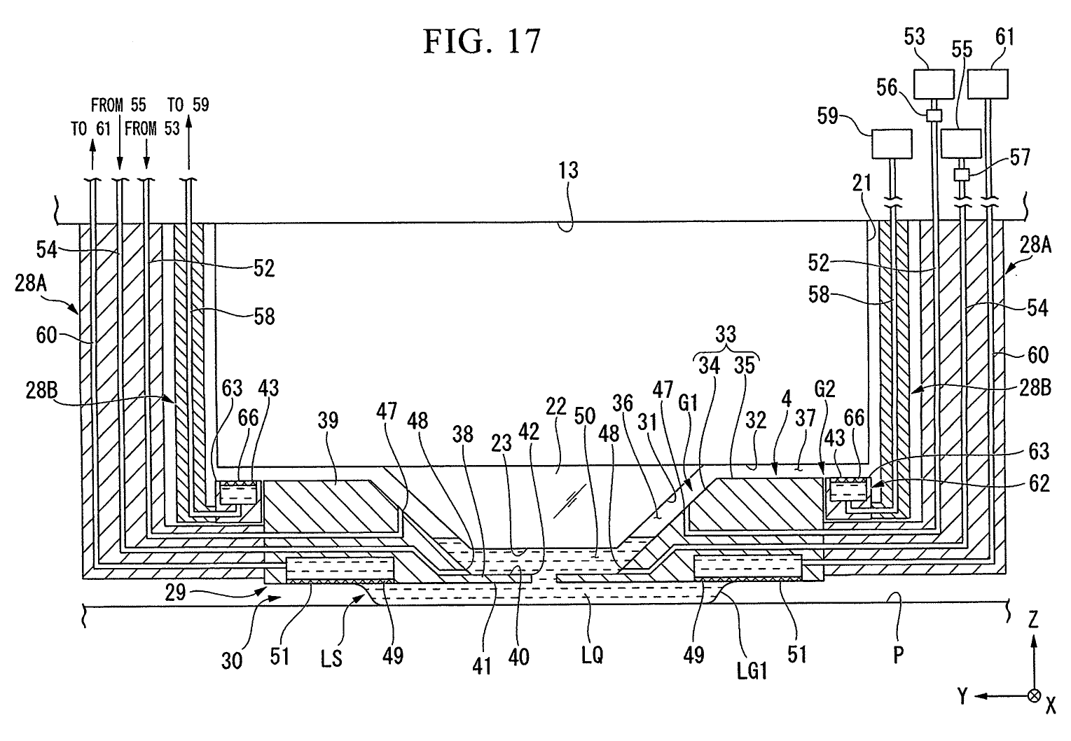

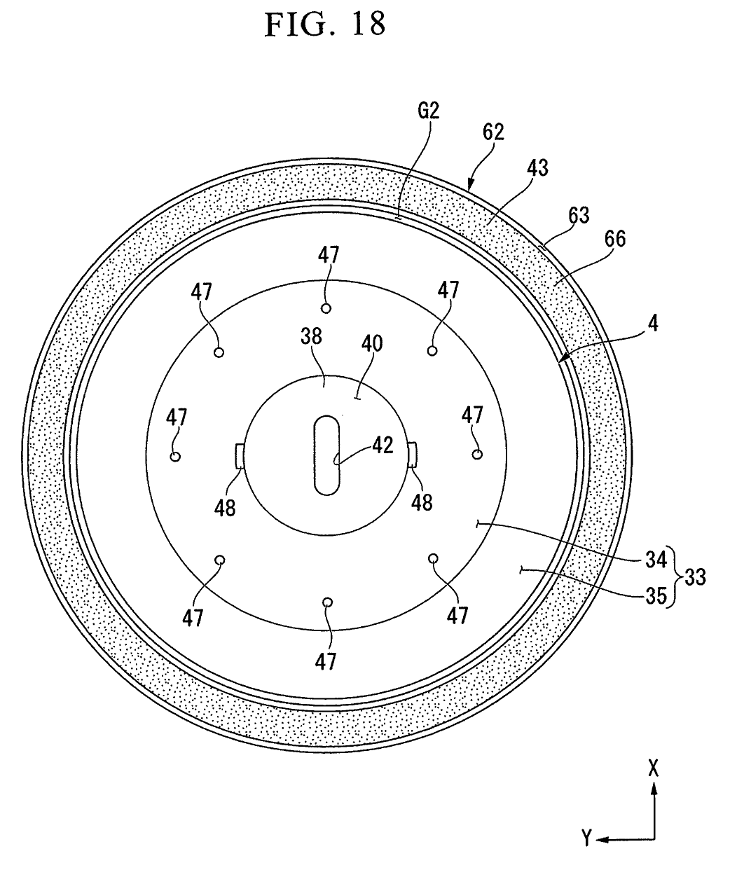

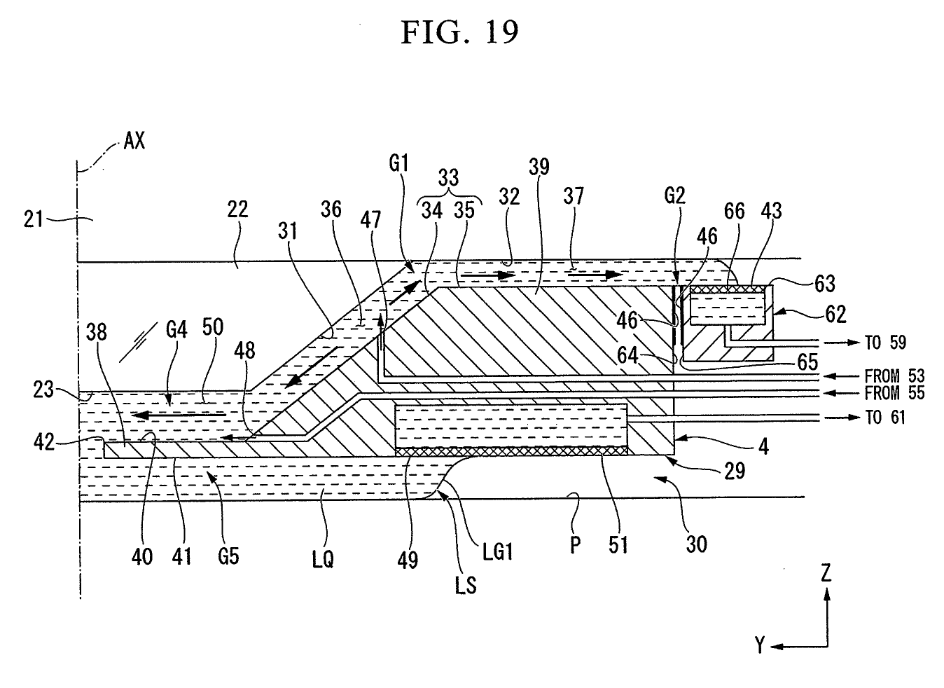

FIG. 17 is a side cross sectional view that shows the vicinity of the liquid immersion member 4, FIG. 18 shows the liquid immersion member 4 and the recovery member 62 viewed from above, and FIG. 19 is a partial enlarged view of FIG. 17. As shown in FIG. 17, FIG. 18, and FIG. 19, the liquid immersion member 4 is disposed in the vicinity of the last optical element 22. The liquid immersion member 4 is disposed at least partly around the optical path of the exposure light EL such that the optical path of the exposure light EL that emerges from the emergent surface 23 is filled with the liquid LQ. In the present embodiment, the liquid immersion member 4 is an annular member. The liquid immersion member 4 is disposed around part of the optical path of the exposure light EL and around the last optical element 22. In addition, in the present embodiment, the recovery member 62 is an annular member that is disposed around the liquid immersion member 4. Furthermore, the liquid immersion member 4 and the recovery member 62 do not have to be circular ring-shaped and may be, for example, rectangular ring-shaped.

The liquid immersion member 4 forms the immersion space LS such that the optical path of the exposure light EL between the emergent surface 23 and an object, which is disposed at a position at which it opposes the emergent surface 23, is filled with the liquid LQ. The immersion space LS is a portion (i.e., a space or area) that is filled with the liquid LQ. In the present embodiment, the object includes the substrate stage 2 (i.e., the plate member T), the substrate P, which is held by the substrate stage 2, or both. During an exposure of the substrate P, the liquid immersion member 4 forms the immersion space LS such that the optical path of the exposure light EL between the last optical element 22 and the substrate P is filled with the liquid LQ.

The liquid immersion member 4 has a lower surface 29, which is capable of opposing the object. A space 30 between the lower surface 29 and the object is capable of holding the liquid LQ. Part of the immersion space LS is formed by the liquid LQ held between the lower surface 29 and the object. In the present embodiment, when the substrate P is irradiated with the exposure light EL, the immersion space LS is already formed such that part of the area of the front surface of the substrate P that includes the projection area PR is covered with the liquid LQ. An interface LG1 (i.e., a meniscus or an edge) of the liquid LQ of the immersion space LS is formed between the lower surface 29 of the liquid immersion member 4 and the front surface (i.e., the upper surface) of the object. The exposure apparatus EX of the present embodiment adopts a local liquid immersion system.

For the sake of simplicity, the text below explains an exemplary case wherein the immersion space LS is formed by disposing the substrate P at a position at which it opposes the emergent surface 23 and the lower surface 29 and holding the liquid LQ between the emergent surface 23 and the lower surface 29 on one side and the front surface of the substrate P on the other side. Furthermore, as discussed above, the immersion space LS can be formed between the emergent surface 23 and the lower surface 29 on one side and the upper surface 26 of the substrate stage 2 (i.e., the plate member T) on the other side.

In the present embodiment, the liquid immersion member 4 has an inner surface 33 that opposes, across a first gap G1: an outer surface 31 of the last optical element 22, an outer surface 32 of the holding member 21 that holds the last optical element 22, or both. In the present embodiment, the inner surface 33 comprises: a first portion 34, which extends in radial directions (i.e., in directions perpendicular to the optical axis AX) with respect to the optical axis AX of the last optical element 22 (i.e., the projection system PL) and in a direction that is the reverse of the direction that the emergent surface 23 faces; and a second portion 35, which is disposed on the outer side of at least part of the first portion 34 with respect to the optical axis AX. In the present embodiment, the second portion 35 is disposed around the first portion 34. The first gap G1 includes a first space 36, which is defined by the first portion 34, and a second space 37, which is defined by the second portion 35.

The outer surface 31 of the last optical element 22 is a surface that is different from and disposed around the emergent surface 23. Namely, the outer surface 31 is a surface wherethrough the exposure light EL does not pass. The outer surface 31 is inclined such that it extends in radial directions (i.e., directions perpendicular to the optical axis AX) with respect to the optical axis AX and in the +Z direction. In the present embodiment, the outer surface 31 and the first portion 34 are opposed. In addition, in the present embodiment, the outer surface 31 and the first portion 34 are substantially parallel. The first space 36 includes a space between the outer surface 31 and the first portion 34. The first space 36 is a space that is inclined such that it extends in radial directions with respect to the optical axis AX and in a direction (i.e., the +Z direction) that leads away from the image plane of the projection system PL. Namely, the first space 36 is a space that is inclined in the +Z direction with respect to the direction that is perpendicular to the optical axis AX (i.e., with respect to the XY plane). Furthermore, the outer surface 31 and the first portion 34 do not have to be parallel. In addition, the outer surface 31, the first portion 34, or both may include a curved surface.

In the present embodiment, the outer surface 32 of the holding member 21 is disposed around the outer surface 31 of the last optical element 22. In the present embodiment, the outer surface 32 and the second portion 35 are opposed. In addition, in the present embodiment, the outer surface 32 and the second portion 35 are substantially parallel. The second space 37 includes a space between the outer surface 32 and the second portion 35. In the present embodiment, the outer surface 32 and the second portion 35 are substantially parallel to the XY plane, and the second space 37 is a space that extends in radial directions with respect to the optical axis AX (i.e., in directions perpendicular to the optical axis AX). Furthermore, the outer surface 32 and the second portion 35 do not have to be substantially parallel to the XY plane. In addition, the outer surface 32 and the second portion 35 do not have to be parallel to one another. In addition, the outer surface 32, the second portion 35, or both may include a curved surface.

In the present embodiment, the liquid immersion member 4 comprises a plate part 38, at least part of which is disposed such that it opposes the emergent surface 23, and a main body part 39, at least part of which is disposed around the last optical element 22. The first portion 34 and the second portion 35 are disposed in the main body part 39. The plate part 38 has an upper surface 40, which opposes the emergent surface 23 across a gap G4 and a lower surface 41, which opposes—across a gap G5—the front surface of the object (e.g., the substrate P) that is disposed such that it opposes the emergent surface 23. In addition, the plate part 38 has an opening 42 wherethrough the exposure light EL that emerges from the emergent surface 23 can pass. During an exposure of the substrate P, the exposure light EL that emerges from the emergent surface 23 is radiated to the front surface of the substrate P through the opening 42.

In addition, in the present embodiment, the exposure apparatus EX is provided with first supply ports 47, which supply the liquid LQ to the first gap G1. In the present embodiment, the first supply ports 47 are disposed in the inner surface 33 of the liquid immersion member 4. In the present embodiment, the first supply ports 47 are disposed in the first portion 34 of the liquid immersion member 4 that opposes the outer surface 31 of the last optical element 22. In the present embodiment, the first supply ports 47 are disposed such that they are equispaced around the optical axis AX. As shown in FIG. 18, in the present embodiment, the first supply ports 47 are disposed at 45° intervals around the optical axis AX. Furthermore, the positions and the number of the first supply ports 47 are not limited to the case shown in FIG. 18 and can be set arbitrarily.

As shown in FIG. 17 and FIG. 19, in the present embodiment, the first supply ports 47 face the direction (i.e., the +Z direction) that is the reverse of the direction that the emergent surface 23 faces. Furthermore, the first supply ports 47 do not have to face the +Z direction.

In addition, in the present embodiment, the exposure apparatus EX has a first recovery port 43, which is disposed at least partly around the optical axis AX and is capable of recovering the liquid LQ from at least part of the first gap G1. The first recovery port 43 is disposed such that it is spaced apart from the first supply ports 47 with respect to the optical axis AX. In the present embodiment, the first recovery port 43 is disposed in the recovery member 62.

A second gap G2 is formed between the recovery member 62 and the liquid immersion member 4. The recovery member 62 is supported by the second support mechanisms 28B and is disposed at least partly around the liquid immersion member 4 supported by the first support mechanisms 28A. Namely, the liquid immersion member 4 and the recovery member 62 are supported spaced apart by the second gap G2 such that the transmission of vibrations from one to the other is prevented. In addition, the liquid immersion member 4 and the recovery member 62 are disposed spaced apart by the second gap G2 such that the transfer of heat from one to the other is prevented. For example, even if the temperature of either the liquid immersion member 4 or the recovery member 62 is changed by the vaporization of the liquid LQ (i.e., even if the temperature falls), it is possible to prevent the propagation of that temperature change to the other member. Furthermore, it is preferable that the second gap G2 is as small as possible so that the liquid LQ does not enter the second gap G2. For example, the second gap G2 (i.e., the distance between an outer surface 64 and an inner surface 65) is less than 0.1 mm.

The recovery member 62 has an upper surface 63, which opposes the outer surface 32 of the holding member 21. The first recovery port 43 is disposed in the upper surface 63. The first recovery port 43 faces a direction that is the reverse of the direction that the emergent surface 23 faces. In the present embodiment, the first recovery port 43 faces upward (i.e., in the +Z direction). In addition, in the present embodiment, the first recovery port 43 is disposed such that it surrounds the optical axis AX. The first recovery port 43 is capable of recovering the liquid LQ from at least part of the first gap G1 and that is not supplied to a space 50 below the emergent surface 23.

In the present embodiment, the recovery member 62 is an annular member that is disposed such that it surrounds the liquid immersion member 4. The first recovery port 43 is disposed in the upper surface 63 such that it surrounds the optical axis AX. In the present embodiment, the first recovery port 43 (i.e., the upper surface 63) of the recovery member 62 is disposed at substantially the same height as the second portion 35.

In addition, in the present embodiment, at least one member of the group consisting of the outer surface 64 of the liquid immersion member 4 and the inner surface 65 of the recovery member 62, which form the second gap G2, is liquid repellent with respect to the liquid LQ. In the present embodiment, the contact angle of the liquid LQ with respect to the outer surface 64 of the liquid immersion member 4, the inner surface 65 of the recovery member 62, both of which form the second gap G2, or both is 90° or greater. In the present embodiment, both the outer surface 64 and the inner surface 65 are liquid repellent with respect to the liquid LQ. In the present embodiment, the outer surface 64 and the inner surface 65 are each formed from a film 46 that is liquid repellent with respect to the liquid LQ. The films 46 are formed from a liquid repellent material that contains, for example, fluorine. Examples of liquid repellent materials include tetrafluoroethylene-perfluoroalkyl vinyl ether copolymer (PFA), polytetrafluoroethylene (PTFE), polyetheretherketone (PEEK), and Teflon®.

Furthermore, only the outer surface 64 or only the inner surface 65, both of which form the second gap G2, may be liquid repellent with respect to the liquid LQ.

In addition, instead of the films 46, at least part of the liquid immersion member 4 that forms the outer surface 64 and/or at least part of the recovery member 62 that forms the inner surface 65 may be formed from a liquid repellent material, such as tetrafluoroethylene-perfluoro (alkyl vinyl ether) copolymer (PFA), polytetrafluoroethylene (PTFE), or polyetheretherketone (PEEK).

A porous member 66 is disposed in the first recovery port 43. The porous member 66 is plate shaped and has a plurality of holes (i.e., openings or pores). Furthermore, the porous member 66 may be a mesh filter, which is a porous member wherein numerous small holes are formed as a mesh. The upper surface 63 of the recovery member 62 includes the upper surface of the porous member 66.

In addition, the liquid immersion member 4 comprises second supply ports 48, which supply the liquid LQ, and a second recovery port 49, which is capable of recovering the liquid LQ. The second supply ports 48 are provided in the inner surface 33 of the liquid immersion member 4. The second supply ports 48 are disposed nearer to the emergent surface 23 (i.e., nearer to the front surface of the substrate P) than the first supply ports 47 are. In the present embodiment, the second supply ports 48 are disposed such that they face the space 50 between the emergent surface 23 and the upper surface 40 of the plate part 38. The second supply ports 48 supply the liquid LQ to the optical path of the exposure light EL. As shown in FIG. 18, in the present embodiment, the second supply ports 48 are disposed such that there is one on the +Y side and one on the −Y side with respect to the optical axis AX. Furthermore, the second supply ports 48 may be disposed such that there is one on the +X side and one on the −X side with respect to the optical axis AX. In addition, the number of the second supply ports 48 may be three or greater.

Furthermore, the second supply ports 48 are disposed at positions at which they oppose the outer surface 31 of the last optical element 22.

Furthermore, the number of the first supply ports 47 and the number of the second supply ports 48 may be the same. In addition, the positions of the first supply ports 47 and the positions of the second supply ports may be the same in the circumferential directions with respect to the optical axis AX or they may be different.

The second recovery port 49 is disposed in the lower surface 29 of the liquid immersion member 4. The second recovery port 49 is capable of recovering the liquid LQ on the front surface of the object (e.g., the substrate P) that is disposed such that it opposes the lower surface 29 of the liquid immersion member 4. Namely, the liquid LQ on the front surface of the object (i.e., the substrate P and the like) that is disposed such that it opposes the second recovery port 49 can be recovered by the second recovery port 49.

The second recovery port 49 is disposed at least partly around the lower surface 41 of the plate part 38. In the present embodiment, the second recovery port 49 is disposed annularly around the lower surface 41. In addition, in the present embodiment, a porous member 51 is disposed in the second recovery port 49. In the present embodiment, the porous member 51 is plate shaped and has a plurality of holes (i.e., openings or pores). Furthermore, the porous member 51 may be a mesh filter, which is a porous member wherein numerous small holes are formed as a mesh.

In the present embodiment, the lower surface 29 of the liquid immersion member 4 includes the lower surface 41 of the plate part 38 and the lower surface of the porous member 51.

As shown in FIG. 17, the first supply ports 47 are connected to a first liquid supply apparatus 53 via supply passageways 52. In the present embodiment, the supply passageways 52 comprise passageways that are formed inside the liquid immersion member 4 and passageways that are formed inside the first support mechanisms 28A. In addition, the second supply ports 48 are connected to a second liquid supply apparatus 55 via supply passageways 54. In the present embodiment, the supply passageways 54 comprise passageways that are formed inside the liquid immersion member 4 and passageways that are formed inside the first support mechanisms 28A. The first and second liquid supply apparatuses 53, 55 can supply the clean, temperature-adjusted liquid LQ to the first and second supply ports 47, 48. Furthermore, parts of the supply passageways 52 and/or parts of the supply passageways 54 do not have to be provided inside the first support mechanisms 28A that support the liquid immersion member 4.

The control apparatus 7 is capable of adjusting the amount of the liquid that is supplied per unit of time via each of the first supply ports 47 and the second supply ports 48. In the present embodiment, adjusting apparatuses 56, 57, which are called mass flow controllers and are capable of adjusting the amount of liquid supplied per unit of time, are disposed in the supply passageways 52 and the supply passageways 54, respectively. The control apparatus 7 controls the operation of the adjustment apparatuses 56, 57. The control apparatus 7 is capable of separately adjusting the amount of the liquid supplied per unit of time via the first supply ports 47 and the second supply ports 48 by separately controlling the adjusting apparatuses 56, 57. In addition, the control apparatus 7 is capable of adjusting the flow speeds of the liquid LQ supplied via the first and second supply ports 47, 48 by adjusting the amounts of the liquid LQ supplied via the first and second supply ports 47, 48. Furthermore, the total amount of the liquid LQ supplied via all of the first supply ports 47 may be the same as or different from the total amount of the liquid LQ supplied via all of the second supply ports 48. In addition, the amount of the liquid LQ supplied via one of the first supply ports 47 may be the same as or different from the amount of the liquid LQ supplied via one of the second supply ports 48.

Furthermore, the plurality of passageways that branch from one supply passageway may be connected to the first supply ports 47 and the second supply ports 48.

The first recovery port 43 is connected to a first liquid recovery apparatus 59 via recovery passageways 58. In the present embodiment, the recovery passageways 58 comprise passageways that are formed inside the liquid immersion member 4 and passageways that are formed inside the second support mechanisms 28B. Furthermore, part of the recovery passageways 58 do not have to be provided inside the second support mechanisms 28B that support the recovery member 62. The second recovery port 49 is connected to a second liquid recovery apparatus 61 via recovery passageways 60. In the present embodiment, the recovery passageways 60 comprise passageways that are formed inside the liquid immersion member 4 and passageways that are formed inside the first support mechanisms 28A. Furthermore, part of the recovery passageways 60 do not have to be provided inside the first support mechanisms 28A that support the liquid immersion member 4. The first and second liquid recovery apparatuses 59, 61 each comprise a vacuum system (such as a valve that controls the connection state between the vacuum source and the recovery port) and can recover the liquid LQ via the first and second recovery ports 43, 49 by suctioning the liquid LQ.

The control apparatus 7 is capable of separately adjusting the amounts of the liquid recovered per unit of time via the first recovery port 43 and the second recovery port 49.

In addition, by controlling the first liquid recovery apparatus 59, the control apparatus 7 can control the pressure differential between the upper surface side and the lower surface side of the porous member 66 such that only the liquid LQ passes through the porous member 66 from the upper surface side (i.e., the first gap G1 side) to the lower surface side (i.e., the recovery passageways 58 side). In the present embodiment, the pressure in the first gap G1, which is on the upper surface side, is controlled by the chamber apparatus 5 and is substantially at atmospheric pressure. The control apparatus 7 adjusts the pressure on the lower surface side in accordance with the pressure on the upper surface side by controlling the first liquid recovery apparatus 59 such that only the liquid LQ passes through the porous member 66 from the upper surface side to the lower surface side. Namely, the control apparatus 7 performs an adjustment such that only the liquid LQ from the first gap G1 is recovered via the holes of the porous member 66 and the gas does not pass therethrough. The technology for adjusting the pressure differential between the one side and the other side of the porous member 66 and thereby causing only the liquid LQ to pass through from the one side to the other side of the porous member 66 is disclosed in, for example, U.S. Pat. No. 7,292,313.

Similarly, by controlling the second liquid recovery apparatus 61, the control apparatus 7 can control the pressure differential between the lower surface side and the upper surface side of the porous member 51 such that only the liquid LQ passes through the porous member 51 from the lower surface side (i.e., the space 30 side) to the upper surface side (i.e., the recovery passageways 60 side).

In the present embodiment, the control apparatus 7 is capable of forming the immersion space LS with the liquid LQ between the last optical element 22 and the liquid immersion member 4 on one side and the object (e.g., the substrate P) that opposes the last optical element 22 and the liquid immersion member 4 on the other side by performing a liquid recovery operation, wherein the second recovery port 49 is used, in parallel with a liquid supply operation, wherein the second supply ports 48 are used.

The following explains a method of using the exposure apparatus EX that has the abovementioned configuration to expose the substrate P.

The control apparatus 7 performs the operation of recovering the liquid LQ via the second recovery port 49 in parallel with the operation of supplying the liquid LQ via the second supply ports 48, uses the liquid immersion member 4 to form the immersion space LS between the last optical element 22 and the liquid immersion member 4 on one side and the substrate P on the other side such that the optical path of the exposure light EL between the emergent surface 23 of the last optical element 22 and the substrate P is filled with the liquid LQ, and then starts the exposure of the substrate P that is held by the substrate stage 2. The control apparatus 7 radiates the exposure light EL that emerges from the emergent surface 23 to the substrate P through the liquid LQ of the immersion space LS.

In the present embodiment, as shown in FIG. 19, the control apparatus 7 performs the operation of supplying the liquid LQ via the first supply ports 47 at least during the exposure of the substrate P. The first supply ports 47 supply the liquid LQ to the first gap G1. In the present embodiment, the first supply ports 47 face the first space 36, and at least some of the liquid LQ supplied via the first supply ports 47 to the first gap G1 (i.e., the first space 36) contacts the outer surface 31 of the last optical element 22 and flows upward (i.e., in the +Z direction) along the outer surface 31 and the first portion 34 and in directions away from the optical axis AX. Namely, the majority of the liquid LQ that is supplied via the first supply ports 47 flows along the first space 36 in a direction that is the reverse of the direction that the emergent surface 23 faces and in radial directions with respect to the optical axis AX.

In the first space 36, the liquid LQ that flows upward and in directions away from the optical axis AX flows into the second space 37. The direction of the liquid LQ that flows from the first space 36 into the second space 37 is changed by the outer surface 32 of the holding member 21, and the liquid LQ then flows along the second space 37 horizontally and in directions away from the optical axis AX. Namely, in the second space 37, the liquid LQ flows parallel to the XY plane and in radial directions with respect to the optical axis AX (i.e., in directions perpendicular to the optical axis AX).

In the present embodiment, by controlling the adjusting apparatus 56, the control apparatus 7 adjusts the amount of the liquid LQ supplied per unit of time via the first supply ports 47 such that the liquid LQ supplied via the first supply ports 47 flows evenly at a low speed in the first gap G1 and such that the first gap G1 is substantially filled with the liquid LQ.

Thus, in the present embodiment, the control apparatus 7 generates the flow of the liquid LQ in directions away from the optical axis AX to the first gap G1 by supplying the liquid LQ via the first supply ports 47 to the first gap G1.

The liquid LQ that is supplied via the first supply ports 47 and flows inside the first gap G1 in directions away from the optical axis AX is recovered by the first recovery port 43. The first recovery port 43 recovers the liquid LQ from at least part of the first gap G1. Thereby, the flow of the liquid LQ to the outer side of the first recovery port 43 with respect to the optical axis AX is prevented.

In the present embodiment, the first recovery port 43 recovers the liquid LQ that passed through the second gap G2 and is present in the second space 37. Thereby, the space in the first gap G1 between the first supply ports 47 and the first recovery port 43 can be substantially filled continuously with the liquid LQ. In addition, in the present embodiment, because the outer surface 64 and the inner surface 65, which form the second gap G2, are liquid repellent with respect to the liquid LQ, the liquid LQ is prevented from penetrating the second gap G2.

In addition, in the present embodiment, the liquid LQ in the second space 37 flows evenly at a low speed in directions away from the optical axis AX, and the force of that flow prevents the liquid LQ from flowing to the outer side of the recovery member 62 with respect to the optical axis AX.

In addition, some of the liquid LQ that is supplied via the first supply ports 47 to the first gap G1 contacts the outer surface 31 of the last optical element 22, flows along the outer surface 31 and the first portion 34 downward and in directions that approach the optical axis AX, and is supplied to the optical path of the exposure light EL. Namely, some of the liquid LQ that is supplied via the first supply ports 47 flows in the direction (i.e., the −Z direction) in which the emergent surface 23 faces and in directions that approach the optical axis AX. Thus, on the lower side (i.e., the −Z side) of the first supply ports 47 as well, the first space 36 can be filled with the liquid LQ. Accordingly, the liquid recovery operation wherein the first recovery port 43 is used is performed in parallel with the liquid supply operation wherein the first supply ports 47 are used, which makes it possible to continuously fill the first gap G1 with the clean, temperature-adjusted liquid LQ while preventing the liquid LQ from flowing out of the first gap G1. In addition, in the present embodiment, the liquid recovery operation wherein the second recovery port 49 is used is performed in parallel with the liquid supply operation wherein the first supply ports 47 and the second supply ports 48 are used, which makes it possible to continuously fill the optical path of the exposure light EL that emerges from the emergent surface 23 with the clean, temperature-adjusted liquid LQ while preventing the liquid LQ from flowing out of the optical path.

In the present embodiment, the liquid LQ flows to the first gap G1, which prevents foreign matter, gas (e.g., bubbles), or the like in the first gap G1 from intermixing with the liquid LQ that is present along the optical path of the exposure light EL (e.g., the liquid LQ that is present in the space 50). In particular, because a flow of the liquid LQ is generated in the first gap G1, which is on the upper side of the first supply ports 47, toward directions away from the optical axis AX, even if, for example, foreign matter (or bubbles or the like) is created in the first gap G1, that foreign matter is prevented from flowing toward the optical path (i.e., the optical axis AX) of the exposure light EL. In addition, in the present embodiment, the first gap G1 is filled with the clean, temperature-adjusted liquid LQ that is supplied via the first supply ports 47, which makes it possible to prevent the temperature of the holding member 21, the last optical element 22, the liquid immersion member 4, or any combination thereof from changing. In addition, in the present embodiment, the first gap G1 is filled with the liquid LQ supplied via the first supply ports 47 and the interface (i.e., a meniscus or an edge) of the liquid LQ is not formed between the liquid immersion member 4 and the last optical element 22 or between the liquid immersion member 4 and the holding member 21, and it is thereby possible to prevent the temperature of the holding member 21, the last optical element 22, the liquid immersion member 4, or any combination thereof from changing as a result of the vaporization of the liquid LQ, which tends to occur at the interface. In addition, in the present embodiment, because the liquid LQ in the first gap G1 is made to flow in the directions away from the optical axis AX, the interface of that liquid LQ is comparatively spaced apart from the optical axis AX, and thereby it is possible to prevent the temperature of the last optical element 22, the liquid LQ in the optical path of the exposure light EL, or both from changing as a result of the vaporization of the liquid LQ, which tends to occur at the interface. In addition, in the present embodiment, in the first gap G1, the liquid LQ flows evenly at a low speed and the interface of the liquid LQ that flows in directions away from the optical axis AX is formed stably in the vicinity of the first recovery port 43; therefore, it is possible to prevent pressure fluctuations in the liquid LQ from affecting the holding member 21, the last optical element 22, the liquid immersion member 4, or any combination thereof. Accordingly, it is possible to prevent fluctuations in the position and in the optical characteristics of the last optical element 22.

In addition, in the present embodiment, the provision of the adjusting apparatuses 56, 57 makes it possible to separately adjust the amounts of the liquid LQ that are supplied per unit of time to the first and second supply ports 47, 48. For example, increasing the amount of the liquid LQ that is supplied via the first supply ports 47 makes it possible to more effectively prevent the intermixing of the gas from the first gap G1 with the liquid LQ that is present along the optical path of the exposure light EL.

In addition, decreasing the amount of the liquid LQ supplied via the second supply ports 48 makes it possible to restrict the amount of the liquid LQ that flows into the space 30; therefore, it is possible to reduce the amount of the liquid LQ recovered at the second recovery port 49 and to thereby prevent, for example, the liquid LQ from remaining on the substrate P. In addition, it is also possible to adjust the amounts of the liquid LQ supplied via the first and second supply ports 47, 48 in accordance with the shape of the holding member 21, the last optical element 22, the liquid immersion member 4 (all of which form the first gap G1), or any combination thereof. Thus, it is possible to appropriately adjust the amounts of the liquid LQ supplied via the first and second supply ports 47, 48 in accordance with, for example, the desired effect or the shapes of the members that form the first gap G1.

In addition, in the present embodiment, because the liquid immersion member 4 and the recovery member 62 are disposed such that they are spaced apart by the second gap G2, it is possible to reduce the impact of a temperature change and/or vibrations in either the liquid immersion member 4 or the recovery member 62 from affecting the other member.

As explained above, according to the present embodiment, at least some of the liquid LQ in the first gap G1 that is supplied via the first supply ports 47 flows in directions away from the optical axis AX, which makes it possible to prevent exposure failures from occurring and thereby prevent defective devices from being produced.

In addition, in the present embodiment, the liquid LQ can be held in the space 30, the space 50, and the first and second spaces 36, 37, and it is possible to prevent the liquid LQ from flowing to the outer side of the spaces 30, 50, 36, 37. Preventing the outflow of the liquid LQ prevents the generation of the heat of vaporization of the liquid LQ and the attendant temperature change (i.e., thermal deformation) of the substrate P or temperature changes in the ambient environment of the substrate P. Accordingly, it is possible to prevent exposure failures from occurring and defective devices from being produced.

Furthermore, the present embodiment explained an exemplary case wherein, as shown in FIG. 19, the second portion 35 of the liquid immersion member 4 and the first recovery port 43 (i.e., the upper surface 63) are disposed at substantially the same height, but the first recovery port 43 (i.e., the upper surface 63) can also be disposed at a position that is lower than (on the −Z side) that of the second portion 35. Even if disposed in this manner, the liquid LQ from the first gap G1 can be recovered smoothly via the first recovery port 43.

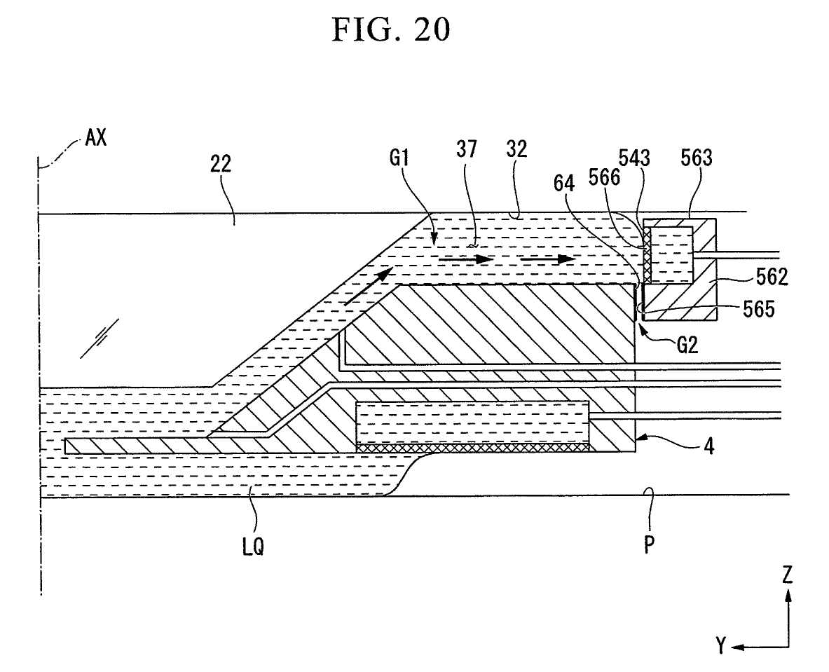

In addition, the first recovery port that recovers the liquid LQ from the first gap G1 does not have to face the +Z direction. For example, as shown in FIG. 20, a first recovery port 543 may be disposed such that it faces toward the optical axis AX. In FIG. 20, the first recovery port 543 is disposed such that it faces the second space 37 (i.e., the first gap G1). In the present embodiment, a front surface of a porous member 566 of the first recovery port 543 is substantially parallel to the optical axis AX (i.e., the Z axis). Thus, the first recovery port 543 is disposed so that it faces toward the optical axis AX and, compared with the layout shown in FIG. 19, the surface area of an interface of the liquid LQ that flows through the first gap G1 (i.e., the surface area over which the liquid LQ contacts the gas) can be made smaller, which makes it possible to prevent the vaporization of the liquid LQ.

In addition, in the present embodiment as well, both the outer surface 64 of the liquid immersion member 4 and an inner surface 565 of a recovery member 562, which form the second gap G2, are liquid repellent with respect to the liquid LQ. Furthermore, only the outer surface 64 or only the inner surface 565, which form the second gap G2, may be liquid repellent with respect to the liquid LQ. In addition, in FIG. 20, at least part of an upper surface 563 of the recovery member 562 and/or the outer surface 32 of the holding member 21, which opposes the upper surface 563 of the recovery member 562, may be liquid repellent. Thereby, it is possible to prevent the liquid LQ from flowing out of a gap between the recovery member 562 and the holding member 21. Furthermore, in FIG. 20, the front surface of the porous member 566 may be inclined with respect to the optical axis AX (i.e., the Z axis).

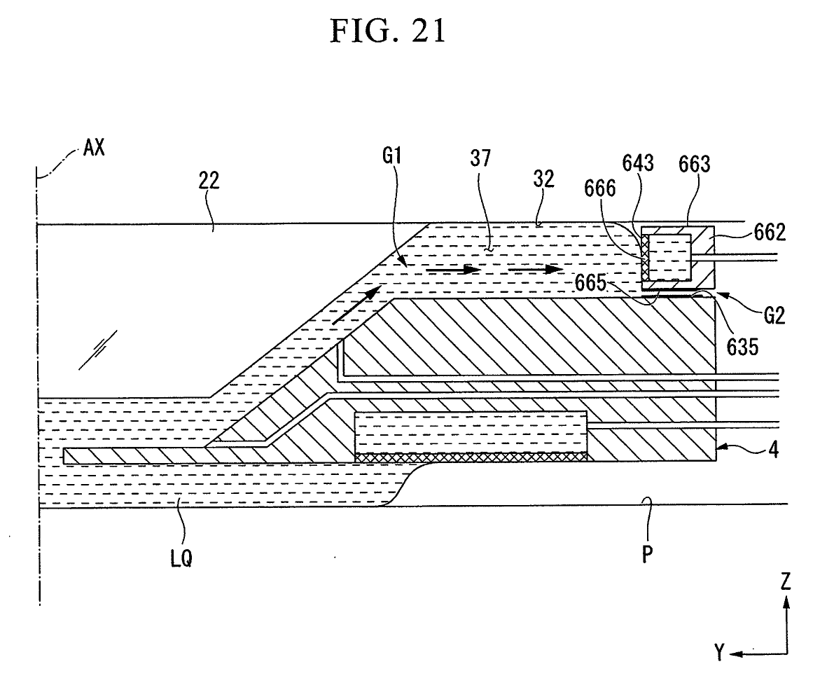

FIG. 21 is a modified example of the embodiment shown in FIG. 20; as shown in FIG. 21, a recovery member 662, which has a first recovery port 643 that is disposed such that it faces the optical axis AX, may be disposed between the outer surface 32 of the holding member 21. and the liquid immersion member 4. In the present embodiment as well, a lower surface 665 of the recovery member 662 and part of a second portion 635 of the inner surface 33 of the liquid immersion member 4, which form the second gap G2, are both liquid repellent with respect to the liquid LQ. Furthermore, only part of the second portion 635 or only the lower surface 665 of the recovery member 662, which form the second gap G2, may be liquid repellent with respect to the liquid LQ.

In addition, in FIG. 20 and FIG. 21, the front surfaces of the porous members disposed in the first recovery ports may be inclined with respect to the optical axis AX (i.e., the Z axis).

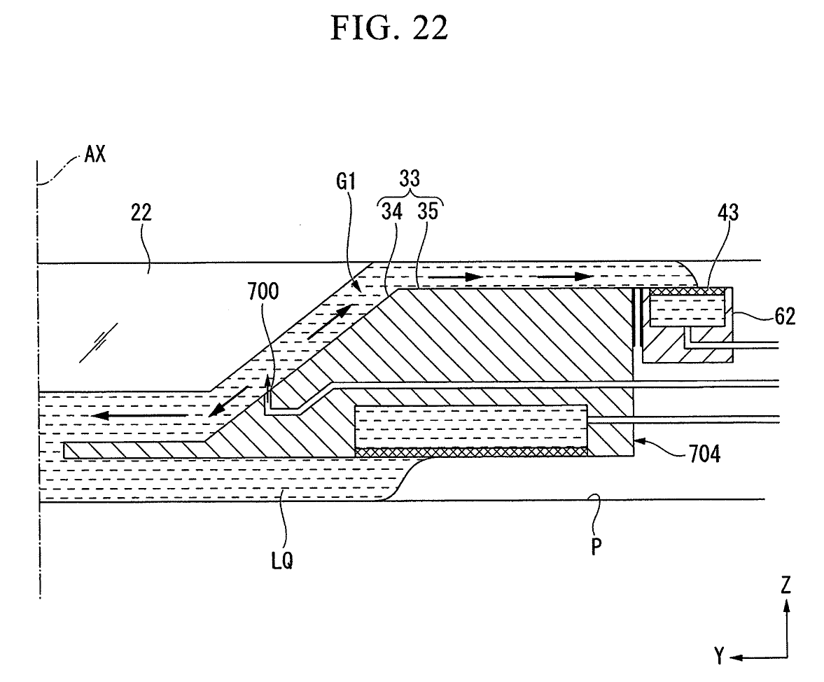

Furthermore, each of the embodiments discussed above explained an exemplary case wherein the first and second supply ports 47, 48 are provided to the inner surface of the liquid immersion member 4; however, as shown in FIG. 22, either the first supply ports or the second supply ports may be omitted. A liquid immersion member 704 shown in FIG. 22 has one supply port 700 in the inner surface 33 (i.e., the first portion 34). Some of the liquid LQ supplied via the supply port 700 flows in the first gap G1 in directions away from the optical axis AX, and the remaining liquid LQ is supplied to the optical path of the exposure light EL that emerges from the emergent surface 23. Furthermore, in FIG. 22, the supply port 700 faces the +Z direction, but may face some other direction. For example, it may face toward the optical axis AX.

In each of the embodiments discussed above, the liquid immersion member (4 and the like) is supported by the first support mechanisms 28A and the recovery member (62 and the like) is supported by the second support mechanisms 28B, but the liquid immersion member and the recovery member may be supported by the same support mechanisms in the state wherein the second gap G2 is formed between the liquid immersion member and the recovery member.

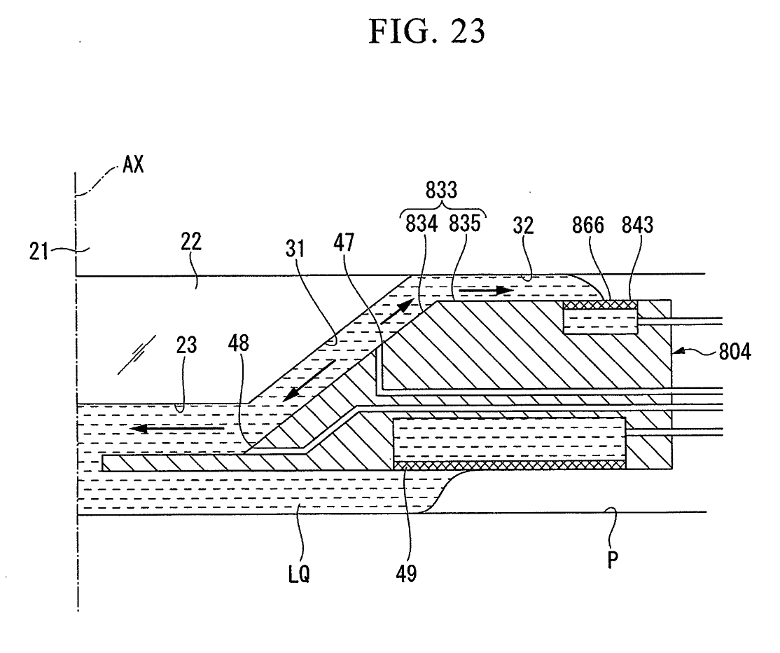

Each of the embodiments discussed above explained an exemplary case wherein the first recovery port (43 and the like) is provided to the recovery member (62 and the like), which is separate from the liquid immersion member (4 and the like); however, as shown in FIG. 23, a first recovery port can be provided to a liquid immersion member 804 that is disposed around the optical path of the exposure light EL such that the optical path of the exposure light EL that emerges from the emergent surface 23 is filled with the liquid LQ. Similar to the liquid immersion member 4 discussed above, the liquid immersion member 804 shown in FIG. 23 has an inner surface 833, which opposes the outer surface 31 and the outer surface 32; in addition, the first recovery port 843 is disposed in the inner surface 833. The first recovery port 843 is disposed in the inner surface 833 such that it is spaced apart from the first supply ports 47 with respect to the optical axis AX. The inner surface 833 has a first portion 834 and a second portion 835, and the first recovery port 843 is disposed in the second portion 835. Furthermore, even if a first recovery port were provided to the liquid immersion member 804, the first recovery port would not have to face the +Z direction. For example, as shown in FIG. 20 and FIG. 21, the first recovery ports may be provided to the liquid immersion member such that it faces toward the optical axis AX.

Furthermore, in each of the embodiments discussed above, the porous members are disposed in the first recovery port (43 and the like) and in the second recovery port 49, and only the liquid LQ passes through the porous members from one side to the other side; however, the first recovery port, the second recovery port 49, or both may recover the liquid LQ together with the gas. In addition, the porous members do not have to be disposed in either the first recovery port or the second recovery port.

In addition, in each of the embodiments discussed above, the second space 37 extends in radial directions with respect to the optical axis AX (i.e., in directions perpendicular to the optical axis AX), but may be inclined with respect to directions perpendicular to the optical axis AX (i.e., with respect to the XY plane). For example, the second space 37 may be inclined such that it extends in radial directions with respect to the optical axis AX and in the +Z direction.

Furthermore, each of the embodiments discussed above explained an exemplary case wherein the inclination angle of the first space 36 with respect to a plane perpendicular to the optical axis (i.e., the XY plane) is greater than the inclination angle of the second space 37 with respect to the plane perpendicular to the optical axis, but the inclination angle of the first space 36 with respect to the plane perpendicular to the optical axis may be the same as or smaller than the inclination angle of the second space 37 with respect to the plane perpendicular to the optical axis.

Furthermore, in the embodiments discussed above, the size of the first gap G1 may be the same as that of the first space 36 and the second space 37, or it may be different.

Furthermore, in each of the embodiments discussed above, the second space 37 is formed between the outer surface 32 of the holding member 21 and the liquid immersion member (4 and the like), but may be formed between the last optical element 22 and the holding member 21 on one side and the liquid immersion member on the other side. Namely, the second portion (35 and the like) of the inner surface of the liquid immersion member may be opposed to the last optical element 22 and the holding member 21. In addition, the entire first gap G1 (i.e., the first space and the second space) may be formed between the last optical element 22 and the liquid immersion member 4.

In addition, in each of the embodiments discussed above, at least part of the outer surface of the last optical element 22 that defines the first gap G1, at least part of the outer surface of the holding member 21, at least part of the inner surface of the liquid immersion member, or any combination thereof preferably is lyophilic to the liquid LQ (i.e., the contact angle of the liquid LQ with respect to such a part is 40°, 30°, 20°, or less).

In addition, in each of the embodiments discussed above, the first recovery port (43 and the like) that recovers the liquid LQ from the first gap G1 is disposed annularly around the optical axis AX (i.e., around the first gap G1), but may be disposed partially around the optical axis AX (e.g., dispersed at equal intervals).

In addition, in each of the embodiments discussed above, the liquid LQ flows continuously from a first supply port 47 to the first recovery port (43 and the like) at least during the exposure of the substrate P, but the liquid LQ may flow intermittently.

### Fourth Embodiment

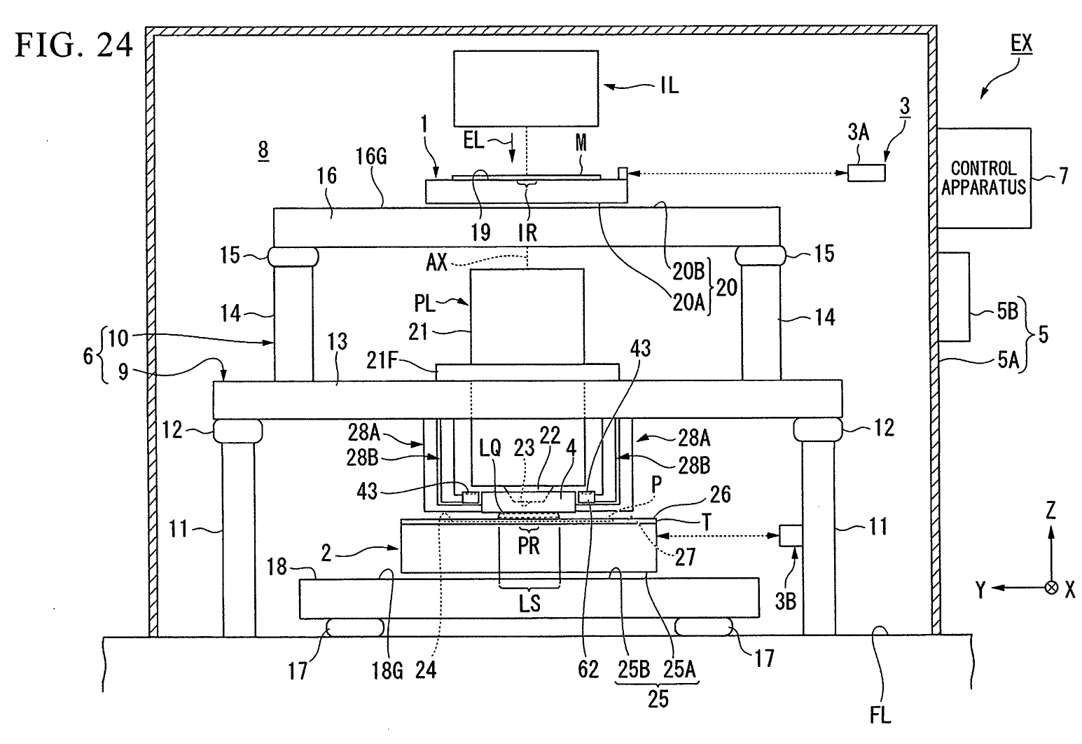

The following text explains a fourth embodiment. FIG. 24 is a schematic block diagram that shows one example of an exposure apparatus EX according to the fourth embodiment. In the explanation below, constituent parts that are identical or equivalent to those in the embodiment discussed above are assigned identical symbols, and the explanations thereof are therefore abbreviated or omitted.

In the present embodiment, as shown in FIG. 24, the exposure apparatus EX comprises: a recovery member 62, which is disposed in the vicinity of the liquid immersion member 4 and has a first recovery port 43 that is capable of recovering the liquid LQ;

The liquid immersion member 4 is supported by first support mechanisms 28A. The recovery member 62 is supported by second support mechanisms 28B. In the present embodiment, the first and second support mechanisms 28A, 28B are supported by the first base plate 13. In the present embodiment, the liquid immersion member 4 is suspended from the first base plate 13 via the first support mechanisms 28A. The recovery member 62 is suspended from the first base plate 13 via the second support mechanisms 28B.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. When the substrate P is to be exposed, the control apparatus 7 controls the mask stage 1 and the substrate stage 2 so as to move the mask M and the substrate P in the prescribed scanning directions within the XY plane, which intersects the optical axis AX (i.e., the optical path of the exposure light EL). In the present embodiment, the scanning directions (i.e., the synchronous movement directions) of both the substrate P and the mask M are the Y axial directions. The control apparatus 7 radiates the exposure light EL to the substrate P through the projection system PL and the liquid LQ in the immersion space LS on the substrate P while moving the substrate P in one of the Y axial directions with respect to the projection area PR of the projection system PL and moving the mask M, synchronized to the movement of the substrate P, in the other Y axial direction with respect to the illumination area IR of the illumination system IL. Thereby, the image of the pattern of the mask M is projected to the substrate P, which is thereby exposed by the exposure light EL.

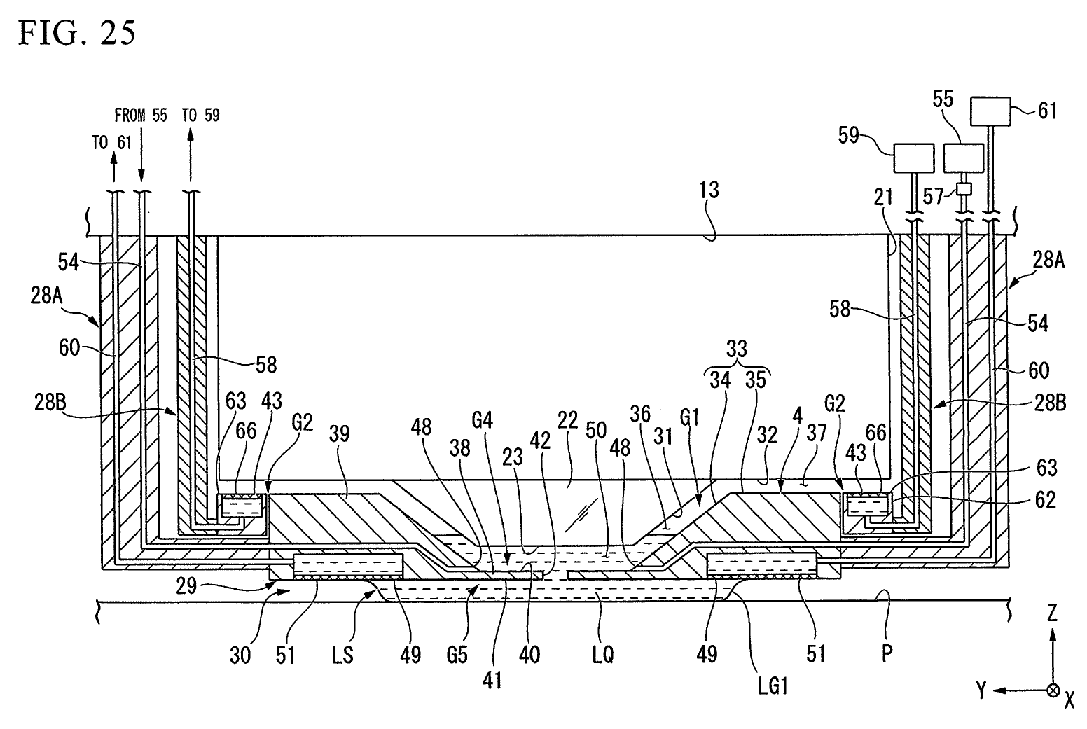

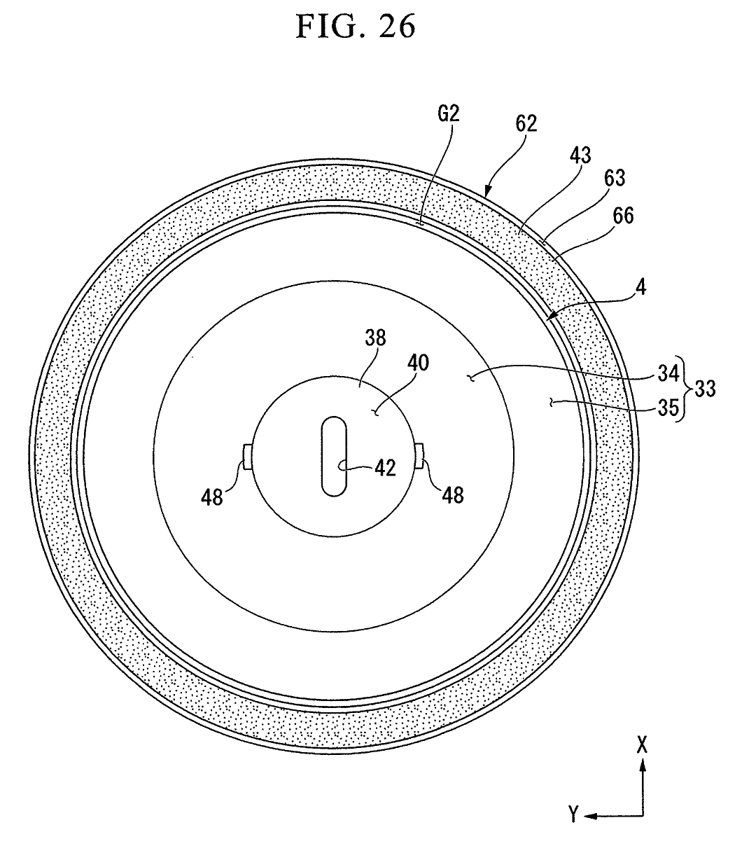

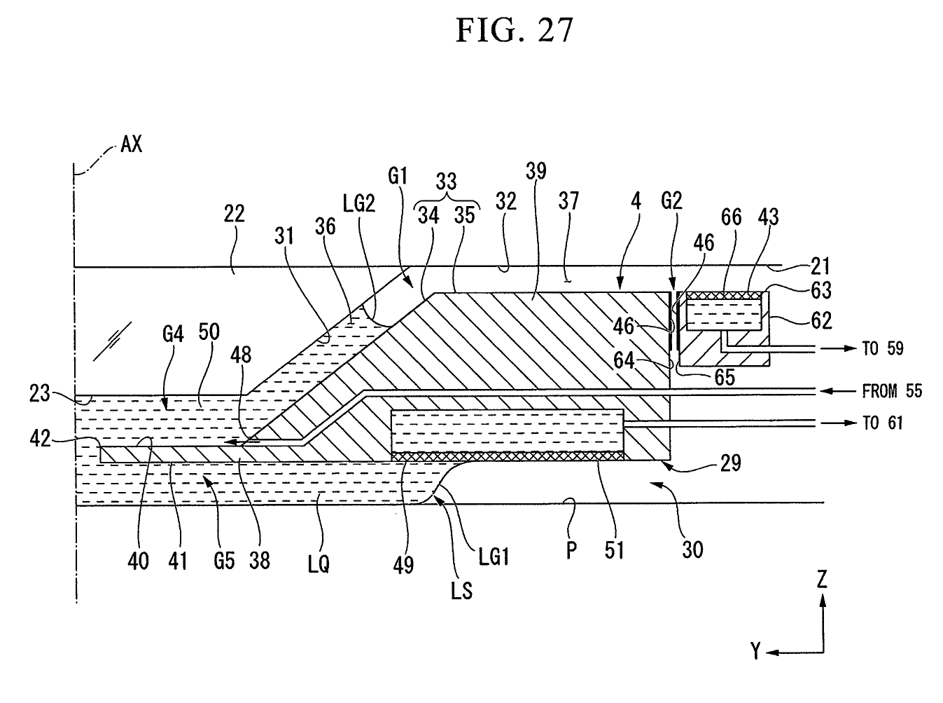

FIG. 25 is a side cross sectional view that shows the vicinity of the liquid immersion member 4 and the recovery member 62, FIG. 26 shows the liquid immersion member 4 and the recovery member 62 viewed from above, and FIG. 27 is a partial enlarged view of FIG. 25. As shown in FIG. 25, FIG. 26, and FIG. 27, the liquid immersion member 4 is disposed in the vicinity of the last optical element 22. The liquid immersion member 4 is disposed at least partly around the optical path of the exposure light EL such that the optical path of the exposure light EL that emerges from the emergent surface 23 is filled with the liquid LQ. In the present embodiment, the liquid immersion member 4 is an annular member. The liquid immersion member 4 is disposed around part of the optical path of the exposure light EL and around the last optical element 22. In addition, in the present embodiment, the recovery member 62 is an annular member that is disposed around the liquid immersion member 4. Furthermore, the liquid immersion member 4 and the recovery member 62 do not have to be circular ring-shaped and may be, for example, rectangular ring-shaped. The liquid immersion member 4 forms the immersion space LS such that the optical path of the exposure light EL between the emergent surface 23 and an object, which is disposed at a position at which it opposes the emergent surface 23, is filled with the liquid LQ. The immersion space LS is a portion (i.e., a space or area) that is filled with the liquid LQ. In the present embodiment, the object includes the substrate stage 2 (i.e., the plate member T), the substrate P, which is held by the substrate stage 2, or both. During an exposure of the substrate P, the liquid immersion member 4 forms the immersion space LS such that the optical path of the exposure light EL between the last optical element 22 and the substrate P is filled with the liquid LQ.

The liquid immersion member 4 has a lower surface 29, which is capable of opposing the object. A space 30 between the lower surface 29 and the object is capable of holding the liquid LQ. Part of the immersion space LS is formed by the liquid LQ held between the lower surface 29 and the object. In the present embodiment, when the substrate P is irradiated with the exposure light EL, the immersion space LS is already formed such that part of the area of the front surface of the substrate P that includes the projection area PR is covered with the liquid LQ. An interface LG1 (i.e., a meniscus or an edge) of the liquid LQ of the immersion space LS is formed between the lower surface 29 of the liquid immersion member 4 and a front surface (i.e., an upper surface) of the object. The exposure apparatus EX of the present embodiment adopts a local liquid immersion system.

For the sake of simplicity, the text below explains an exemplary case wherein the immersion space LS is formed by disposing the substrate P at a position at which it opposes the emergent surface 23 and the lower surface 29 and holding the liquid LQ between the emergent surface 23 and the lower surface 29 on one side and the front surface of the substrate P on the other side. Furthermore, as discussed above, the immersion space LS can be formed between the emergent surface 23 and the lower surface 29 on one side and the upper surface 26 of the substrate stage 2 (i.e., the plate member T) on the other side.

In the present embodiment, the liquid immersion member 4 has an inner surface 33 that opposes, across a first gap G1, an outer surface 31 of the last optical element 22, an outer surface 32 of the holding member 21 that holds the last optical element 22, or both. In the present embodiment, the inner surface 33 comprises: a first portion 34, which extends in radial directions (i.e., in directions perpendicular to the optical axis AX) with respect to the optical axis AX of the last optical element 22 (i.e., the projection system PL) and in a direction (i.e., the +Z direction) that is the reverse of the direction that the emergent surface 23 of the last optical element 22 faces; and a second portion 35, which is disposed on the outer side of at least part of the first portion 34 with respect to the optical axis AX. In the present embodiment, the second portion 35 is disposed around the first portion 34. The first gap G1 includes a first space 36, which is defined by the first portion 34, and a second space 37, which is defined by the second portion 35.

The outer surface 31 of the last optical element 22 is a surface that is different from and disposed around the emergent surface 23. Namely, the outer surface 31 is a surface wherethrough the exposure light EL does not pass. The outer surface 31 is inclined such that it extends in radial directions (i.e., directions perpendicular to the optical axis AX) with respect to the optical axis AX and in the +Z direction. In the present embodiment, the outer surface 31 and the first portion 34 are opposed. In the present embodiment, the outer surface 31 and the first portion 34 are substantially parallel. The first space 36 includes a space between the outer surface 31 and the first portion 34. In radial directions with respect to the optical axis AX, the first space 36 is inclined such that it extends in a direction (i.e., the +Z direction) that leads away from the image plane of the projection system PL. Namely, the first space 36 is a space that is inclined in the +Z direction with respect to the direction that is perpendicular to the optical axis AX (i.e., with respect to the XY plane). Furthermore, the outer surface 31 and the first portion 34 do not have to be parallel. In addition, the outer surface 31, the first portion 34, or both may include a curved surface.

In the present embodiment, the outer surface 32 of the holding member 21 is disposed around the outer surface 31 of the last optical element 22. In the present embodiment, the outer surface 32 and the second portion 35 are opposed. In addition, in the present embodiment, the outer surface 32 and the second portion 35 are substantially parallel. The second space 37 includes a space between the outer surface 32 and the second portion 35. In the present embodiment, the outer surface 32 and the second portion 35 are substantially parallel to the XY plane, and the second space 37 is a space that extends in radial directions with respect to the optical axis AX (i.e., in directions perpendicular to the optical axis AX). Furthermore, the outer surface 32 and the second portion 35 do not have to be substantially parallel to the XY plane. In addition, the outer surface 32 and the second portion 35 do not have to be parallel to one another. In addition, the outer surface 32, the second portion 35, or both may include a curved surface.

In the present embodiment, the liquid immersion member 4 comprises a plate part 38, at least part of which is disposed such that it opposes the emergent surface 23, and a main body part 39, at least part of which is disposed around the last optical element 22. The first portion 34 and the second portion 35 are disposed in the main body part 39. The plate part 38 has an upper surface 40, which opposes the emergent surface 23 across a gap G4 and a lower surface 41, which opposes—across a gap G5—the front surface of the object (e.g., the substrate P) that is disposed such that it opposes the emergent surface 23. In addition, the plate part 38 has an opening 42 wherethrough the exposure light EL that emerges from the emergent surface 23 can pass. During an exposure of the substrate P, the exposure light EL that emerges from the emergent surface 23 is radiated to the front surface of the substrate P through the opening 42.

The recovery member 62 has the first recovery port 43, which recovers the liquid LQ from at least part of the first gap G1. The recovery member 62 is disposed such that it opposes the liquid immersion member 4 across a second gap G2. The recovery member 62 is supported by the second support mechanisms 28B and is disposed at least partly around the liquid immersion member 4, which is supported by the first support mechanisms 28A. Furthermore, it is preferable that the second gap G2 is as small as possible so that the liquid LQ does not enter the second gap G2. For example, the second gap G2 (i.e., the distance between an outer surface 64 and an inner surface 65) is less than 0.1 mm.

The recovery member 62 has an upper surface 63, which opposes the outer surface 32 of the holding member 21. The first recovery port 43 is disposed in the upper surface 63. The first recovery port 43 faces a direction (i.e., the +Z direction) that is the reverse of the direction that the emergent surface 23 faces. The first recovery port 43 is capable of recovering the liquid LQ—that is not supplied to a space 50 below the emergent surface 23—from at least part of the first gap G1.

In the present embodiment, the recovery member 62 is an annular member that is disposed such that it surrounds the liquid immersion member 4. The first recovery port 43 is disposed in the upper surface 63 such that it surrounds the optical axis AX. In the present embodiment, the first recovery port 43 (i.e., the upper surface 63) of the recovery member 62 is disposed at substantially the same height as the second portion 35.

In addition, in the present embodiment, at least one member of the group consisting of the outer surface 64 of the liquid immersion member 4 and the inner surface 65 of the recovery member 62, which form the second gap G2, is liquid repellent with respect to the liquid LQ. In the present embodiment, the contact angle of the liquid LQ with respect to the outer surface 64 of the liquid immersion member 4, the inner surface 65 of the recovery member 62, both of which form the second gap G2, or both is 90° or greater. In the present embodiment, both the outer surface 64 and the inner surface 65 are liquid repellent with respect to the liquid LQ. In the present embodiment, the outer surface 64 and the inner surface 65 are each formed from a film 46 that is liquid repellent with respect to the liquid LQ. The films 46 are formed from a liquid repellent material that contains, for example, fluorine. Examples of liquid repellent materials include tetrafluoroethylene-perfluoro (alkyl vinyl ether) copolymer (PFA), polytetrafluoroethylene (PTFE), polyetheretherketone (PEEK), and Teflon®.

Furthermore, only the outer surface 64 or only the inner surface 65, both of which form the second gap G2, may be liquid repellent with respect to the liquid LQ.

In addition, instead of the films 46, at least part of the liquid immersion member 4 that forms the outer surface 64 and/or at least part of the recovery member 62 that forms the inner surface 65 may be formed from a liquid repellent material, such as tetrafluoroethylene-perfluoro (alkyl vinyl ether) copolymer (PFA), polytetrafluoroethylene (PTFE), or polyetheretherketone (PEEK).

A porous member 66 is disposed in the first recovery port 43. The porous member 66 is plate shaped and has a plurality of holes (i.e., openings or pores). Furthermore, the porous member 66 may be a mesh filter, which is a porous member wherein numerous small holes are formed as a mesh. The upper surface 63 of the recovery member 62 includes the upper surface of the porous member 66.

In addition, the liquid immersion member 4 comprises supply ports 48, which supply the liquid LQ to the optical path of the exposure light EL, and a second recovery port 49, which is capable of recovering the liquid LQ. The supply ports 48 are disposed in the inner surface 33 of the liquid immersion member 4. In the present embodiment, the supply ports 48 are disposed such that they face the space 50 between the emergent surface 23 and the upper surface 40 of the plate part 38. As shown in FIG. 26, in the present embodiment, the supply ports 48 are disposed such that there is one on the +Y side and one on the −Y side of the optical axis AX.

Furthermore, the supply ports 48 are disposed at positions at which they oppose the outer surface 31 of the last optical element 22. In addition, the supply ports 48 may be disposed such that there is one on the +X side and one on the −X side of the optical axis AX. In addition, the number of the supply ports 48 may be three or greater. In addition, instead of or in addition to the supply ports 48 of the inner surface 33, a supply port may be provided to the lower surface 29 of the liquid immersion member 4.

The second recovery port 49 is disposed in the lower surface 29 of the liquid immersion member 4. The second recovery port 49 is capable of recovering the liquid LQ on the front surface of the object (such as the substrate P) that is disposed such that it opposes the lower surface 29 of the liquid immersion member 4. Namely, the liquid LQ on the front surface of the object (i.e., the substrate P and the like) that is disposed such that it opposes the second recovery port 49 can be recovered via the second recovery port 49.

The second recovery port 49 is disposed at least partly around the lower surface 41 of the plate part 38. In the present embodiment, the second recovery port 49 is disposed annularly around the lower surface 41. In addition, in the present embodiment, a porous member 51 is disposed in the second recovery port 49. In the present embodiment, the porous member 51 is plate shaped and has a plurality of holes (i.e., openings or pores). Furthermore, the porous member 51 may be a mesh filter, which is a porous member wherein numerous small holes are formed as a mesh.

In the present embodiment, the lower surface 29 of the liquid immersion member 4 includes the lower surface 41 of the plate part 38 and a lower surface of the porous member 51.

As shown in FIG. 25, the supply ports 48 are connected to a liquid supply apparatus 55 via supply passageways 54. In the present embodiment, the supply passageways 54 comprise passageways that are formed inside the liquid immersion member 4 and passageways that are formed inside the first support mechanisms 28A. The liquid supply apparatus 55 can supply the liquid LQ, which is clean and temperature adjusted, to the supply ports 48. The control apparatus 7 is capable of adjusting the amounts of the liquid supplied per unit of time via the supply ports 48. In the present embodiment, an adjusting apparatus 57, which is called a mass flow controller and is capable of adjusting the amount of liquid supplied per unit of time, is disposed in the supply passageways 54. The control apparatus 7 controls the operation of the adjustment apparatus 57. The control apparatus 7 is capable of adjusting the amounts of the liquid LQ supplied per unit of time via the supply ports 48 by controlling the adjusting apparatus 57. In addition, by adjusting the amounts of the liquid LQ supplied via the supply ports 48, the control apparatus 7 is capable of adjusting the flow speeds of the liquid LQ supplied via the supply ports 48. Furthermore, part of the supply passageways 54 do not have to be provided inside the first support mechanisms 28A that support the liquid immersion member 4.

The first recovery port 43 is connected to a first liquid recovery apparatus 59 via recovery passageways 58. In the present embodiment, the recovery passageways 58 comprise passageways that are formed inside the recovery member 62 and passageways that are formed inside the second support mechanisms 28B. The first liquid recovery apparatus 59 comprises a vacuum system (such as a valve that controls the connection state between a vacuum source and the first recovery port 43) and is capable of recovering the liquid LQ via the first recovery port 43 by suctioning the liquid LQ. Furthermore, part of the recovery passageways 58 do not have to be provided inside the second support mechanisms 28B that support the recovery member 62.

The second recovery port 49 is connected to a second liquid recovery apparatus 61 via recovery passageways 60. In the present embodiment, the recovery passageways 60 comprise passageways that are formed inside the liquid immersion member 4 and passageways that are formed inside the first support mechanisms 28A. The second liquid recovery apparatus 61 comprises a vacuum system (such as a valve that controls the connection state between the vacuum source and the second recovery port 49) and can recover the liquid LQ via the second recovery port 49 by suctioning the liquid LQ. Furthermore, part of the recovery passageways 58 do not have to be provided inside the first support mechanisms 28A that support the liquid immersion member 4.

The control apparatus 7 is capable of separately adjusting the amounts of the liquid LQ recovered per unit of time via the first recovery port 43 and the second recovery port 49.

By controlling the first liquid recovery apparatus 59, the control apparatus 7 can control the pressure differential between a lower surface side and an upper surface side of the porous member 66 such that only the liquid LQ passes through the porous member 66 from the upper surface side (i.e., the first gap G1 side) to the lower surface side (i.e., the recovery passageways 58 side). In the present embodiment, the pressure in the first gap G1, which is on the upper surface side, is controlled by the chamber apparatus 5 and is substantially at atmospheric pressure. The control apparatus 7 adjusts the pressure on the lower surface side in accordance with the pressure on the upper surface side by controlling the first liquid recovery apparatus 59 such that only the liquid LQ passes through the porous member 66 from the upper surface side to the lower surface side. Namely, the control apparatus 7 performs an adjustment such that only the liquid LQ from the first gap G1 is recovered via the holes of the porous member 66 and the gas does not pass therethrough. The technology for adjusting the pressure differential between the one side and the other side of the porous member 66 and thereby causing only the liquid LQ to pass through the porous member 66 from the one side to the other side of is disclosed in, for example, U.S. Pat. No. 7,292,313.

Similarly, by controlling the second liquid recovery apparatus 61, the control apparatus 7 can adjust the pressure differential between the lower surface side and the upper surface side of the porous member 51 such that only the liquid LQ passes through the porous member 51 from the lower surface side (i.e., the space 30 side) to the upper surface side (i.e., the recovery passageways 60 side).

In the present embodiment, the control apparatus 7 is capable of forming the immersion space LS with the liquid LQ between the last optical element 22 and the liquid immersion member 4 on one side and the object (such as the substrate P) that opposes the last optical element 22 and the liquid immersion member 4 on the other side by performing a liquid recovery operation, wherein the second recovery port 49 is used, in parallel with a liquid supply operation, wherein the supply ports 48 are used.

The following explains a method of using the exposure apparatus EX that has the abovementioned configuration to expose the substrate P.

The control apparatus 7: performs the operation of recovering the liquid LQ via the second recovery port 49 in parallel with the operation of supplying the liquid LQ via the second supply ports 48; uses the liquid immersion member 4 to form the immersion space LS between the last optical element 22 and the liquid immersion member 4 on one side and the substrate P, which is held by the substrate stage 2, on the other side such that the optical path of the exposure light EL between the emergent surface 23 of the last optical element 22 and the substrate P is filled with the liquid LQ; and then starts the exposure of the substrate P. The control apparatus 7 radiates the exposure light EL that emerges from the emergent surface 23 to the substrate P through the liquid LQ of the immersion space LS.

In the present embodiment, for example, when the substrate P is substantially stationary, the liquid LQ supplied via the supply ports 48 fills at least part of the first space 36, as shown in FIG. 27. An interface LG2 of the liquid LQ in the first gap G1 is formed between the outer surface 31 and the first portion 34.

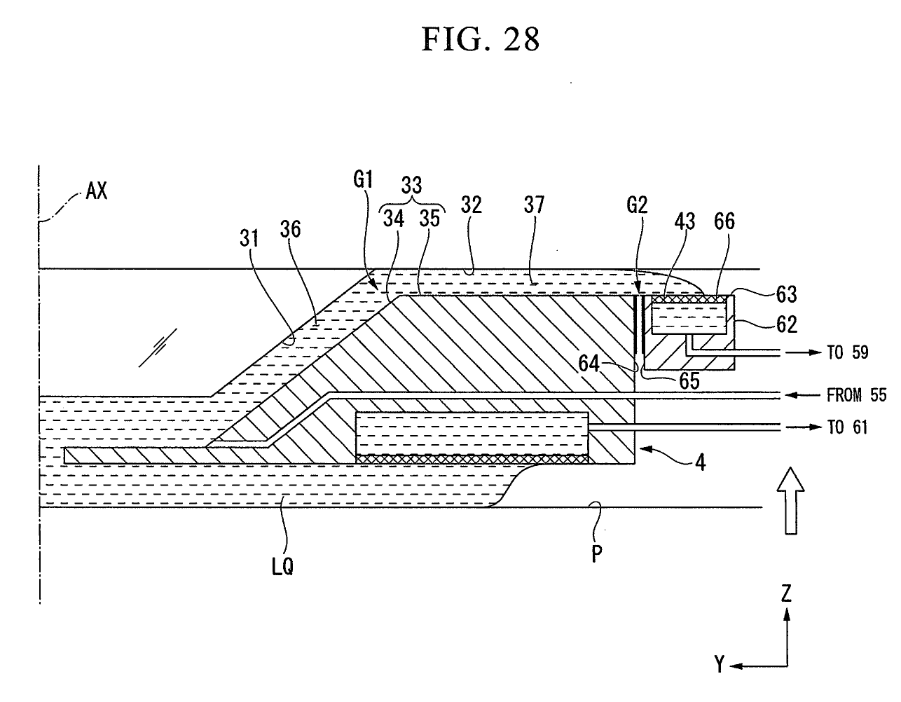

Nevertheless, there is a possibility that the liquid LQ might overflow from the first space 36. FIG. 28 is a view that shows one example of the state of the liquid LQ when the substrate P has moved in the +Z direction. FIG. 28 shows the state wherein, owing to the movement of the substrate P in the +Z direction, the liquid LQ of the first space 36 has overflowed from the first gap G1 (i.e., the first space 36 and the second space 37). An upper end of the first space 36 is connected to the second space 37, and the liquid LQ that overflows from the first space 36 flows into the second space 37. The liquid LQ that overflows from the first space 36 and flows into the second space 37 flows through the second space 37 horizontally and in directions away from the optical axis AX.

The first recovery port 43 is disposed on the outer side of the second space 37 with respect to the optical axis AX and is capable of recovering the liquid LQ from the second space 37. Namely, the first recovery port 43 recovers the liquid LQ that overflows from the second space 37. Thus, in the present embodiment, the first recovery port 43 recovers, via the second space 37, the liquid LQ that overflows from the first space 36.

In the present embodiment, the first recovery port 43 recovers the liquid LQ that overflows from the first gap G1, which includes the first and second spaces 36, 37, and that passes over the second gap G2. In the present embodiment, because the outer surface 64 and the inner surface 65, which form the second gap G2, are liquid repellent with respect to the liquid LQ, the liquid LQ is prevented from penetrating the second gap G2.

In the present embodiment, the first recovery port 43 recovers the liquid LQ that overflows from the first gap G1, which makes it possible to prevent the liquid LQ from flowing out of the first gap G1.

Furthermore, the above explained an exemplary case wherein the liquid LQ overflows from the first gap G1 because of the movement of the substrate P; however, it is also conceivable that the liquid LQ would overflow as a result of other movement conditions of the substrate P, such as an increase in the amounts of the liquid LQ supplied via the supply ports 48.

As explained above, according to the present embodiment, the first recovery port 43 is provided to the recovery member 62, which is disposed such that it opposes the liquid immersion member 4 across the second gap G2, and therefore it is possible to prevent the liquid LQ from flowing to the outer side of the first recovery port 43. Preventing the outflow of the liquid LQ prevents the generation of the heat of vaporization of the liquid LQ that flowed out and the attendant temperature change (i.e., thermal deformation) of the substrate P or in the ambient environment of the substrate P. Accordingly, it is possible to prevent exposure failures from occurring and defective devices from being produced.

In addition, according to the present embodiment as discussed above, the liquid immersion member 4 and the recovery member 62 are supported such that they are spaced apart by the second gap G2. Namely, the liquid immersion member 4 and the recovery member 62 are supported such that they are spaced apart by the second gap G2 so that the transmission of vibrations from one to the other is prevented. For example, the vibrations generated by the recovery member 62 can be prevented from transmitting to the liquid immersion member 4. Similarly, the vibrations generated by the liquid immersion member 4 can be prevented from transmitting to the recovery member 62.

In addition, the liquid immersion member 4 and the recovery member 62 are supported such that they are spaced apart by the second gap G2 so that the transfer of heat from one to the other is prevented. For example, even if the temperature of either the liquid immersion member 4 or the recovery member 62 is changed by, for example, the vaporization of the liquid LQ (i.e., even if the temperature falls), it is possible to prevent the propagation of that temperature change to the other member.

In addition, according to the present embodiment, only the liquid LQ is recovered via the first recovery port 43, which makes it possible to prevent the generation of vibrations caused by the operation of recovering the liquid LQ and/or to prevent the vaporization of the liquid LQ.

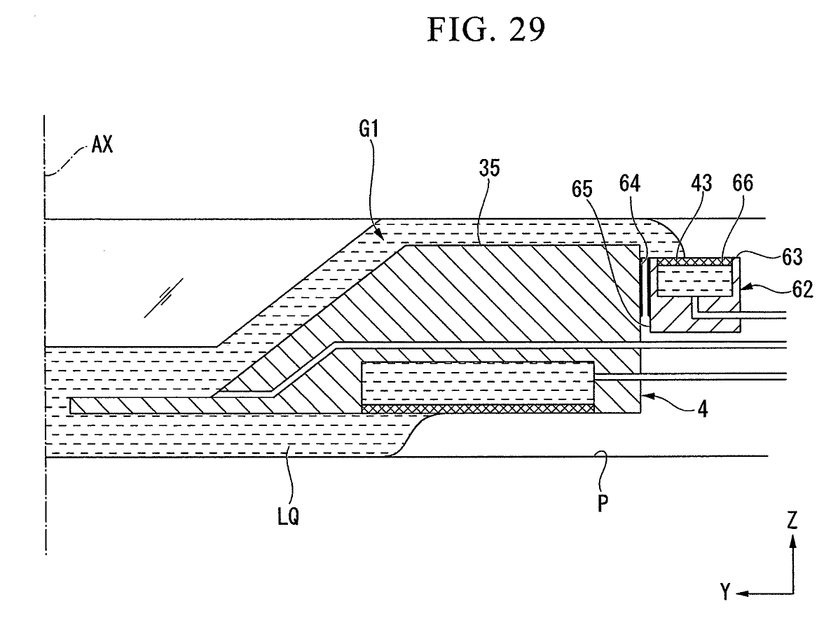

Furthermore, as shown in FIG. 29, it is also possible to dispose the first recovery port 43 (i.e., the upper surface 63) of the recovery member 62 at a position that is lower than (on the −Z side of) the second portion 35 of the liquid immersion member 4. The liquid LQ that overflows from the first gap G1 is supplied smoothly to the first recovery port 43, which makes it possible for the first recovery port 43 to smoothly recover the liquid LQ that overflows from the first gap G1.

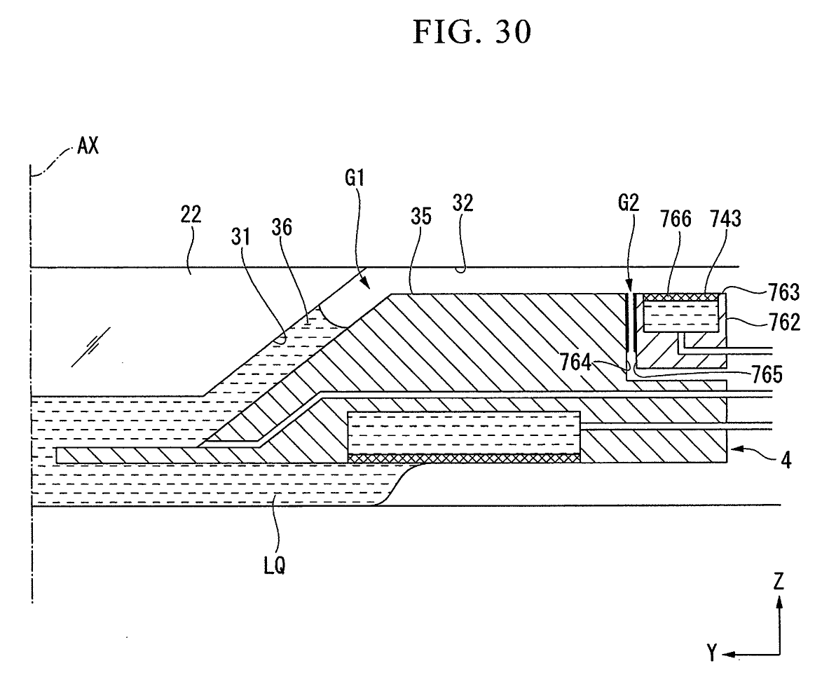

Furthermore, a recovery member 762, which has a first recovery port 743 that recovers the liquid LQ that overflows from the first gap G1, may be disposed as shown in FIG. 30.

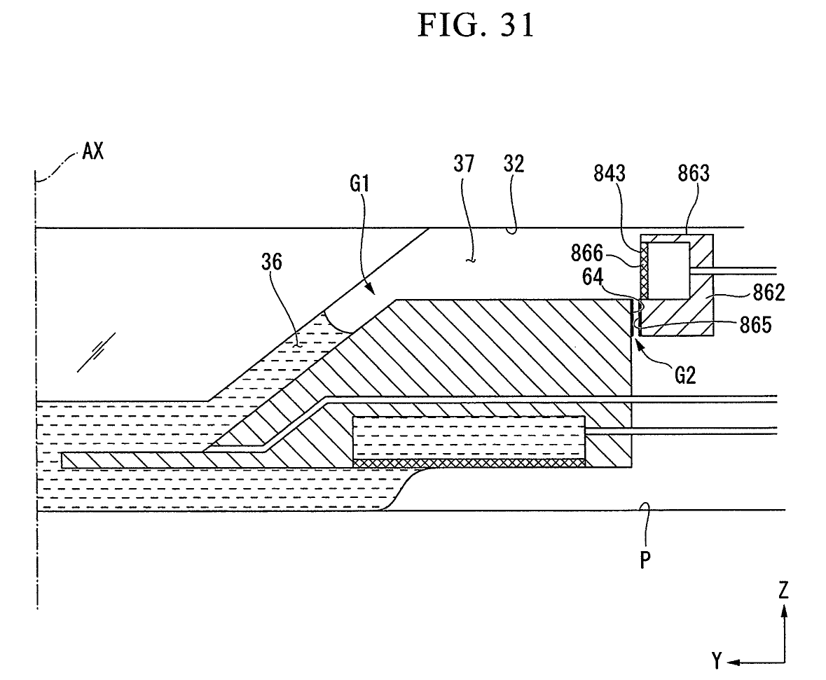

In addition, the first recovery port that recovers the liquid LQ from the first gap G1 does not have to face the +Z direction. For example, as shown in FIG. 31, a first recovery port 843 may be disposed such that it faces toward the optical axis AX. In FIG. 31, the first recovery port 843 is disposed such that it faces the second space 37 (i.e., the first gap G1). In the present embodiment, a front surface of a porous member 866 of the first recovery port 843 is substantially parallel to the optical axis AX (i.e., the Z axis). In addition, in the present embodiment as well, both the outer surface 64 of the liquid immersion member 4 and an inner surface 865 of a recovery member 862, which form the second gap G2, are liquid repellent with respect to the liquid LQ. Furthermore, only the outer surface 64 or only the inner surface 865, which form the second gap G2, may be liquid repellent with respect to the liquid LQ.

In addition, in FIG. 31, at least part of an upper surface 863 of the recovery member 862 and/or the outer surface 32 of the holding member 21, which opposes the upper surface 863 of the recovery member 862, may be liquid repellent. Thereby, it is possible to prevent the liquid LQ from flowing out of a gap between the recovery member 762 and the holding member 21.

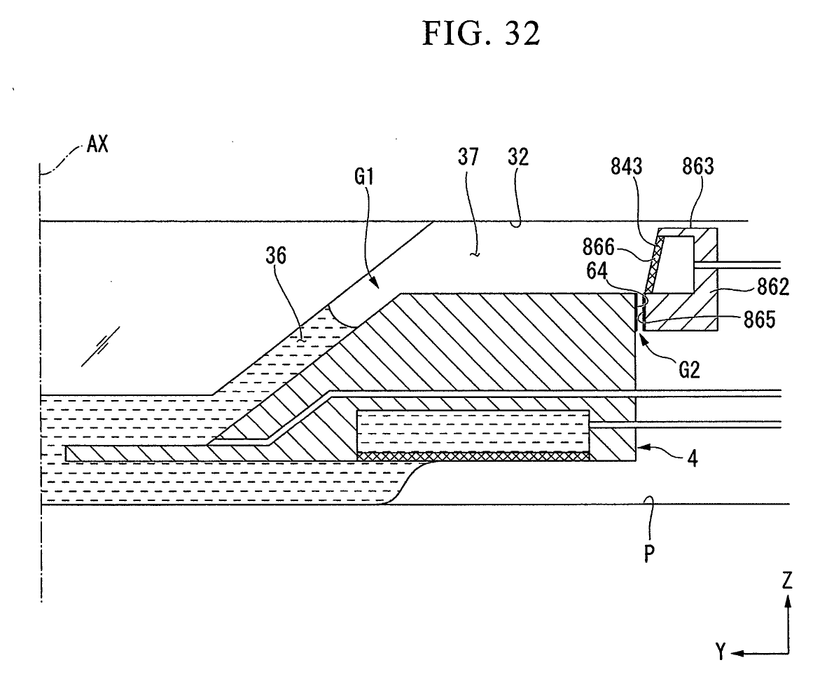

FIG. 32 is a modified example of the embodiment shown in FIG. 31; as shown in FIG. 32, the front surface of the porous member 866 of the first recovery port 843, which is disposed such that it faces the optical axis AX, may be inclined.

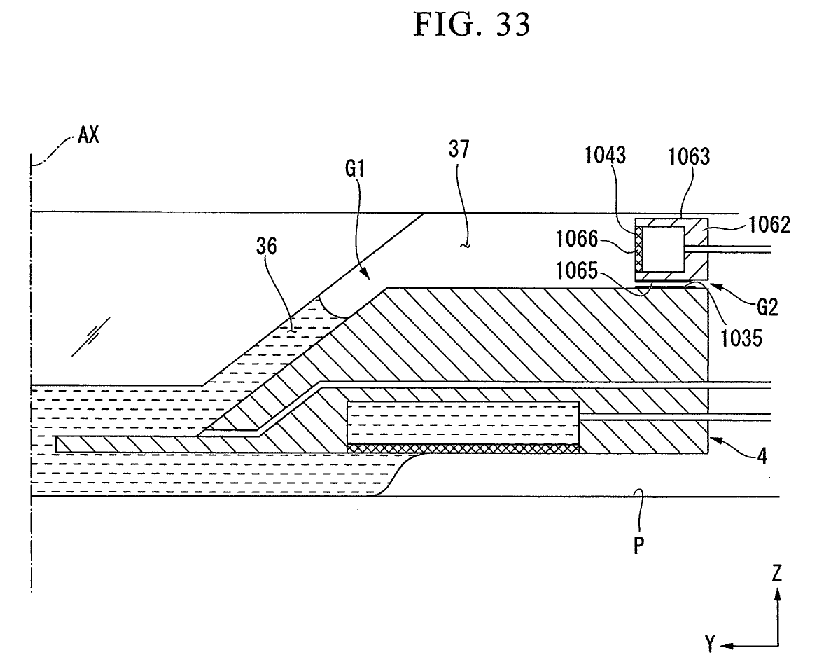

FIG. 33 is a modified example of the embodiment shown in FIG. 31; as shown in FIG. 33, a recovery member 1062, which has a first recovery port 1043 that is disposed such that it faces the optical axis AX, may be disposed between the outer surface 32 of the holding member 21 and the liquid immersion member 4. In the present embodiment as well, a lower surface 1065 of the recovery member 1062 and part of a second portion 1035 of the inner surface 33 of the liquid immersion member 4, which form the second gap G2, are both liquid repellent with respect to the liquid LQ. Furthermore, only part of the second portion 1035 or only the lower surface 1065 of the recovery member 1062, which form the second gap G2, may be liquid repellent with respect to the liquid LQ. In this case as well, at least part of an upper surface 1063 of the recovery member 1062 and/or the outer surface 32 of the holding member 21, which opposes the upper surface 1063 of the recovery member 1062, may be liquid repellent. In this case as well, the front surface of a porous member 1066 may be inclined as shown in FIG. 32.

Furthermore, in each of the embodiments discussed above, the porous members are disposed in the first recovery port (43 and the like) and in the second recovery port 49, and only the liquid LQ passes through the porous members from one side to the other side; however, the first recovery port, the second recovery port 49, or both may recover the liquid LQ together with the gas. In addition, the porous members do not have to be disposed in either the first recovery port or the second recovery port 49.

In addition, in each of the embodiments discussed above, the second space 37 extends in radial directions with respect to the optical axis AX (i.e., in directions perpendicular to the optical axis AX), but may be inclined with respect to directions perpendicular to the optical axis AX (i.e., with respect to the XY plane). For example, the second space 37 may be inclined such that it extends in radial directions with respect to the optical axis AX and in the +Z direction.

In addition, each of the embodiments discussed above explained an exemplary case wherein the inclination angle of the first space 36 with respect to the plane perpendicular to the optical axis AX (i.e., with respect to the XY plane) is greater than the inclination angle of the second space 37 with respect to the plane perpendicular to the optical axis AX, but the inclination angle of the first space 36 with respect to the plane perpendicular to the optical axis AX may be the same as or smaller than the inclination angle of the second space 37 with respect to the plane perpendicular to the optical axis AX.

Furthermore, in the embodiments discussed above, the size of the first gap G1 may be the same as that of the first space 36 and the second space 37, or it may be different.

Furthermore, in each of the embodiments discussed above, the second space 37 is formed between the outer surface 32 of the holding member 21 and the liquid immersion member 4 (i.e., the inner surface 33), but may be formed between the last optical element 22 and the holding member 21 on one side and the liquid immersion member 4 on the other side. Namely, the inner surface 33 (i.e., the second portion 35) of the liquid immersion member 4 may be opposed to the last optical element 22 and the holding member 21. In addition, the entire first gap G1 may be formed between the last optical element 22 and the liquid immersion member 4.

In addition, in each of the embodiments discussed above, at least part of the outer surface of the last optical element 22 that defines the first gap G1, at least part of the outer surface of the holding member 21, at least part of the inner surface of the liquid immersion member, or any combination thereof preferably is lyophilic with respect to the liquid LQ (i.e., the contact angle of the liquid LQ with respect to such a part is 40°, 30°, 20°, or less).

In addition, in each of the embodiments discussed above, the liquid immersion member 4 is supported by the first support mechanisms 28A and the recovery member (62 and the like) is supported by the second support mechanisms 28B, but the liquid immersion member 4 and the recovery member (62 and the like) may be supported by the same support mechanisms in the state wherein the second gap G2 is formed between the liquid immersion member 4 and the recovery member (62 and the like).

In addition, in each of the embodiments discussed above, the first recovery port (43 and the like) that recovers the liquid LQ from the first gap G1 is disposed annularly around the optical axis AX (i.e., around the first gap G1), but may be disposed partially around the optical axis AX (e.g., dispersed at equal intervals).

Furthermore, in each of the embodiments discussed above, the optical path on the emergent (image plane) side of the last optical element 22 of the projection system PL is filled with the liquid LQ; however, it is possible to use a projection system wherein the optical path on the incident (object plane) side of the last optical element 22 is also filled with the liquid LQ, as disclosed in, for example, PCT International Publication No. WO2004/019128.

Furthermore, although the liquid LQ in each of the embodiments discussed above is water, it may be a liquid other than water. For example, it is also possible to use hydro-fluoro-ether (HFE), perfluorinated polyether (PFPE), Fomblin® oil, or the like as the liquid LQ. In addition, it is also possible to use various fluids, for example, a supercritical fluid, as the liquid LQ.

Furthermore, the substrate P in each of the embodiments discussed above is not limited to a semiconductor wafer for fabricating semiconductor devices, but can also be adapted to, for example, a glass substrate for display devices, a ceramic wafer for thin film magnetic heads, or the original plate of a mask or a reticle (i.e., synthetic quartz or a silicon wafer) used by an exposure apparatus.

The exposure apparatus EX can also be adapted to a step-and-scan type scanning exposure apparatus (i.e., a scanning stepper) that scans and exposes the pattern of the mask M by synchronously moving the mask M and the substrate P, as well as to a step-and-repeat type projection exposure apparatus (i.e., a stepper) that successively steps the substrate P and performs a full-field exposure of the pattern of the mask M with the mask M and the substrate P in a stationary state.

Furthermore, when performing an exposure with a step-and-repeat system, the projection system may be used to transfer a reduced image of a first pattern to the substrate P in a state wherein the first pattern and the substrate P are substantially stationary, after which the projection system may be used to perform a full-field exposure of the substrate P, wherein a reduced image of a second pattern partially superposes the transferred first pattern in a state wherein the second pattern and the substrate P are substantially stationary (i.e., as in a stitching type full-field exposure apparatus). In addition, the stitching type exposure apparatus can also be adapted to a step-and-stitch type exposure apparatus that successively steps the substrate P and transfers at least two patterns onto the substrate P such that they are partially superposed.

In addition, the present invention can also be adapted to, for example, an exposure apparatus that combines on a substrate the patterns of two masks through a projection system and double exposes, substantially simultaneously, a single shot region on the substrate using a single scanning exposure, as disclosed in, for example, U.S. Pat. No. 6,611,316. In addition, the present invention can also be adapted to, for example, a proximity type exposure apparatus and a mirror projection aligner.

In addition, the present invention can also be adapted to a twin stage type exposure apparatus, which comprises a plurality of substrate stages, as disclosed in, for example, U.S. Pat. Nos. 6,341,007, 6,208,407, and 6,262,796.

Furthermore, as disclosed in, for example, U.S. Pat. No. 6,897,963 and U.S. Patent Application Publication No. 2007/0127006, the present invention can also be adapted to an exposure apparatus that is provided with: a substrate stage, which holds the substrate; and a measurement stage that does not hold the substrate to be exposed and whereon a fiducial member (wherein a fiducial mark is formed), various photoelectric sensors, or the like, are mounted. In addition, the present invention can also be adapted to an exposure apparatus that comprises a plurality of substrate stages and measurement stages.

The type of exposure apparatus EX is not limited to a semiconductor device fabrication exposure apparatus that exposes the substrate P with the pattern of a semiconductor device, but can also be widely adapted to exposure apparatuses used to fabricate, for example, liquid crystal devices or displays, and to exposure apparatuses used to fabricate thin film magnetic heads, image capturing devices (CCDs), micromachines, MEMS devices, DNA chips, or reticles and masks.

In addition, in each of the embodiments discussed above, an ArF excimer laser may be used as a light source apparatus that generates ArF excimer laser light, which serves as the exposure light EL; however, as disclosed in, for example, U.S. Pat. No. 7,023,610, a harmonic generation apparatus may be used that outputs pulsed light with a wavelength of 193 nm and that comprises: an optical amplifier part, which has a solid state laser light source (such as a DFB semiconductor laser or a fiber laser), a fiber amplifier, and the like; and a wavelength converting part. Furthermore, in the abovementioned embodiments, both the illumination area and the projection area discussed above are rectangular, but they may be some other shape, for example, arcuate.

Furthermore, in each of the embodiments discussed above, an optically transmissive mask is used wherein a prescribed shielding pattern (or phase pattern or dimming pattern) is formed on an optically transmissive substrate; however, instead of such a mask, a variable shaped mask (also called an electronic mask, an active mask, or an image generator), wherein a transmissive pattern, a reflective pattern, or a light emitting pattern is formed based on electronic data of the pattern to be exposed, may be used as disclosed in, for example, U.S. Pat. No. 6,778,257. The variable shaped mask comprises, for example, a digital micromirror device (DMD), which is one kind of non-emissive type image display device (e.g., a spatial light modulator). In addition, instead of a variable shaped mask that comprises a non-emissive type image display device, a pattern forming apparatus that comprises a self-luminous type image display device may be provided. Examples of a self-luminous type image display device include a cathode ray tube (CRT), an inorganic electroluminescence display, an organic electroluminescence display (OLED: organic light emitting diode), an LED display, a laser diode (LD) display, a field emission display (FED), and a plasma display panel (PDP).

Each of the embodiments discussed above explained an exemplary case of an exposure apparatus that comprises the projection system PL, but the present invention can be adapted to an exposure apparatus and an exposing method that do not use the projection system PL. Even if the projection system PL is not used, the exposure light can be radiated to the substrate through optical members, such as lenses, and an immersion space can be formed in a prescribed space between the substrate and those optical members.

In addition, by forming interference fringes on the substrate P as disclosed in, for example, PCT International Publication No. WO2001/035168, the present invention can also be adapted to an exposure apparatus (i.e., a lithographic system) that exposes the substrate P with a line-and-space pattern.

As described above, the exposure apparatus EX in the embodiments is manufactured by assembling various subsystems, as well as each constituent element, such that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus EX from the various subsystems includes, for example, the mechanical interconnection, the wiring and connection of electrical circuits, and the piping and connection of the pneumatic circuits among the various subsystems. Naturally, prior to performing the process of assembling the exposure apparatus EX from these various subsystems, there are also the processes of assembling each individual subsystem. When the process of assembling the exposure apparatus EX from the various subsystems is complete, a comprehensive adjustment is performed to ensure the various accuracies of the exposure apparatus EX as a whole. Furthermore, it is preferable to manufacture the exposure apparatus EX in a clean room, wherein the temperature, the cleanliness level, and the like are controlled.

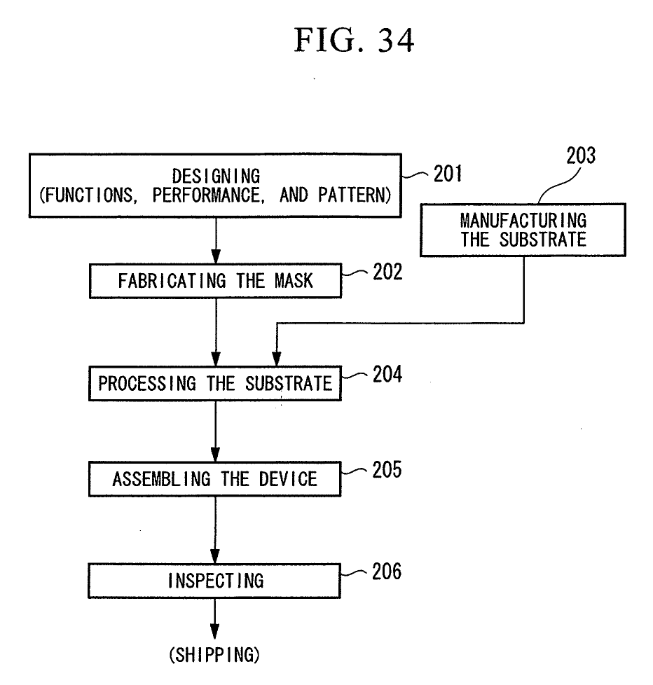

As shown in FIG. 34, a micro-device, such as a semiconductor device, is manufactured by: a step 201 that designs the functions and performance of the micro-device; a step 202 that fabricates the mask M (i.e., a reticle) based on this designing step; a step 203 that manufactures the substrate P, which is the base material of the device; a substrate processing step 204 that includes, in accordance with the embodiments discussed above, exposing the substrate P with the exposure light EL using the pattern of the mask M and developing the exposed substrate P; a device assembling step 205 (which includes fabrication processes, such as dicing, bonding, and packaging); an inspecting step 206; and the like.

Furthermore, the features of each of the embodiments discussed above can be combined as appropriate. In addition, there may be cases wherein some of the constituent elements are not used. In addition, each disclosure of every Japanese published patent application and U.S. patent related to the exposure apparatus recited in each of the embodiments, modified examples, and the like discussed above is hereby incorporated by reference in its entirety to the extent permitted by national laws and regulations.

What is claimed is:

1. An exposure apparatus, comprising:
an optical member, which has an emergent surface wherefrom exposure light emerges;
a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface;
a first recovery port, which is disposed at least partly around an optical axis of the optical member and is capable of recovering a liquid from at least part of the first gap; and
a second gap, which is formed on the outer side of the first recovery port with respect to the optical axis and is smaller than the first gap.

2. The exposure apparatus according to claim 1, further comprising:
a protrusion, which is disposed such that it surrounds the optical axis of at least one member of the group consisting of one member wherein the first recovery port is provided and another member, which opposes the one member;
wherein the second gap is formed by the protrusion.

3. The exposure apparatus according to claim 2, wherein
the protrusion is disposed on the other member;
the first recovery port is demarcated by a first edge and a second edge, which is disposed on the outer side of the first edge with respect to the optical axis; and
the protrusion forms the second gap on the outer side of the second edge with respect to the optical axis.

4. The exposure apparatus according to claim 3, wherein
the protrusion has a third edge, which is disposed such that it surrounds the optical axis, and a fourth edge, which is disposed on the outer side of the third edge with respect to the optical axis; and
the fourth edge is disposed on the outer side of the second edge in a radial direction with respect to the optical axis.

5. The exposure apparatus according to claim 4, wherein
a distance between the first edge and the second edge in the radial direction is smaller than a distance between the third edge and the fourth edge in the radial direction.

6. The exposure apparatus according to claim 4, wherein
a distance between the first edge and the second edge in the radial direction is larger than a distance between the third edge and the fourth edge in the radial direction.

7. The exposure apparatus according to claim 4, wherein
the distance between the first edge and the second edge in the radial direction is smaller than the first gap and larger than the second gap.

8. The exposure apparatus according to claim 4, wherein
in the radial direction, the second edge is disposed between the third edge and the fourth edge and the first edge is disposed on the inner side of the third edge.

9. The exposure apparatus according to claim 8, wherein
at least part of the first recovery port opposes the protrusion.

10. The exposure apparatus according to claim 4, wherein
the second edge and the third edge are disposed at substantially the same position in the radial direction.

11. The exposure apparatus according to claim 4, wherein
the distance between the first edge and the third edge in the radial direction is smaller than the first gap.

12. The exposure apparatus according to claim 1, comprising:
a porous member, which is disposed in the first recovery port.

13. The exposure apparatus according to claim 12, wherein
the pressure differential between one side and another side of the porous member is controlled such that only the liquid passes through the porous member from the one side to the other side.

14. The exposure apparatus according to claim 1, wherein
the first recovery port recovers the liquid, together with a gas, from at least part of the first gap.

15. The exposure apparatus according to claim 1, wherein
the first recovery port faces a direction that is the reverse of the direction that the emergent surface faces.

16. The exposure apparatus according to claim 1, further comprising:
a first supply port, which supplies the liquid to the first gap,
wherein at least some of the liquid supplied via the first supply port flows in the first gap in directions away from the optical axis.

17. The exposure apparatus according to claim 16, wherein
a space between the first supply port and the first recovery port in the first gap is substantially filled with the liquid supplied via the first supply port.

18. The exposure apparatus according to claim 16, wherein
the first supply port is disposed in the inner surface of the second member.

19. The exposure apparatus according to claim 16, wherein
the first recovery port is disposed spaced apart from the first supply ports with respect to the optical axis.

20. The exposure apparatus according to claim 16, wherein
the first supply port faces a direction that is the reverse of the direction that the emergent surface faces.

21. The exposure apparatus according to claim 16, wherein
some of the liquid supplied via the first supply port to the first gap is supplied to the optical path of the exposure light.

22. The exposure apparatus according to claim 16, further comprising:
a second supply port, which is disposed in the inner surface of the second member and supply the liquid;
wherein the second supply port is disposed closer to the emergent surface than the first supply port is.

23. The exposure apparatus according to claim 22, further comprising:
an adjusting apparatus, which separately adjusts the amounts of the liquid supplied per unit of time to the first supply port and the second supply port.

24. The exposure apparatus according to claim 1, wherein
the one member comprises the second member; and
the first recovery port is disposed in the inner surface of the second member.

25. The exposure apparatus according to claim 24, wherein
the inner surface has a first portion, which extends in the radial direction with respect to the optical axis and in a direction that is the reverse of the direction that the emergent surface faces; and a second portion, which is disposed on the outer side of at least part of the first portion with respect to the optical axis; and
the first recovery port is disposed in the second portion.

26. The exposure apparatus according to claim 25, wherein
the first gap has a first space, which is defined by the first portion, and a second space, which is defined by the second portion; and
the second space extends perpendicularly to the optical axis of the optical member.

27. The exposure apparatus according to claim 1, wherein
the one member comprises the second member and a third member, which is disposed such that it opposes the second member across a third gap.

28. The exposure apparatus according to claim 27, further comprising:
a first support mechanism, which supports the second member; and
a second support mechanism, which supports the third member such that the third member is disposed at least partly around the second member.

29. The exposure apparatus according to claim 27, wherein
at least one of the two surfaces that form the third gap is liquid repellent with respect to the liquid.

30. The exposure apparatus according to claim 24, wherein
the other member comprises at least one member of the group consisting of the optical member and the first member.

31. The exposure apparatus according to claim 1, wherein
the one member comprises at least one member of the group consisting of the optical member and the first member.

32. The exposure apparatus according to claim 31, wherein
the other member comprises the second member.

33. The exposure apparatus according to claim 31, wherein
the other member comprises the second member and a third member, which is disposed such that it opposes the second member across a third gap.

34. The exposure apparatus according to claim 1, wherein
at least one of the two surfaces that form the second gap is liquid repellent with respect to the liquid.

35. The exposure apparatus according to claim 1, wherein
the first recovery port recovers the liquid that overflows from at least part of the first gap.

36. The exposure apparatus according to claim 1, wherein
the second member has a second recovery port; and
the liquid on a front surface of a substrate that opposes the second recovery port can be recovered via the second recovery port.

37. An exposure apparatus comprising:
an optical member, which has an emergent surface wherefrom exposure light emerges;
a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface;
a first recovery port, which is disposed at least partly around an optical axis of the optical member and is capable of recovering a liquid from at least part of the first gap; and
a liquid restricting part, which is formed on the outer side of the first recovery port with respect to the optical axis and allows the passage of a gas from the first gap and prevents the passage of the liquid from the first gap.

38. The exposure apparatus according to claim 37, wherein
the liquid restricting part has a second gap, which is formed on the outer side of the first recovery port with respect to the optical axis and is smaller than the first gap.

39. A device fabricating method comprising:
exposing a substrate using an exposure apparatus according to claim 1; and
developing the exposed substrate.

40. An exposing method, comprising:
radiating exposure light, which emerges from an emergent surface of an optical member, to a substrate;
filling an optical path of the exposure light between the emergent surface and the substrate with a liquid using a second member that is disposed at least partly around the optical path of the exposure light and that has an inner surface that opposes, via a first gap, at least one surface of the group consisting of an outer surface of the optical member, which is different from the emergent surface, and an outer surface of a first member, which holds the optical member; and
recovering the liquid from at least part of the first gap via a first recovery port; wherein,
a second gap, which is formed on the outer side of the first recovery port with respect to the optical axis of the optical member and is smaller than the first gap, prevents the liquid from flowing from the first gap to the outer side of the first recovery port with respect to the optical axis.

41. A device fabricating method, comprising:
exposing a substrate using an exposing method according to claim 40; and
developing the exposed substrate.

42. An exposure apparatus comprising:
an optical member, which has an emergent surface wherefrom exposure light emerges;
a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface; and
a first supply port, which supplies a liquid to the first gap,
wherein at least some of the liquid that is supplied via the first supply port flows in the first gap in a direction away from an optical axis of the optical member, and
the exposure light that emerges from the emergent surface is radiated to a substrate through the liquid between the emergent surface of the optical member and the substrate.

43. The exposure apparatus according to claim 42, wherein
the first supply port is disposed in the inner surface of the second member.

44. The exposure apparatus according to claim 43, wherein
the inner surface has a first portion, which extends in a radial direction with respect to the optical axis of the optical member and in a direction that is the reverse of the direction that the emergent surface of the optical member faces; and a second portion, which is disposed on the outer side of at least part of the first portion with respect to the optical axis; and
the first supply port is disposed in the first portion.

45. The exposure apparatus according to claim 44, wherein
the first gap has a first space, which is defined by the first portion, and a second space, which is defined by the second portion; and
the second space extends perpendicularly to the optical axis of the optical member.

46. The exposure apparatus according to claim 42, wherein
the first supply port faces a direction that is the reverse of the direction that the emergent surface faces.

47. The exposure apparatus according to claim 42, wherein
some of the liquid supplied via the first supply port to the first gap is supplied to the optical path of the exposure light.

48. The exposure apparatus according to claim 42, further comprising:
a second supply port, which is provided in the inner surface of the second member and supplies the liquid,
wherein the second supply port is disposed closer to the emergent surface than the first supply port is.

49. The exposure apparatus according to claim 48, further comprising:
an adjusting apparatus, which separately adjusts the amounts of the liquid supplied per unit of time to the first supply port and the second supply port.

50. The exposure apparatus according to claim 42, further comprising:
a first recovery port, which is disposed spaced apart from the first supply port with respect to the optical axis;
wherein the liquid that is supplied via the first supply port and flows in the first gap in a direction away from the optical axis is recovered via the first recovery port.

51. The exposure apparatus according to claim 50, wherein
the first recovery port is disposed in the inner surface of the second member.

52. The exposure apparatus according to claim 50, wherein
the recovery port is disposed in a third member, which is disposed at least partly around the second member such that it opposes the second member across a second gap.

53. The exposure apparatus according to claim 52, further comprising:
a first support mechanism, which supports the second member; and a second support mechanism, which supports the third member.

54. The exposure apparatus according to claim 52, wherein
at least one of the two surfaces that form the second gap is liquid repellent with respect to the liquid.

55. The exposure apparatus according to claim 52, wherein
the first recovery port recovers the liquid that passes over the second gap.

56. The exposure apparatus according to claim 50, wherein
the first recovery port faces a direction that is the reverse of the direction that the emergent surface faces.

57. The exposure apparatus according to claim 50, wherein
the first recovery port is disposed such that it faces toward the optical axis.

58. The exposure apparatus according to claim 50, further comprising:
a porous member, which is disposed in the first recovery port.

59. The exposure apparatus according to claim 58, wherein
the pressure differential between one side and another side of the porous member is controlled such that only the liquid passes through the porous member from the one side to the other side.

60. The exposure apparatus according to claim 50, wherein
the first recovery port recovers the liquid, together with a gas, from the first gap.

61. The exposure apparatus according to claim 42, wherein
the second member has a second recovery port; and
the liquid on a front surface of the substrate that opposes the second recovery port can be recovered via the second recovery port.

62. An exposure apparatus comprising:
an optical member, which has an emergent surface wherefrom exposure light emerges;
a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface;
a first supply port, which supplies a liquid to the first gap; and
a first recovery port that is disposed spaced apart from the first supply ports with respect to the optical axis and that recovers the liquid that is supplied via the first supply ports;
wherein a space in the first gap between the first supply port and the first recovery port is substantially filled with the liquid that is supplied via the first supply port; and
the exposure light that emerges from the emergent surface is radiated to a substrate through the liquid between the emergent surface of the optical member and the substrate.

63. A device fabricating method comprising:
exposing a substrate using an exposure apparatus according to claim 42; and
developing the exposed substrate.

64. An exposing method comprising:
radiating exposure light, which emerges from an emergent surface of an optical member, to a substrate;
filling an optical path of the exposure light between the emergent surface and the substrate with a liquid using a second member that is disposed at least partly around the optical path of the exposure light and that has an inner surface that opposes, via a first gap, at least one surface of the group consisting of an outer surface of the optical member, which is different from the emergent surface, and an outer surface of a first member, which holds the optical member; and
flowing at least some of the liquid that is supplied to the first gap in a direction away from the optical axis of the optical member.

65. A device fabricating method comprising:
exposing a substrate using an exposing method according to claim 64; and
developing the exposed substrate.

66. An exposure apparatus comprising:
an optical member, which has an emergent surface wherefrom exposure light emerges;
a second member that: has an inner surface that opposes, via a first gap, at least one surface from the group consisting of an outer surface of the optical member, which is different from the emergent surface, and an outer surface of a first member, which holds the optical member; and is disposed at least partly around an optical path of the exposure light that emerges from the emergent surface; and
a third member, which has a first recovery port that recovers a liquid from the first gap and is disposed such that it opposes the second member across a second gap,
wherein the exposure light that emerges from the emergent surface is radiated to a substrate through the liquid between the emergent surface of the optical member and the substrate.

67. The exposure apparatus according to claim 66, further comprising:
a first support mechanism, which supports the second member; and
a second support mechanism, which supports the third member such that the third member is disposed at least partly around the second member.

68. The exposure apparatus according to claim 66, wherein
at least one of the two surfaces that form the second gap is liquid repellent with respect to the liquid.

69. The exposure apparatus according to claim 66, wherein
the inner surface comprises a first portion, which extends in a radial direction with respect to an optical axis of the optical member and in a direction that is the reverse of the direction that the emergent surface faces, and a second portion, which is disposed on the outer side of at least part of the first portion with respect to the optical axis;
the first gap has a first space, which is defined by the first portion, and a second space, which is defined by the second portion; and
the first recovery port recovers the liquid from the second space.

70. The exposure apparatus according to claim 69, wherein
the second space extends perpendicularly to the optical axis of the optical member.

71. The exposure apparatus according to claim 69, wherein
the first recovery port recovers, via the second space, the liquid that overflows from the first space.

72. The exposure apparatus according to claim 69, wherein
the first recovery port faces the direction that is the reverse of the direction that the emergent surface faces and is disposed at substantially the same height as the second portion.

73. The exposure apparatus according to claim 69, wherein
the first recovery port faces the direction that is the reverse of the direction that the emergent surface faces and is disposed at a position that is lower than the second portion.

74. The exposure apparatus according to claim 69, wherein
the first recovery port recovers the liquid that overflows from the first space.

75. The exposure apparatus according to claim 66, wherein
the first recovery port recovers the liquid that overflows from the first gap.

76. The exposure apparatus according to claim 66, wherein
the first recovery port faces a direction that is the reverse of the direction that the emergent surface faces.

77. The exposure apparatus according to claim 66, wherein
the first recovery port is disposed such that it faces toward the optical axis.

78. The exposure apparatus according to claim 66, further comprising:
a porous member, which is disposed in the first recovery port.

79. The exposure apparatus according to claim 78, wherein
the pressure differential between one side and another side of the porous member is controlled such that only the liquid passes through the porous member from the one side to the other side.

80. The exposure apparatus according to claim 66, wherein
the first recovery port recovers the liquid, together with a gas, from the first gap.

81. The exposure apparatus according to claim 66, wherein
the second member has supply ports that supply the liquid to the optical path.

82. The exposure apparatus according to claim 81, wherein
the supply ports are disposed in the inner surface.

83. The exposure apparatus according to claim 66, wherein
the second member has a second recovery port; and
the liquid on a front surface of the substrate that opposes the second recovery port can be recovered via the second recovery port.

84. The exposure apparatus according to claim 66, wherein
the first recovery port recovers the liquid that passes over the second gap.

85. A device fabricating method comprising:
exposing a substrate using an exposure apparatus according to claim 66; and
developing the exposed substrate.

86. An exposing method comprising:
radiating exposure light, which emerges from an emergent surface of an optical member, to a substrate;
filling an optical path of the exposure light between the emergent surface and the substrate with a liquid using a second member that is disposed at least partly around the optical path of the exposure light and that has an inner surface that opposes, via a first gap, at least one surface of the group consisting of an outer surface of the optical member, which is different from the emergent surface, and an outer surface of a first member, which holds the optical member; and
recovering the liquid from the first gap via a recovery port of a third member, which is disposed such that it opposes the second member across a second gap.

87. A device fabricating method comprising:
exposing a substrate using an exposing method according to claim 86; and
developing the exposed substrate.
